(19) United States
(12) Patent Application Publication
(10) Pub. No.: US 2026/0273510 A1
(43) Pub. Date: Sep. 17, 2026

(54) BIO-INSPIRED NANOCOATING AND THE USE THEREOF

(71) Applicant: The Penn State Research Foundation, University Park, PA (US)

(72) Inventors: Amir Sheikhi, University Park, PA (US); Shang-Lin Yeh, University Park, PA (US); Roya Koshani, University Park, PA (US)

(73) Assignee: The Penn State Research Foundation, University Park, PA (US)

(21) Appl. No.: 19/474,574

(22) PCT Filed: Apr. 9, 2024
(86) PCT No.: PCT/US2024/023705

§ 371 Date: Oct. 10, 2025

Related U.S. Application Data
(60) Provisional application No. 63/495,895, filed on Apr. 13, 2023.

(51) Int. Cl. B01J 20/32; B01D 15/36

(52) U.S. Cl. CPC B01J 20/3204; B01D 15/361; B01J 20/3206; B01J 20/3285; B01J 20/3295

(57) ABSTRACT

Embodiments can relate to an adsorbent including a substrate and a coating formed on a surface of the substrate. The coating can include a bifunctional hairy cellulose nanocrystal (BHCNC) having a dialdehyde group and a dicarboxylate group. Additional embodiments can relate to methods of making and using the same.

### CROSS-REFERENCE TO RELATED APPLICATIONS

This patent application is related to and claims the benefit of priority to U.S. provisional patent application No. 63/495,895, filed Apr. 13, 2023, the entire contents of which is incorporated herein by reference.

### FIELD OF THE INVENTION

Embodiments can relate to an adsorbent including a substrate and a coating formed on a surface of the substrate. The coating can include bifunctional/multifunctional hairy cellulose nanocrystals (BHCNC) and/or a bifunctional/multifunctional polymers having at least dialdehyde groups and anionic (such as carboxylates) and/or cationic (such as amines) functional groups. Additional embodiments relate to methods of making and using the same.

### BACKGROUND OF THE INVENTION

Rare earth elements (REE), such as neodymium (Nd), are the most demanded elements for developing advanced technologies, ranging from wind turbines, hybrid engines, electric vehicles, mobile phones, medical devices, and laptops. Nd is an enabling component in strong neodymium-iron-boron (NdFeB) magnets, which are used in electronic devices. It is also a key element in neodymium-doped yttrium aluminum garnet (Nd-YAG) laser, one of the major processes of fabricating integrated circuit packages in semiconductor manufacturing. The limited supply of Nd by China has considerably raised its price in the past few years. The USA Department of Energy classified Nd as one of the critical materials since 2010 because of its supply shortage and tremendous impact on emerging sustainable technologies. To fulfill the lack of ready-to-exploit Nd supply and environmental considerations, secondary sources such as electronic waste recovery or industrial wastewater recycling have been explored recently.

Currently, adsorption is among the most appealing methods for Nd recovery from aqueous media as a result of cost-effective operations and low energy consumption. So far, Nd has been removed using adsorbents, such as alginate gels, phosphorus sol-gel adsorbents, nanotubes, porous carbon, vermiculite, regolith-hosted clay, and biosorbent microalgae. We have recently engineered a bio-based adsorbent based on cellulose, the most abundant biopolymer on earth, named anionic hairy cellulose nanocrystals that is cellulose nanoparticles attached to disordered dicarboxylated cellulose chains bearing a high content (~5 mmol g⁻¹) of carboxylate groups for high-concentration Nd or drug removal. The hairs impart the anionic hairy cellulose nanocrystals with a high adsorption capacity for neodymium ions (Nd³⁺) and selectivity against calcium ions (Ca²⁺) and ferrous ions (Fe²⁺); however, the Nd³⁺ removal percentage remains exceedingly low at a low adsorbate: adsorbent ratio as a result of the colloidal stability of unsaturated nanoparticles. In fact, this is a key bottleneck in using nanoparticles for ion separation and extraction. Adding complementary ions, including Ca²⁺, to neutralize nanoparticle adsorbents after adsorption has only partially induced aggregation. As an example, Nd³⁺ removal percentage of anionic hairy cellulose nanocrystals is below 40% at an initial Nd³⁺ concentrations of 10 ppm. Accordingly, despite highly functional and/or ion-specific groups, low-concentrations ion removal using nanoparticles or biopolymers remains a challenge.

Immobilizing nanoparticles or biopolymers on substrates without compromising their key functional groups using a facile, rapid, and robust coating technology may be beneficial for the advancement of REE industry. Bioinspired catechol or pyrogallol-based molecules have been used as functional building blocks for spontaneous and substrate-independent coatings. Among these molecules, dopamine (DA) was the first universal and versatile coating compound, discovered in 2007 based on the inspiration from the adhesive nature of catechol and amines on mussel adhesive proteins. Catechol groups on DA yield quinones by alkaline pH-induced oxidation, which are capable of reacting with other catechol/quinone groups and subsequently polymerizing to polydopamine (PDA). The formation of PDA involves multiple reaction pathways, including the oxidative reaction of DA to 5,6-dihydroxyindole and non-covalent self-assembled trimer of (DA)₂/5,6-dihydroxyindole. The PDA coating harbors latent reactivity toward nucleophiles, so molecules with nucleophilic groups, such as amino, thiol, or aldehyde groups can be grafted onto a PDA-coated surface via Michael addition or Schiff base reaction Therefore, target biopolymers, such as modified polysaccharides may be immobilized on substrates via PDA-mediated ad-layer formation or one-step coating.

### SUMMARY OF THE INVENTION

The present disclosure provides the first mussel-inspired nanocoating based on hairy cellulose nanocrystals for the rapid, low concentration, and selective Nd recovery. Embodiments can be used to synthesize bifunctional hairy cellulose nanocrystals (BHCNC) bearing dialdehyde and dicarboxylate groups and use it to develop a mussel-inspired nanocellulose coating (MINC). The MINC can be optimized based on the Schiff based formation between the BHCNC aldehyde groups and DA on a model substrate, i.e., silica gel (SG) microparticles, to maximize the accessible dicarboxylate groups for Nd recovery. Competitive Nd³⁺ adsorption against common ions in industrial leachate, such as Nat, Ca²⁺, and Fe³⁺ as well as the cyclic reuse of MINC are thoroughly assessed. MINC may enable the next-generation bio-based nanocoating for the sustainable recovery of REE.

The present disclosure discusses multifunctional and/or bifunctional polymers, particles, etc. It is understood that this term “multifunctional” includes bifunctional.

Embodiments can relate to an adsorbent. The adsorbent can include a substrate and a coating formed on a surface of the substrate. The coating can include multifunctional polymers and/or particles, bearing anionic, cationic, zwitterionic, and/or neutrally charged functional groups.

In some embodiments, the multifunctional polymers and/or particles include bifunctional hairy cellulose nanocrystals (BHCNC).

In some embodiments, the anionic, cationic, zwitterionic, and/or neutrally charged functional groups include dialdehyde groups and dicarboxylate groups.

In some embodiments, the coating is formed on a portion of the surface of the substrate or formed on an entire surface of the substrate.

In some embodiments, the coating, on each portion of the surface, is formed with uniform thickness and/or uniform concentration; the coating, on each portion of the surface, is formed with non-uniform thickness and/or non-uniform concentration; or the coating is formed with uniform thickness and/or uniform concentration on a first portion of the surface and is formed with non-uniform thickness and/or non-uniform concentration on a second portion of the surface.

In some embodiments, the substrate includes one or more substrates.

In some embodiments, the one or more substrates includes one or more of the same type of substrate or one or more of a different type of substrate.

In some embodiments, the multifunctional polymers and/or particles includes one or more types of multifunctional polymers and/or particles.

In some embodiments, the multifunctional polymers and/or particles includes one or more types of multifunctional polymers and/or particles. One substrate is coated with one type of multifunctional polymers and/or particles and another substrate is coated with another type of multifunctional polymers and/or particles.

In some embodiments, the substrate is one or more particles, any one or combination of the one or more particles having a length that is on a nano scale, a micro scale, or a milli scale.

In some embodiments, the substrate comprises a polymer, an organic compound, and/or an inorganic compound.

In some embodiments, the inorganic compound comprises a synthetic compound, a natural compound, and/or a semi-natural compound.

In some embodiments, the substrate is silica gel, silicate nanoplatelets, microcrystalline cellulose, an organic compound, and/or an inorganic compound.

Embodiments can relate to a method of generating an adsorbent/The method can involve forming a coating on a surface of a substrate, the coating comprising multifunctional polymers and/or particles, bearing anionic, cationic, zwitterionic, and/or neutrally charged functional groups.

In some embodiments, the multifunctional polymers and/or particles include bifunctional hairy cellulose nanocrystals (BHCNC).

In some embodiments, the method involve converting a cellulose fibril to BHCNC via synthesis.

In some embodiments, the synthesis comprises: oxidizing a biomass to convert a hydroxyl group of the biomass into an aldehyde group; oxidizing aldehyde-modified biomass to convert the aldehyde group to an anionic group, a cationic group, a zwitterionic group, and/or an electrically neutral group; and forming a micro- and/or nano-structured precipitate with the chemically modified biomass.

In some embodiments, the synthesis comprises oxidizing the biomass to convert a hydroxyl group of the biomass into a dialdehyde group.

In some embodiments, the synthesis comprises oxidizing the dialdehyde-modified biomass to at least partially convert the dialdehyde group to a dicarboxylate group.

In some embodiments, adjusting a thickness and/or a concentration of the coating to optimize accessibility of functional groups, when the adsorbent will be used in an adsorption process.

In some embodiments, the functional groups include a dicarboxylate group.

Embodiments can relate to a method of recovering an element from a solution. The method can involve exposing an adsorbent to a solution containing an element. The adsorbent can include: a substrate; and a coating formed on a surface of the substrate, the coating comprising: multifunctional polymers and/or particles, bearing anionic, cationic, zwitterionic, and/or neutrally charged functional groups. The method can involve allowing the element to adsorb to the adsorbent.

In some embodiments, the method involves: removing the adsorbent from the solution; and adjusting a pH of the environment within which the adsorbent is held to recover the element.

In some embodiments, the method involves exposing the adsorbent to the solution to adsorb the element; and/or exposing the adsorbent to a different solution containing an element and allowing the element to adsorb to the adsorbent.

In some embodiments, the element is any element.

In some embodiments, the element is a metal, a rare earth element, and/or a precious metal.

Embodiments can relate to a method of generating an adsorbent. The method can involve forming a coating on a surface of a substrate, the coating configured to utilize a bioinspired adhesion mechanism found in nature.

In some embodiments, the bioinspired adhesion mechanism includes a mussel-inspired coating and/or a tea-inspired coating.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1A shows an exemplary method of making an adsorbent using an embodiment of the inventive method. FIG. 1B shows an exemplary method of recovering an element using an embodiment of the adsorbent. FIG. 1C shows an exemplary schematic of an embodiment of the BHCNC synthesis method via the successive (meta) periodate- and chlorite-mediated oxidation of delignified softwood kraft pulp. FIG. 1D shows interaction of Nd³⁺ and dicarboxylate groups of BHCNC, the active component of MINC. FIG. 1E shows MINC composition and interactions with Nd³⁺. FIG. 1F shows MINC chemistry, representing the covalent linkage between DA and BHCNC via the Schiff base reaction, resulting in BHCNC immobilization on SG.

FIG. 2A shows the concentration of carboxylate groups in the MINC-treated SG and the grafting ratio of BHCNC (m_{BHCNC}/m_{SG}) at varying ratios of BHCNC aldehyde to DA amine groups, increased by increasing BHCNC concentration at a fixed DA concentration (2 mg mL⁻¹). The carboxylate groups and m_{BHCNC}/m_{SG} reach a plateau at aldehyde/amine ~1.3 mol mol-1. FIG. 2B shows FTIR spectra of SG, BHCNC and MINC-treated SG. The imine bond on MINC-treated SG confirms the Schiff base formation. FIG. 2C shows SEM images of SG and MINC-treated SG, showing different surface textures of unmodified and modified substrates.

FIG. 3A shows a schematic of Nd³⁺ removal procedure using MINC-treated SG. FIG. 3B shows effect of contact time on MINC-mediated Nd³⁺ removal at C₀=700 ppm. FIG. 3C shows Nd³⁺ removal percentage and capacity of BHCNC, SG, PSG, or MINC-treated SG at C₀=10 ppm. FIG. 3D shows effect of initial Nd³⁺ concentrations on MINC-mediated Nd³⁺ removal percentage and capacity. FIG. 3E shows Nd³⁺ equilibrium removal capacity of MINC-treated SG versus equilibrium Nd³⁺ concentration, fitted to the Langmuir isotherm model. The inset table present the isotherm parameters. In panels B-E, the adsorbent mass is 35 mg.

FIGS. 4A and 4B show the effect of pH on MINC-mediated Nd³⁺ removal at (FIG. 4A) low (C₀=10 ppm) or (FIG. 4B) high (C₀=700 ppm) Nd³⁺ initial concentrations. The mass of MINC-treated SG adsorbent is 35 mg. FIG. 4C shows a schematic of Nd³⁺ removal mechanism using the MINC-treated SG at pH>3. FIG. 4D shows a schematic of Nd³⁺ desorption (recovery) mechanism from the MINC-treated SG at pH<3. FIG. 4E shows the effect of initial Nd³⁺ concentrations on MINC-mediated Nd³⁺ removal and desorption. FIG. 4F shows Nd³⁺ removal and desorption percentage of MINC-treated SG versus varying acid wash cycle numbers at C₀=10 ppm.

FIGS. 5A, 5B, and 5C show the effects of (FIG. 5A) monovalent ions (Na⁺), FIG. 5B divalent ions (Ca²⁺), or FIG. 5C trivalent ions (Fe³⁺) on the Nd³⁺ removal percentage and capacity of MINC-treated SG at a low Nd³⁺ concentration (C₀=10 ppm). FIG. 5D shows Fe³⁺ removal capacity of MINC-treated SG with or without Nd³⁺.

FIG. 6 shows a calibration curve of dopamine (DA) UV-vis absorbance (λₘₐₓ=280 nm) in Milli-Q water.

FIGS. 7A, 7B, and 7C show aldehyde and carboxylate content measurements. FIG. 7A shows aldehyde content of DAMC measured by the hydroxylamine hydrochloride titration method. FIG. 7B shows carboxylate content of BHCNC, measured by the conductometric titration. FIG. 7C shows aldehyde content of BHCNC, measured by the hydroxylamine hydrochloride titration method.

FIG. 8A shows full survey XPS spectra of BHCNC, FIG. 8B shows full survey XPS spectra of SG, and FIG. 8C shows full survey XPS spectra of MINC-treated SG. Cis survey deconvoluted into different carbon bonds for (FIG. 8D) BHCNC, (FIG. 8E) SG, and (FIG. 8F) MINC-treated SG. (Pos. denotes position, FWHM stands for the full width half maximum, % Area means the area percentage).

FIGS. 9A and 9B show the equivalent size distribution of SG and MINC-treated SG, analyzed by Image J based on SEM images and considering equivalent circular shapes.

FIG. 10 shows MINC-mediated Nd³⁺ removal percentage at varying initial Nd³⁺ concentrations, ranging from 1 ppm to 10 ppm.

FIGS. 11A and 11B show MINC-treated SG reusability and stability results, wherein the Nd³⁺ (C₀=10 ppm) (FIG. 11A) removal percentage or (FIG. 11B) desorption of MINC-treated SG after varying acid wash cycles at pH=1, 1.5, or 2. FIG. 11C shows carboxylate content of MINC-treated SG after incubating in a HCl solution (pH=1.5) for varying period. FIG. 11D shows carboxylate content of MINC-treated SG versus varying acid wash cycles. The mass ratio of desorbed BHCNC to the total BHCNC on MINC-treated SG is shown in FIG. 11E after incubation in a HCl solution (pH=1.5) for varying period or (FIG. 11F) after varying acid wash cycles. (NS p>0.05, *p<0.05, **p<0.01, and ***p<0.001).

FIGS. 12A, 12B, and 12C show effects of competitive ions on the MINC-mediated Ndx³⁺ removal, illustrating effects of (FIG. 12A) monovalent ions (Na⁺), (FIG. 12B) divalent ions (Ca²⁺), or (FIG. 12C) trivalent ions (Fe³⁺) on the Nd³⁺ (C₀=700 ppm) removal percentage and capacity of MINC-treated SG.

FIGS. 13A, 13B, 13C, and 13D show synthesis and characterization of cellulose-based adsorbents. FIG. 13A is a schematic of AHCNC synthesis via the successive periodate- and chlorite-mediated oxidation of delignified softwood kraft pulp, as well as TEMPO-CNC synthesis via the HCl hydrolysis, followed by the TEMPO-mediated oxidation of delignified softwood kraft pulp. FIG. 13B is charge content, FIG. 13C is ζ-potential, and FIG. 13D is hydrodynamic equivalent size of TEMPO-CNC, CMC, AHCNC and DCC. Note that DCC is unable to be detected by DLS, thus no data is included for the ζ-potential and hydrodynamic size.

FIGS. 14A, 14B, 14C, 14D, 14E, and 14F show charge content and morphology assessment of cellulose-based adsorbents. Carboxylate group content of (FIG. 14A) TEMPO-CNC, (FIG. 14B) CMC, (FIG. 14C) AHCNC, and (FIG. 14D) DCC, measured by the conductometric titration. AFM images of (FIG. 14E) TEMPO-CNC, and (FIG. 14F) AHCNC.

FIGS. 15A, 15B, 15C, and 15D show Dy^{III} removal using the cellulose-based nanoparticles (AHCNC and TEMPO-CNC) and fully solubilized biopolymers (CMC and DCC). FIG. 15A show a schematic of Dy^{III} removal using AHCNC, which is similar to the other adsorbents. The unsaturated, electrically charged adsorbents remain stable and do not precipitate. Ion separation takes place when the adsorbents are saturated, forming aggregates and precipitate.

FIG. 15B shows the effect of contact time on Dy^{III} removal using the cellulose-based adsorbents at C₀=2 mM (323 ppm), excluding the vortex and centrifugation time (~10 min). FIG. 15C show the effect of C₀ on the Dy^{III} removal percentage (R) of cellulose-based adsorbents. FIG. 15D shows the effect of C₀ on the Dy^{III} removal capacity (q_{c}) of cellulose-based adsorbents.

FIGS. 16A, 16B, 16C, 16D, 16E, and 16F show the effects of a divalent cation and a LREE on the Dy³⁺ removal of cellulose-based adsorbents. Effects of (FIG. 16A) Ca^{II} and (FIG. 16B) Nd^{III} on TEMPO-CNC- and CMC-mediated Dy^{III} removal. Effects of (FIG. 16C) Ca^{II} and (FIG. 16D) Nd^{III} on AHCNC- and DCC-mediated Dy^{III} removal. (FIG. 16E) Dy^{III} and Ca^{II} distribution factors (log D) for TEMPO-CNC, CMC, AHCNC, and DCC in a Dy^{III} (2 mM)-Ca^{II} (2 mM) mixture. (FIG. 16F) Dy^{III} and Nd^{III} log D for the adsorbents in a Dy^{III} (2 mM)-Nd^{III} (2 mM) mixture. (NS p≥0.05, *p<0.05, **p<0.01, and ***p<0.001).

FIGS. 17A, 17B, and 17C show competitive Nd^{III}/Dy^{III} adsorption to AHCNC. FIG. 17A shows the Nd^{III} removal capacity (q_{c,Nd}^{III}) of AHCNC with or without 2 mM of Dy^{III}. FIG. 17B shows the Dy^{III} removal capacity (q_{c}) of AHCNC with or without 10 mM of Nd_{III}. FIG. 17C shows q_{c,Na}^{III} of AHCNC at varying Dy^{III} concentrations.

FIGS. 18A, 18B, 18C, 18D, 18E, and 18F show ion type and concentration effects on the colloidal properties of cellulose-based adsorbents. (FIG. 18A) ζ-potential and (FIG. 18B) hydrodynamic equivalent size of TEMPO-CNC at varying initial Ca^{II}, Nd^{III} or Dy^{III} concentrations. (FIG. 18C) ζ-potential and (FIG. 18D) Hydrodynamic equivalent size of CMC at varying initial Ca^{II}, Nd^{III} or Dy^{III} concentrations. (FIG. 18E) ζ-potential and (FIG. 18F) Hydrodynamic equivalent size of AHCNC at varying initial Ca^{II}, Nd^{III} or Dy^{III} concentrations.

FIGS. 19A, 19B, 19C, 19D, 19E, 19F, 19G, 19H, and 19I show the effect on ion type and concentration on the size distribution of cellulose-based adsorbents. Size (i.e., equivalent diameter) distributions of (FIG. 19A) TEMPO-CNC at varying initial Ca^{II} concentrations, (FIG. 19B) TEMPO-CNC at varying initial Nd^{III} or Dy^{III} concentrations, (FIG. 19C) TEMPO-CNC at varying initial Dy^{III} concentrations, (FIG. 19D) CMC at varying initial Ca^{II} concentrations, (FIG. 19E) CMC at varying initial Nd^{III} or Dy^{III} concentrations, (FIG. 19F) CMC at varying initial Dy^{III} concentrations. (FIG. 19G) AHCNC at varying initial Ca^{II} concentrations, (FIG. 19H) AHCNC at varying initial Nd^{III} or Dy^{III} concentrations, and (FIG. 19I) AHCNC at varying initial Dy^{III} concentrations.

FIGS. 20A, 20B, and 20C show fundamental aspects of ion binding to cellulose-based adsorbents. (FIG. 20A) The dissociation constant (K_{D}) of Ca^{II}-, Nd^{III}- or Dy^{III}-bound TEMPO-CNC, CMC, and AHCNC, determined using the ITC. (FIG. 20B) The glass transition temperature (T_{g}) of Ca^{II}-, Nd^{III}-, or Dy^{III}-bound CMC, AHCNC, and DCC, measured using the DSC. (FIG. 20C) Conceptual representation of Ca^{II}-, Nd^{III}- and Dy^{III}-bound AHCNC, where Ca^{II} induces dominant intrahair crosslinking and Dy^{III} induces dominated interhair crosslinking. (NS p≥0.05, *p<0.05, and **p<0.01.

FIGS. 21A, 21B, 21C, 21D, 21E, and 21F show ITC titration plots of ions-AHCNC. (FIG. 21A) Representative ITC trace for titration of 1 mg mL⁻¹ AHCNC with with a Ca^{II} solution (1 mM, pH=5.7). (FIG. 21B) Thermogram derived from titration of 1 mg mL⁻¹ AHCNC with 1 mM Ca^{II} solution. (FIG. 21C) Representative ITC trace for titration of 1 mg mL⁻¹ AHCNC with a Nd^{III} solution (1 mM, pH=5.7). (FIG. 21D) Thermogram derived from titration of 1 mg mL⁻¹ AHCNC with 1 mM Nd^{III} solution. (FIG. 21E) Representative ITC trace for titration of 1 mg mL⁻¹ AHCNC with a Dy^{III} solution (1 mM, pH=5.7). (FIG. 21F) Thermogram derived from titration of 1 mg mL⁻¹ AHCNC with a Dy^{III} solution (1 mM).

FIGS. 22A, 22B, 22C, 22D, 22E, and 22F show ITC titration plots of ions-TEMPO-CNC. (FIG. 22A) Representative ITC trace for titration of 1 mg mL⁻¹ TEMPO-CNC with a Ca^{II} solution (1 mM, pH=5.7). (FIG. 22B) Thermogram derived from the titration data in FIG. 22A. (FIG. 22C) Representative ITC trace for titration of 1 mg mL⁻¹ TEMPO-CNC with a Nd^{III} solution (1 mM, pH=5.7). (FIG. 22D) Thermogram derived from the titration data in FIG. 22C. (FIG. 22E) Representative ITC trace for titration of 1 mg mL⁻¹ TEMPO-CNC with a Dy^{III} solution (1 mM, pH=5.7). (FIG. 22F) Thermogram derived from the titration data in FIG. 22E.

FIGS. 23A, 23B, 23C, 23D, 23E, and 23F show ITC titration plots for ions-CMC. (FIG. 23A) Representative ITC trace for titration of 1 mg mL⁻¹ CMC with a Ca^{II} solution (1 mM, pH=5.7). (FIG. 23B) Thermogram derived from the titration data in FIG. 23A. (FIG. 23C) Representative ITC trace for titration of 1 mg mL⁻¹ CMC with a Nd^{III} solution (1 mM, pH=5.7). (FIG. 23D) Thermogram derived from the titration data in FIG. 23C. (FIG. 23E) Representative ITC trace for titration of 1 mg mL⁻¹ CMC with a Dy^{III} solution (1 mM, pH=5.7). (FIG. 23F) Thermogram derived from the titration data in FIG. 23E.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of the present invention. The scope of the present invention is not limited by this description.

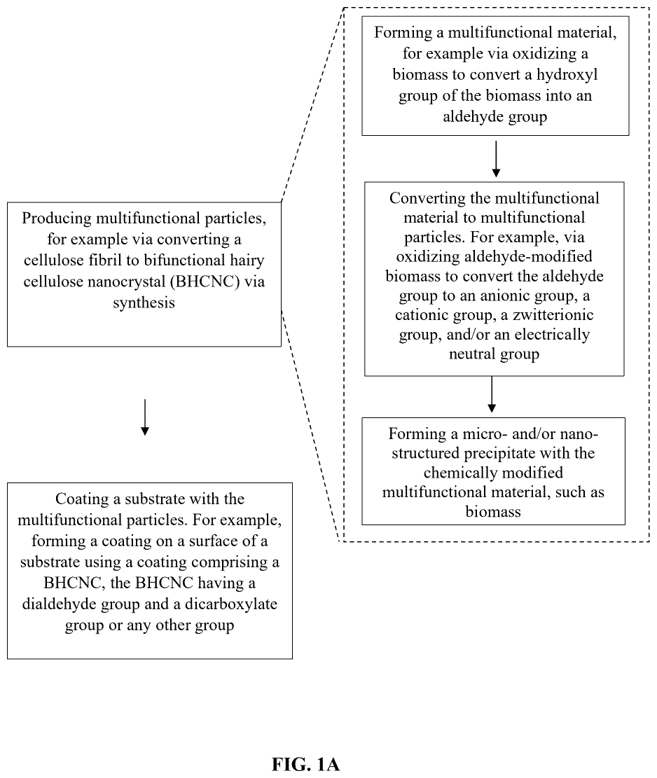

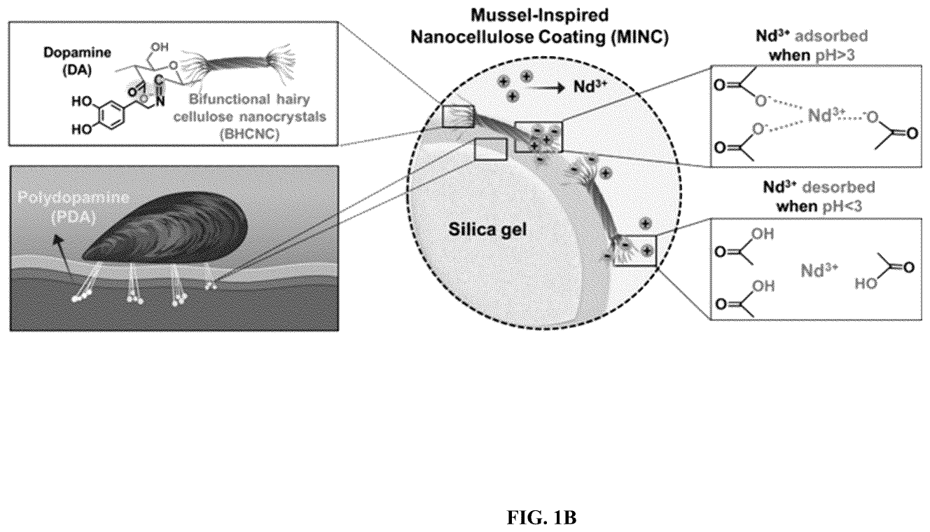

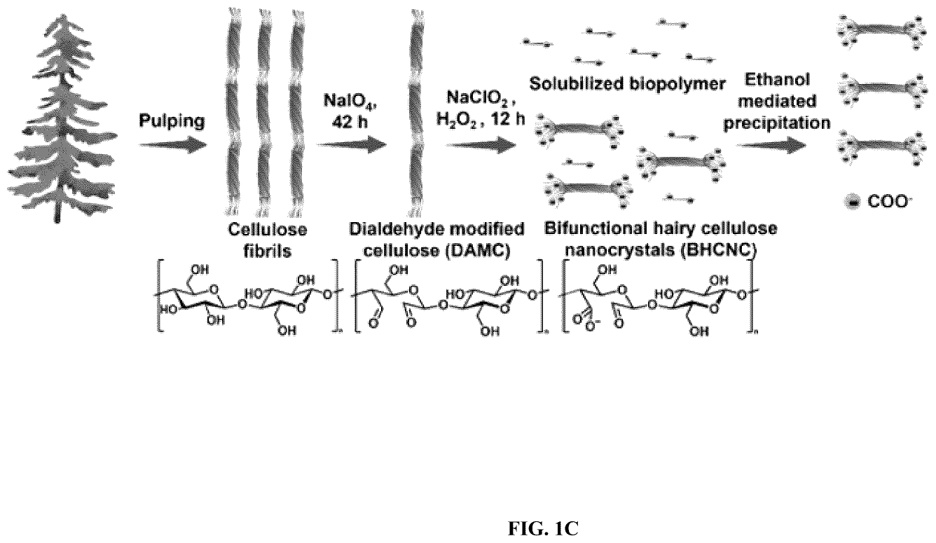

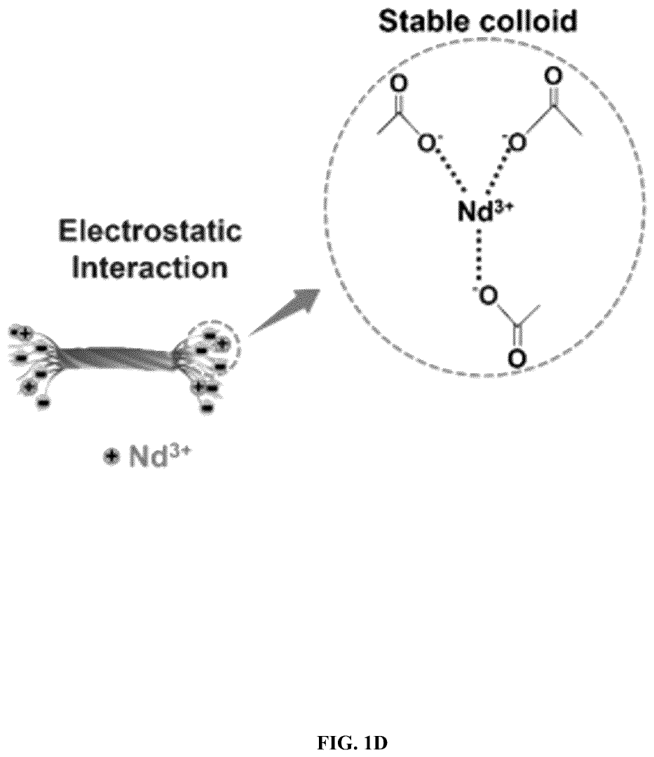

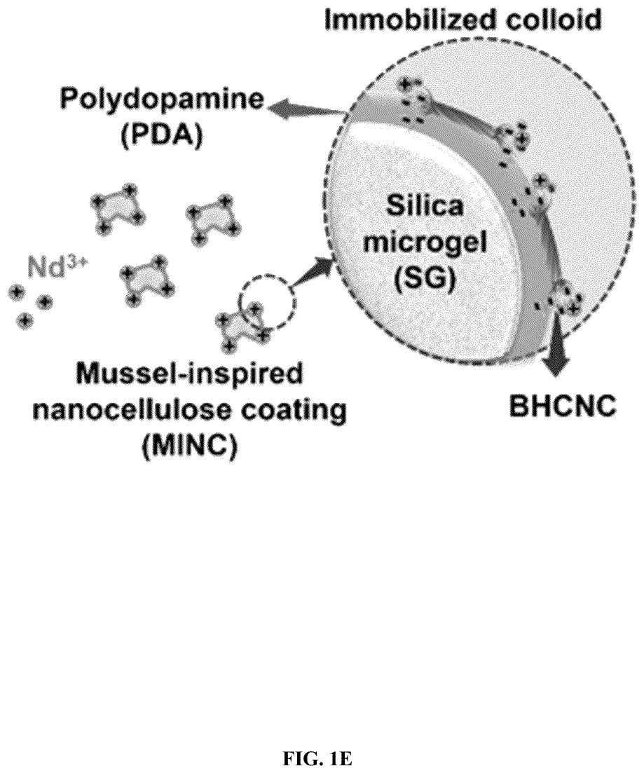

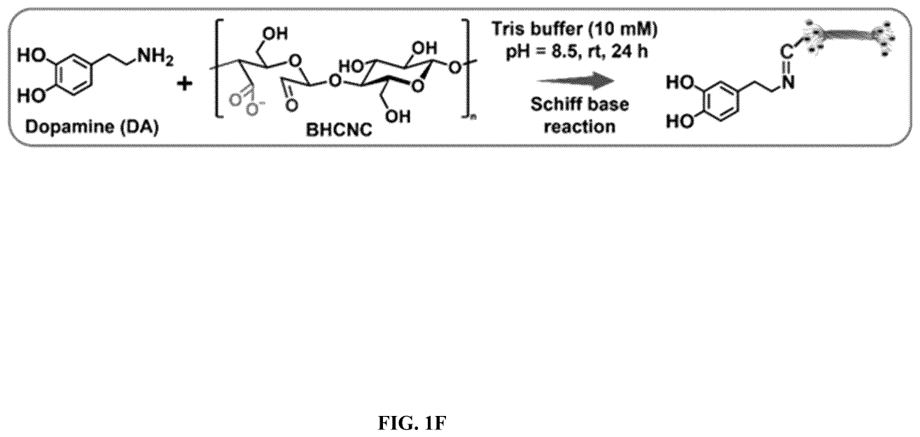

Referring to FIGS. 1A and 1B, embodiments can relate to an adsorbent. The adsorbent can include a substrate and a coating formed on a surface of the substrate. The substrate can be any substrate, such as microparticle, nanoparticle, and/or planar substrates. The substrate can be a particle at any length of scale (e.g., nano, micro, milli, etc.). The substrate may be made up of any polymer, organic compounds, inorganic compounds (e.g., synthetic, natural, semi-natural), etc. Exemplary substrates can be silica gel, silicate platelets, MXenes, metal particles, plastic particles, hydrogel particles, polymeric particles, etc. The adsorbent can include one or more substrates, which can include one or more of the same type of substrate or one or more of a different type of substrate.

The coating can be or include a cellulose micro- or nano-structure. For instance, the coating can be or include a cellulose nanofibril (CNF), a cellulose nanocrystal (CNC), a hairy cellulose nanocrystals (HCNC), etc. The adsorbent can include one or more types of cellulose structures. For embodiments having more than one substrate, one substrate can be coated with one type of cellulose structure and another substrate can be coated with another type of cellulose structure. An exemplary cellulose coating can be a bifunctional hairy cellulose nanocrystal (BHCNC). As will be explained herein, the cellulose structure can be synthesized to have at least one dialdehyde group and at least one dicarboxylate group. The dialdehyde group(s) enable dopamine-mediated orthogonal conjugation of the cellulose structure to the substrate(s). The dicarboxylate group(s) provide high-capacity, selective element removal when embodiments of the adsorbent are used or element recovery. As will be demonstrated, this is especially so in the presence of and against competing ions such as ferric, calcium, sodium ions, etc.

It will be appreciated that the coating can be formed on a portion of the surface of the substrate or formed on an entire surface of the substrate. It will also be appreciated that the coating, on each portion of the surface, can be formed with uniform thickness and/or uniform concentration. The coating, on each portion of the surface, can be formed with non-uniform thickness and/or non-uniform concentration. The coating can be formed with uniform thickness and/or uniform concentration on a first portion of the surface and can be formed with non-uniform thickness and/or non-uniform concentration on a second portion of the surface.

Additional embodiments can relate to methods and making and using embodiments of the adsorbent. Thus, methods disclosed herein can relate to chemical systems in which mixtures and solutions are formed, oxidation reactions and precipitation are promoted, agitation, quenching, etc. occurs. Chemical and physical parameters controlling these processes can be based on amounts, concentrations, kinetics, energetics, thermodynamics, etc. of the system and/or constituents of the system.

Embodiments can relate to a method of generating an adsorbent. The method can involve forming a coating on a surface of a substrate, the coating comprising a cellulose structure (e.g., bifunctional hairy cellulose nanocrystal (BHCNC)) having a dialdehyde group and a dicarboxylate group. Forming the BHCNC can involve converting a cellulose fibril to BHCNC via synthesis. The synthesis can involve oxidizing a biomass to convert a hydroxyl group of the biomass into an aldehyde group. The biomass can be a lignocellulosic material (e.g., softwood pulp, cotton, corncob, tomato peel, etc.). It is understood that the inventive method can be applied to other biomass substances, which can include polyphenolic compounds and carbohydrates (e.g., alginate, hyaluronic acid, chitin, chitosan, etc.). In addition, the inventive method can be applied to non-polysaccharide materials, such as lignin. Other sources can include fruits, hemps, plants, grass, etc.

For the oxidation, the lignocellulosic can be paced in a solution subjecting it to NaIO₄. The solution can be stirred (e.g., mechanical, magnetic, ultrasonic, etc.) to promote agitation. This can be done for a predetermined amount of time. At the predetermined amount of time, ethylene glycol can be added to the solution to quench sodium periodate oxidation. For instance, ethylene glycol can quench any unreacted sodium periodate in the solution. The NaIO₄ oxidation can generate oxidative cleavage of vicinal diol at the C₂-C₃ bond of the biomass. The C₂-C₃ bond is the repeating unit of cellulous chains on cellobiose. Generating oxidative cleavage of vicinal diol can break the C₂-C₃ bond while oxidizing the hydroxyl group. More specifically, the oxidative cleavage of the vicinal diol at the C₂-C₃ bond on cellobiose breaks the bond while subsequently oxidizing the hydroxyl groups to convert them to aldehydes. This can form dialdehyde modified cellulose (DAMC).

The result of this first oxidation stage can be solid aldehyde-functionalized product. This lingocellulosic biomass biopolymer can them be isolated and remove from solution using a known filtering technique.

The synthesis can involve a second oxidation stage—e.g., the synthesis can involve oxidizing aldehyde-modified biomass to convert the aldehyde group to an anionic group, a cationic group, a zwitterionic group, and/or an electrically neutral group. This can be achieved by oxidizing the sodium periodate-oxidized biomass (e.g., the solid aldehyde-functionalized product) with sodium chlorite (NaClO₂). This can be done to convert, or at least partially convert, the aldehyde group(s) (e.g., dialdehyde moieties) into a carboxylate group(s) or dicarboxylate group(s). More specifically, the subsequent oxidation of DAMC with sodium chlorite selectively converts the aldehyde groups to carboxylate groups, which disintegrates the DAMC to nanocrystals as electrostatic repulsion among the crystals is increased. Although periodate oxidation is highly selective toward vicinal diols, reactions may also occur with phenolic guiacyl compounds, such as lignin, forming o-quinone structures.

For the oxidation, the solid aldehyde-functionalized product produced by the first oxidation stage can be dissolved in an aqueous solution of NaClO₂. In some embodiments, the method can involve subjecting the sodium periodate-oxidized biomass to a hypochlorous acid (HOCl) scavenger during the second oxidation stage. For instance, the HOCl scavenger can be added to the aqueous solution of NaClO₂ during the second stage oxidation. The HOCl scavenger can be hydrogen peroxide, for example. The scavenger is used to prevent HOCl from competing with the desired sodium chlorite oxidation.

The synthesis can involve forming a micro- and/or nano-structured precipitate with the chemically modified biomass. For instance, the result of the second oxidation stage can be the formation of a micro- and/or nano-structured precipitate. This micro- and/or nano-structured precipitate can be isolated and removed from solution via centrifugation, for example. While centrifugation can be used for larger particles, isolation and removal of smaller particles may require exposing the solution to a poor solvent (EtOH). Thus, the isolation and removal can involve centrifugation and/or use of a poor solvent.

While embodiments disclosed herein describe use of external forces (mixing, centrifugation, fluidization, etc.) at one or more stages of the process, the inventive method can be performed without such external forces.

The resultant micro- and/or nano-structured precipitate can have a large charge density For instance, the precipitate can include anionic cellulose nanocrystals, which can comprise a crystalline body similar to that of conventional cellulose nanocrystals that are sandwiched between highly negatively charged disordered cellulose chains. It should be noted, however, that the resultant micro- and/or nano-structured precipitate can be anionic, cationic, zwitterionic, or electrically neutral.

This high charge concentration can make the precipitate useful for many applications, which can include removal and recovery of elements (e.g., rear-earth elements) for example. For instance, electrostatic interactions between negatively charged carboxylate groups of the precipitate and positively charged elements (e.g., Nd³⁺) can facilitate adsorption of the elements by the precipitate. Thus, a substance containing the element of concern can be placed in a solution supporting the precipitate. This can cause adsorption of the element to the precipitate. Extraction of the elements can be achieved by protonating the carboxylate groups so as to neutralize their negative charge. Protonation can occur by lowering the pH of the solution. Upon lowering the pH, the carboxylate groups are protonated, which can cause release of the adsorbed element.

It is contemplated for the adsorbent to be used for recovery of elements (e.g., rare earth elements-Nd, for example). In some embodiments, a thickness and/or a concentration of the coating can be adjusted to optimize accessibility of a dicarboxylate group(s) when the adsorbent will be used in an adsorption process. To recovery an element, the adsorbent can be exposed to a solution containing the element. The charge density characteristics facilitate the adsorption of the element to the adsorbent. The adsorbent can then be removed from the solution and placed in another solution in which the pH of the environment within which the adsorbent is held can be adjusted. Adjusting the pH can facilitate recovery of the element. The adsorbent can then be washed and reused. For instance, the adsorbent can be exposed back to the same solution to adsorb more of the element. In addition, or in the alternative, the adsorbent can be exposed to a different solution containing an element and allowing the element to adsorb to the adsorbent.

### EXAMPLES

The following describe exemplary adsorbents and coatings, and test results of making, using, and applying the same.

Neodymium (Nd) is one of the most urgent rare earth elements (REE) for developing the next generation of magnetic medical devices and clean energy. Eco-friendly and sustainable nanotechnology for REE recovery may be highly suitable to address the limited global supply while minimizing the environmental footprints of current practice, such as solvent extraction. Here, we present a one-step mussel-inspired nanocellulose coating (MINC) using bifunctional hairy cellulose nanocrystals (BHCNC), bearing dialdehyde and dicarboxylate groups. The dialdehyde groups enable dopamine-mediated orthogonal conjugation of BHCNC to substrates, such as microparticles, while the high content of dicarboxylate groups yields high-capacity, selective Nd removal against ferric, calcium, and sodium ions. To the best of our knowledge, the MINC-treated substrate provides the most rapid selective removal and recovery of Nd ions even at low Nd concentrations with a capacity that is among the highest reported values. The MINC can provide new opportunities in developing next-generation bio-based nanocoatings for the sustainable recovery of REE and other precious elements.

### Materials and Methods

### Materials

To synthesize BHCNC, Northern bleached softwood kraft pulp sheets (Domtar Inc., Canada) were used. Neodymium (III) chloride hexahydrate (NdCl₃·6H₂O, 99.9% trace metal basis), sodium chloride (NaCl, >99.5%), calcium chloride dihydrate (CaCl₂·2H₂O, for molecular biology, ≥99.0%), iron (III) chloride (FeCl₃, >97%), sodium hydroxide (NaOH, ACS Reagent, >97%), hydrochloric acid (HCl, ACS reagent, 37%), sodium (meta) periodate (NaIO₄, >99.0%), sodium chlorite (NaClO₂, 80%), hydrogen peroxide (H₂O₂, 30 wt %), ethylene glycol (Reagent plus, >99%), hydroxylamine hydrochloride (NH₂OH·HCl, Reagent plus, 99%), dopamine hydrochloride (4-(2-aminoethyl)benzene-1,2-diol, 97%), and tris buffer (1.0 M, pH=7.0) were supplied by Sigma-Aldrich, USA. SG microparticles were obtained from a supermarket. Anhydrous ethanol (200 proof) was obtained from KOPTEC, USA. Deionized (DI) water was used to produce Milli-Q water (18.2 m (2 cm resistivity) using an ultrafilter (Biopak Polisher, Millipore, USA).

### BHCNC Synthesis

One gram of softwood kraft pulp was shredded into thin pieces of approximately 2 cm×2 cm, followed by soaking in DI water for about 24 h. The wet pulp was placed in a fruit blender and mechanically disintegrated for 10 min, followed by vacuum filtration to yield a pulp slurry. Dialdehyde modified cellulose (DAMC) was synthesized via reacting the pulp slurry with 65 mL of total DI water and 1.32 g of NaIO₄. The solution included 3.8 g of NaCl, which was stirred in a breaker for 42 h at room temperature. Since periodate is a light-sensitive oxidizing agent, the reaction was performed in the dark via wrapping the beaker with aluminum foil. Unreacted periodate was deactivated by adding ethylene glycol (1 mL) to the reaction slurry. Then, DAMC fibers were rinsed with DI water at least 5 times. Each time, the fibers were dispersed in 50 mL of DI water, stirred for 5 min, and collected by vacuum filtration.

The dialdehyde groups were partially converted to dicarboxylate groups via subjecting DAMC to chlorite reaction. For this, DAMC slurry including DI water (total volume=50 mL), 0.8452 g of NaClO₂, and 0.8478 mL of H₂O₂ (added dropwise), was stirred for 12 h at ambient temperature. The reaction pH was 5.0±0.2, which was adjusted by the intermittent addition of NaOH solution (0.5 M) during the reaction. The reaction mixture was then centrifugated at 27000×g for 15 min to remove non-disintegrated fibers. BHCNC was precipitated by adding ethanol (0.16 g per 1 g of suspension) to the supernatant, followed by centrifugation at 3000×g for 15 min. To remove any unreacted chemicals, the BHCNC was redispersed in DI water (50 mL) and dialyzed against DI water for at least 4 days.

### Assessment of DAMC and BHCNC Functional Groups

To measure dialdehyde group content, never-dried DAMC or BHCNC (e.g., 0.05 g, based on dry mass) was suspended/dispersed in Milli-Q water (50 mL) at pH=3.5, adjusted by a HCl solution (0.1 M). Afterwards, 10 mL of NH₂OH·HCl (5 wt %) was added to the mixture, followed by stirring for 10 min during which pH decreased as a result of hydroxylamine-aldehyde reaction, which produced HCl. To measure the aldehyde content, the solution was titrated using a NaOH solution (10 mM, 0.1 mL min⁻¹) using an automated titrator (Metrohm 907 Titrando, USA) to reach pH=3.5, i.e., the initial pH. The carboxyl content of BHCNC and other BHCNC-based adsorbents (e.g., MINC-treated SG) was measured by conductometric titration. The experiment was conducted on the never-dried adsorbent (0.02 g, based on dry mass, in 140 mL of Milli-Q water). Then, a NaCl solution (20 mM, 2 mL) was added, and the solution pH was decreased to 3 using HCl (0.1 M). The solution was titrated using a NaOH solution (10 mM) at a rate of 0.1 mL min⁻¹ until pH~11 using an automated titrator (Metrohm 907 Titrando, USA). The carboxylate content was measured using the NaOH volume required to neutralize the weak acid, representing dicarboxylate groups.

### Preparation of MINC on a Model Substrate

To prepare MINC and maximize its Nd³⁺ removal capacity, varying amounts of BHCNC were coated on SG as a model substrate via an optimized DA coating procedure. It has previously been established that a DA solution with a concentration of 2 mg mL⁻¹ in 10 mM tris buffer (pH=8.5) incubated for 24 h enables spontaneous thin film formation. Here, 200 mg of dry SG and 80 mg of DA were mixed with varying concentrations of BHCNC dispersion and 0.4 mL of 1 M tris buffer to reach a final volume of 40 mL (yielding 10 mM tris buffer), including the volume of NaOH used for pH adjustment and Milli-Q water. The solution pH was adjusted to ~8.5 using a NaOH solution (0.5 M), and the suspension was incubated at room temperature via constant gentle agitation using nutating mixer (Fisherbrand, USA) for 24 h. The SG microparticles treated with MINC were rinsed with Milli-Q water at least four times and separated by centrifugation at 3000×g for 5 min, followed by drying at 37° C. in an oven overnight for further use.

### Determination of Unreacted DA Concentration

To determine free DA concentration, DA solutions with a concentration ranging from 0-2 mg mL⁻¹ were prepared via successive dilution of a 2 mg mL⁻¹ stock DA solution using Milli-Q-water. The absorbance of solutions was assessed at a maximum absorption wavelength λₘₐₓ=280 nm using a UV-vis spectrophotometer (Tecan Model Infinite 200 Pro, USA), and the corresponding calibration curve was obtained. To ensure that all unpolymerized DA were washed away after MINC formation, DA concentration was measured in the supernatant by the UV-vis spectrophotometry at λₘₐₓ=280 nm.

### Characterization of MINC-Treated SG

### Grafting Ratio of BHCNC

To determine the grafting ratio of BHCNC on the SG, first, the concentration of DA in the supernatant of MINC reaction and subsequently its mass (m_{DA}) was measured by the UV-vis spectrophotometry at 280 nm. Then, 5 mL of the supernatant was dried in an oven at 37° C. overnight to calculate the mass of free (ungrafted) BHCNC (m_{BHCNC}) by subtracting m_{DA} from the mass of total dried residue. The grafting ratio (m_{BHCNC}/m_{SG}) was then calculated using equation (Eqn.) 1.

$${m}_{BHCNC} / {m}_{SG} = \frac{( {m}_{0 , BHCNC} - {m}_{BHCNC} )}{{m}_{SG}} \times 100 \% \qquad ( 1 )$$

where m_{0,BHCNC} (mg) denotes the initial mass of BHCNC used in the MINC reaction, and m_{SG} (mg) is the mass of SG.

### Fourier Transform Infrared (FTIR) Spectroscopy

To identify the functional groups of BHCNC, SG, and MINC-treated SG, infrared spectra were collected on a Bruker Vertex 70 spectrometer equipped with a deuterium triglycerine sulfate (DTGS) detector, according to Bouguer-Beer-Lambert law. Measurements were performed in attenuated total reflection (ATR) geometry using a Harrick Diamax diamond ATR accessory. The spectra were extracted by averaging a total of 100 scans at 6 cm⁻¹ resolution, and the absorbance was calculated by referencing the clean bare diamond spectrum.

### X-Ray Photoelectron Spectroscopy (XPS)

XPS spectroscopy was conducted. A Physical Electronics VersaProbe III instrument, which was combined with a concentric hemispherical analyzer and a monochromatic A1 kα X-ray source (hv=1,486.6 eV) was used. Argon ions and low energy electrons (<5 eV) were used for charge neutralization. CH& band in the carbon 1s spectra at 284.8 eV was used to charge reference the peaks. Note that the calibration of binding energy axis was performed using gold (Au) foils (Au 4f_{7/2}=83.96 eV) and sputter cleaned copper (Cu) (Cu 2p_{3/2}=932.62 eV, Cu 3p_{3/2}=75.1 eV). A sampling depth=3-6 nm was obtained by setting the takeoff angle to 45° versus the surface plane of sample. Instrumental relative sensitivity factors (RSFs) were used for quantification. The diameter of X-ray beam size ~200 μm.

### Scanning Electron Microscopy (SEM) Imaging

The morphology of SG and MINC-treated SG were examined by SEM imaging (ThermoFisher Verios G4, USA). Briefly, the dried samples were placed on a sample holder using an adhesive carbon tape, followed by coating them with a layer of indium (thickness=3 nm) via a vacuum sputtering instrument (Leica sputter coating EM ACE 600, USA). SEM was utilized for imaging using 3 kV accelerating voltage and 6.3 pA beam current through the length detector (TLD) in the field free mode. The particle size distribution of samples was quantified by Image J (version 1.53t 24).

### Nd³⁺ Adsorption Using MINC-Treated SG

A stock Nd³⁺ solution was made via dissolving 180 mg of NdCl₃·6H₂O in Milli-Q water (20 mL). Then, the stock solution was successively diluted using Milli-Q water to prepare varying concentrations of Nd³⁺ solution ranging from 10 ppm to 1400 ppm. The solution pH=5.7, which was tuned using a HCl solution (0.5 M) and Milli-Q water (total sample volume=7 mL). The adsorbent (MINC treated SG, BHCNC, SG, or PDA-SG, 35 mg each) was then added to the Nd³⁺ solution (7 mL), vortexed (5 min), and centrifuged at 3000×g (5 min). The supernatant Nd³⁺ equilibrium concentration (Cₑ) was assessed using the inductively coupled plasma-atomic emission spectrometry (ICP-AES, Thermo iCAP 7400). Removal percentage (R, %) or equilibrium removal capacity (qₑ, mg mL⁻¹) were obtained using Eqns. 2 or 3, respectively.

$$R = \frac{( {C}_{0} - {C}_{e} )}{{C}_{0}} \times 100 \% \qquad ( 2 )$$

$${q}_{e} = \frac{( {C}_{0} - {C}_{e} )}{m} \times V \qquad ( 3 )$$

where C₀ (mg mL⁻¹) is the initial Nd³⁺ concentration, m (g) is the adsorbent mass, and V (mL) denotes the total solution volume.

### Nd³⁺ Recovery and Reusability of MINC-Treated SG

To examine Nd³⁺ desorption from the adsorbent, MINC-treated SG (100 mg) was first dispersed in 20 mL of Nd³⁺ solution (C₀=10 ppm) and vortexed for 5 min to obtain the maximum removal capacity. The supernatant was removed after centrifugation at 3000×g for 5 min and replaced with fresh, Nd³⁺-free Milli-Q water, and the pH was adjusted to 1.5 using a HCl solution (2 M). The final solution volume was 20 mL. The suspension was vortexed (5 min) and centrifuged (3000×g for 5 min), followed by collecting the supernatant and measuring the equilibrium concentration of Nd³⁺ (Cₑ) using the ICP-AES. Desorption percentage (D, %) was obtained using Eqn. 4.

$$D = \frac{{C}_{e}}{( {C}_{0} \times \frac{R}{100} )} \times 100 \% \qquad ( 4 )$$

R is the removal percentage in each cycle.

To assess the reusability of MINC-treated SG, the adsorbent was removed from the solution after the desorption experiment and rinsed with Milli-Q water several times until the pH of supernatant reach the pH of Milli-Q water. Then, the adsorbent was added to a new Nd³⁺ solution (10 ppm), followed by conducting the adsorption experiment. This cycle was repeated 10 times, and R and D for each cycle were measured.

### Competitive Nd³⁺ Removal Using MINC-Treated SG

### Effect of pH on Nd³⁺ Removal

The effect of pH on MINC-mediated Nd³⁺ removal was investigated at low (10 ppm) and high (700 ppm) concentrations of Nd³⁺ via varying pH from 1.5 to 7 using HCl or NaOH solutions. To this end, the adsorbent (MINC-treated SG, 35 mg) was added to the Nd³⁺ solutions (7 mL), vortexed (5 min), and centrifuged (3000 Xg for 5 min), followed by collecting the supernatants and measuring Nd³⁺ concentration using the ICP-AES.

### Effect of Ionic Strength on Nd³⁺ Removal

The effect of monovalent and divalent cations on MINC-based Nd³⁺ removal was studied at low (10 ppm) and high (700 ppm) Nd³⁺ concentrations using NaCl or CaCl₂) solutions, respectively. Each salt was mixed with the Nd³⁺ solutions (final cation concentration=1, 10, 100, 500, or 1000 ppm), and the final pH was adjusted to 5.7 using HCl (0.5 M) and Milli-Q water (final volume=7 mL). The adsorbent (35 mg) was then added to the solutions, vortexed (5 min), and centrifuged (3000 Xg for 5 min), followed by collecting the supernatants and Nd³⁺ concentration measurement using the ICP-AES.

Selective removal of Nd³⁺ against ferric ions (Fe³⁺)

The effect of Fe³⁺, the main ion competitor in magnet leachates, on the MINC-mediated Nd³⁺ removal was investigated at low (10 ppm) and high (700 ppm) Nd³⁺ concentrations. FeCl₃ was mixed with the Nd³⁺ solutions at pH=3, adjusted using HCl (0.5 M). Due to a low weight fraction of Fe³⁺ (<0.2) in FeCl₃ solution at pH=3, control samples were prepared by adding FeCl₃ directly to Nd³⁺ solutions (10 and 700 ppm) without using the adsorbent, yielding a final Fe³⁺ concentration of 8, 30, 57, and 115 ppm, quantified by the ICP-AES. The main samples were then prepared by adding MINC-treated SG (35 mg) to the Fe³⁺-Nd³⁺ solutions (7 mL) with known element concentrations, vortexed (5 min), and centrifuged (3000×g for 5 min). Supernatants were collected for measuring Nd³⁺ and Fe³⁺ concentrations using the ICP-AES.

### Statistical Analyses

Mean±standard deviation (SD) is used to present the data. The analysis of significance was based on the student's t-test (conducted for two distinct groups). In case of three distinct groups, the one-way analysis of variance (ANOVA) was conducted, followed by the post hoc Tukey-Kramer test. p-values≤0.05 were used to identify significantly different groups. Microsoft Excel (Office 2016) or Minitab 20 Web App (Accessed via Penn State, PA, USA) were used for the statistical analyses.

### Results and Discussions

### MINC Development Using BHCNC

FIG. 1C shows an exemplary schematic of an embodiment of the BHCNC synthesis method via the successive (meta) periodate- and chlorite-mediated oxidation of delignified softwood kraft pulp. FIG. 1D shows interaction of Nd³⁺ and dicarboxylate groups of BHCNC, the active component of MINC. FIG. 1E shows MINC composition and interactions with Nd³⁺. FIG. 1F shows MINC chemistry, representing the covalent linkage between DA and BHCNC via the Schiff base reaction, resulting in BHCNC immobilization on SG.

To develop MINC, cellulose fibrils were first converted to BHCNC, bearing dialdehyde and dicarboxylate groups. FIG. 1C presents the synthesis of BHCNC using softwood kraft pulp via consecutive (meta) periodate and chlorite oxidation reactions. A 42 h (meta) periodate reaction resulted in intact DAMC fibers in which C₂ and C₃ were partially modified with aldehyde groups. The dialdehyde groups were mostly converted to dicarboxylates via a 12 h chlorite reaction, yielding a mixture of BHCNC and fully solubilized cellulose chains, separated from each other by fractional precipitation using ethanol as a non-solvent. The aldehyde content of DAMC was ~6.2±0.2 mmol g⁻¹, measured using NaOH volume that neutralized released HCl from the hydroxylamine-aldehyde reaction. The carboxylate content of BHCNC was 5.0±0.2 mmol g⁻¹, measured based on the volume of NaOH used to neutralize the weak acid, e.g., carboxyl groups, marked on the conductometric titration curve shown in the FIGS. The aldehyde content of BHCNC was ~1.1±0.2 mmol g⁻¹, indicating that >80% of DAMC dialdehyde groups have been converted to dicarboxylate groups in BHCNC. Aldehyde groups of BHCNC render it suitable for the Schiff base reaction with DA, preserving a high content of carboxylate groups for ion removal.

A persistent challenge in using nanoparticles for ion removal is to obtain colloidal precipitation at under-stoichiometric adsorbate: adsorbent functional group ratios. FIG. 1D presents the electrostatic interaction of Nd³⁺ and anionic BHCNC. When the nanoparticles are partially saturated with Nd³⁺, BHCNC-Nd species remain colloidally stable without undergoing phase separation as a result of the high charge content and excluded volume of hairs leading to electrosteric repulsion among the nanoparticles. To overcome the colloidal stability limitation, BHCNC is readily coated on SG using PDA, as presented in FIG. 1E. DA undergoes the Schiff base reaction with BHCNC aldehyde groups while being polymerized at pH ~8.5 (FIG. 1F), adhering to the substrate and resembling how mussels adhere to wet surfaces. The pH of reaction was adjusted to 8.5 for optimal PDA-assisted coating.

### MINC Optimization

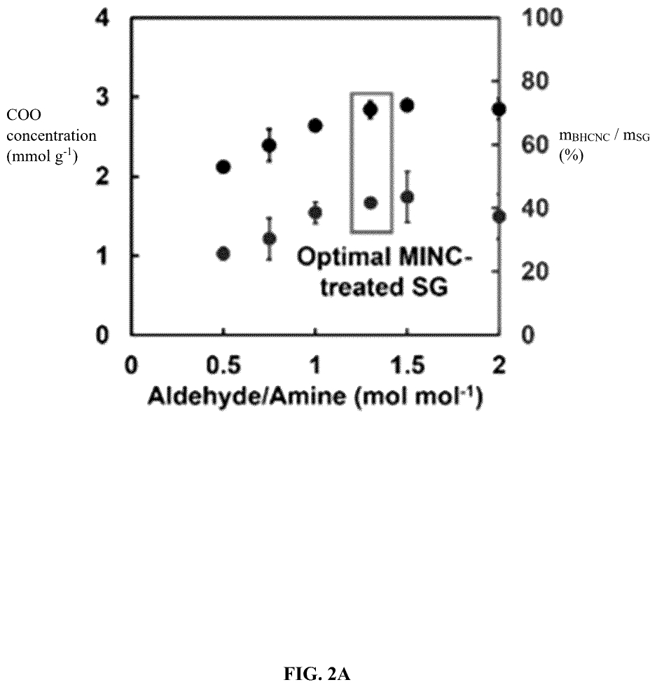

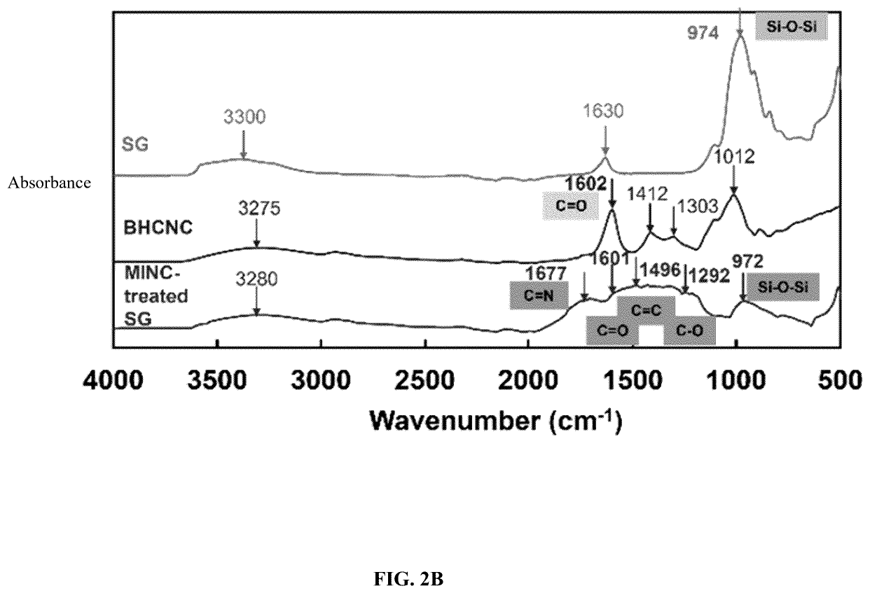

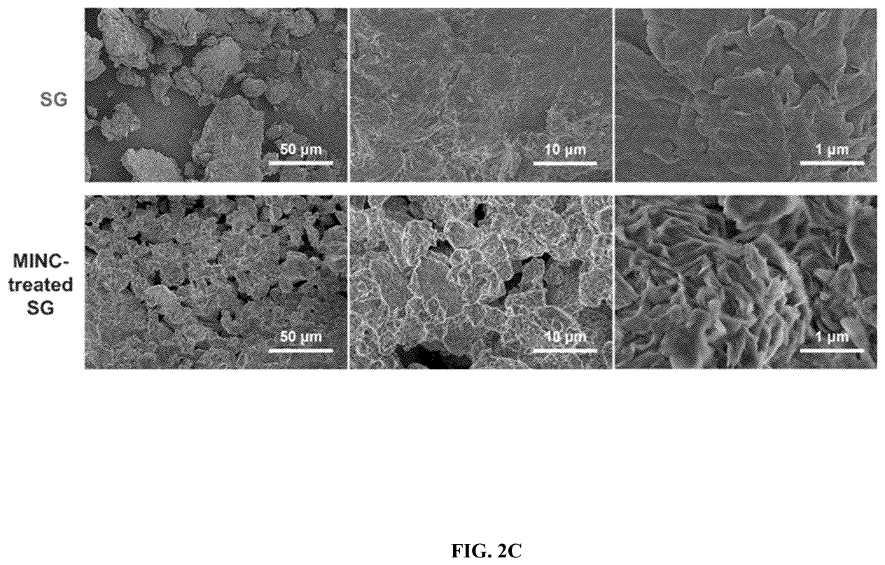

FIG. 2A shows the concentration of carboxylate groups in the MINC-treated SG and the grafting ratio of BHCNC (m_{BHCNC}/m_{SG}) at varying ratios of BHCNC aldehyde to DA amine groups, increased by increasing BHCNC concentration at a fixed DA concentration (2 mg mL⁻¹). The carboxylate groups and m_{BHCNC}/m_{SG} reach a plateau at aldehyde/amine ~1.3 mol mol⁻¹. FIG. 2B shows FTIR spectra of SG, BHCNC and MINC-treated SG. The imine bond on MINC-treated SG confirms the Schiff base formation. FIG. 2C shows SEM images of SG and MINC-treated SG, showing different surface textures of unmodified and modified substrates.

To optimize MINC formulation for maximizing the grafting ratio and accessible carboxylate groups, varying concentrations of BHCNC were coated on SG using DA. FIG. 2A presents the carboxylate group concentration of MINC-treated SG and BHCNC grafting ratio at varying molar ratios of BHCNC aldehyde to DA amine groups, ranging from 0.5 to 2, which correspond to BHCNC concentrations ranging from 5.7 mg mL⁻¹ to 22.7 mg mL⁻¹ at a fixed DA concentration of 2 mg mL⁻¹. The carboxylate group concentration of MINC-treated SG and grafting ratio increased by increasing BHCNC concentration at the aldehyde/amine molar ratios below 1.3 and reached a plateau beyond 1.3. As the number of amine groups on DA are also involved in the amine-quinone conjugation to form PDA on the substrate, only a fraction of amine groups on DA were available to enable the amine-aldehyde Schiff base formation and BHCNC immobilization on SG. Therefore, the saturation of coated BHCNC on the SG via PDA-mediated chemistry was obtained when the aldehyde/amine molar ratio reached 1.3. Based on the carboxylate group content and grafting ratio, the aldehyde/amine molar ratio of 1.3 was selected for preparing the optimal MINC-treated SG.

FIG. 2B presents the FTIR spectra of SG, BHCNC, and MINC-treated SG. In the SG spectrum, the characteristic peaks at 974 cm⁻¹, 1630 cm⁻¹, or 3300 cm⁻¹ (broad peak) were attributed to the asymmetric stretching vibration of Si—O—Si, bending vibration of O—H bonds in the physically adsorbed water on SG, or symmetric stretching vibrations of hydroxyl groups (O—H) in silica, respectively. In the BHCNC spectrum, the characteristic peaks at 10¹² cm⁻¹, 1303 cm⁻¹, 1412 cm⁻¹, 1602 cm-1, and 3275 cm-1 were assigned to CH2—OH—CH₂ stretching, O—H bending, —CH₂ scissor bending, COO⁻ stretching (sodium form), and O—H stretching, respectively. In the MINC-treated SG spectrum, the characteristic peaks at 972 cm⁻¹, 1292 cm⁻¹, 1496 cm⁻¹, 1601 cm⁻¹, 1677 cm⁻¹, and 3280 cm⁻¹ were corresponded to Si—O—Si stretching from SG, C—O stretching from PDA, C═C stretching from PDA, C═O stretching from BHCNC, C═N stretching from an imine bond, and O—H stretching from BHCNC, respectively. The peak associated with the imine bond confirmed the conjugation of BHCNC with PDA via the Schiff base reaction, suggesting that the BHCNC was successfully immobilized on the substrate.

To examine the elemental composition of MINC-treated SG surface and confirm the binding of BHCNC to SG, XPS was conducted. XPS spectra of BHCNC, SG, and MINC-treated SG reveal that Cis peaks were fitted to their constituent subpeaks at 284.75, 285.47, 287.84, 289.04 and 286.41 eV, which are the characteristic peaks of CHₓ, C—N, C═O, COO, and C—O, respectively. The C₁ₛ spectra of BHCNC and MINC-treated SG were appeared at the same binding energy region, showing that the MINC covered the substrate with a layer of BHCNC at a minimum thickness of 3-5 nm, detected by the XPS. Table 1 also shows that the surface Si content reduced from ~21%±7% to ~0.6%±0.3% after coating the SG with the MINC.

TABLE 1
Atomic composition of SG, BHCNC, or MINC-treated SG, analyzed by XPS.

| | Carbon | | | | | | | | | | Oxygen | | | | | | | | |
|---|---|---|---|---|---|---|---|---|---|---|---|---|---|---|---|---|---|---|---|
| | | | C═N, | | | | Nitrogen | | | | | | O═C, | Others | | | | | |
| Sample | C^{total} | CHₓ | C—O | C—(O, N) | C═O | COO | N^{total} | N—C | C—N⁺ | NOₓ | O^{total} | O—C, | O—Si | Al | Ca | Cl | Mg | Na | Si |
| BHCNC | 70.2 | 38.6 | 9.7 | 10.8 | 7.2 | 4.0 | 0.3 | 0.2 | — | 0.1 | 24.2 | 21.4 | 2.8 | — | — | — | — | 5.3 | — |
| SG | 6.1 | 1.8 | — | — | 3.2 | 1.1 | 1.5 | 0.8 | 0.7 | — | 60.3 | O 1s not fit | | 7.1 | 0.8 | — | 3.2 | — | 21.0 |
| MINC- | 63.4 | 32.2 | 7.2 | 13.5 | 6.2 | 4.2 | 0.7 | 0.5 | — | 0.1 | 28.7 | 23.7 | 4.9 | 1.6 | — | 0.5 | — | 4.8 | 0.6 |
| treated SG | | | | | | | | | | | | | | | | | | | |

FIG. 2C shows the SEM images of bare SG and MINC-treated SG at varying magnifications. The SG surface was uniform and dense, whereas the MINC-treated SG resulted in rugged and rougher surfaces. Reviewing the equivalent size distribution of SG and MINC-treated SG, it can be seen that the increase in size from 24±17 μm to 38±11 μm may be attributed to the partial aggregation of particles mediated by PDA.

### MINC-Mediated Nd³⁺ Removal

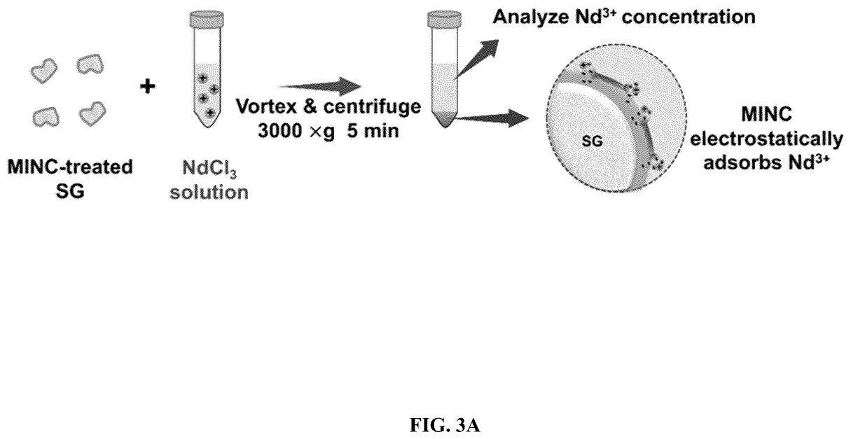

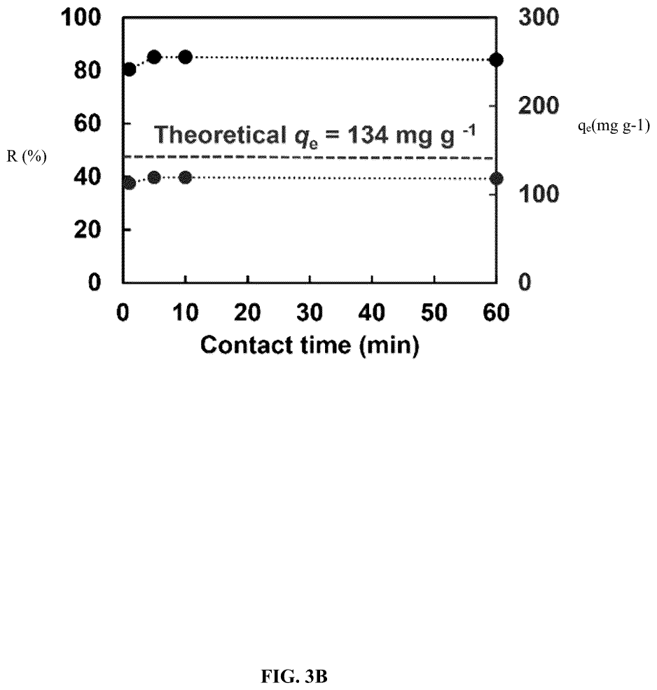

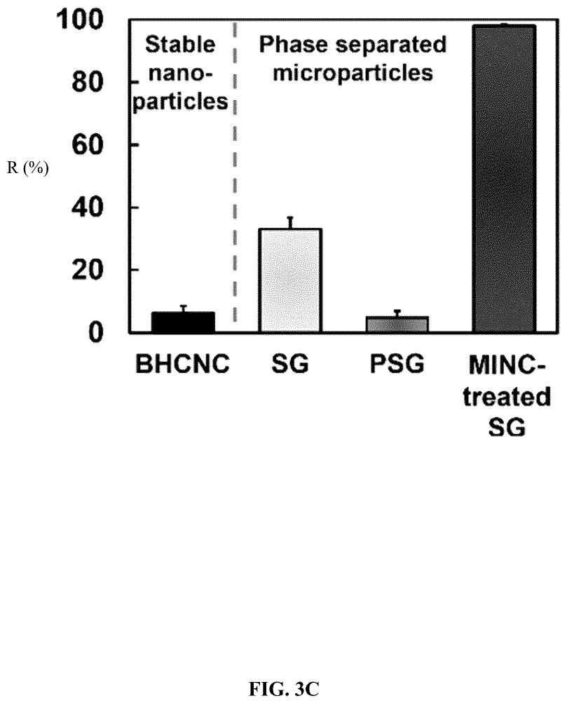

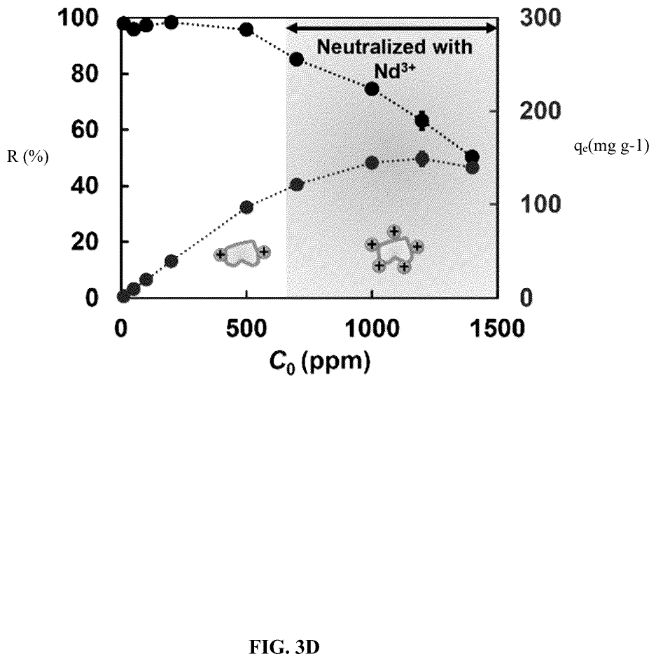

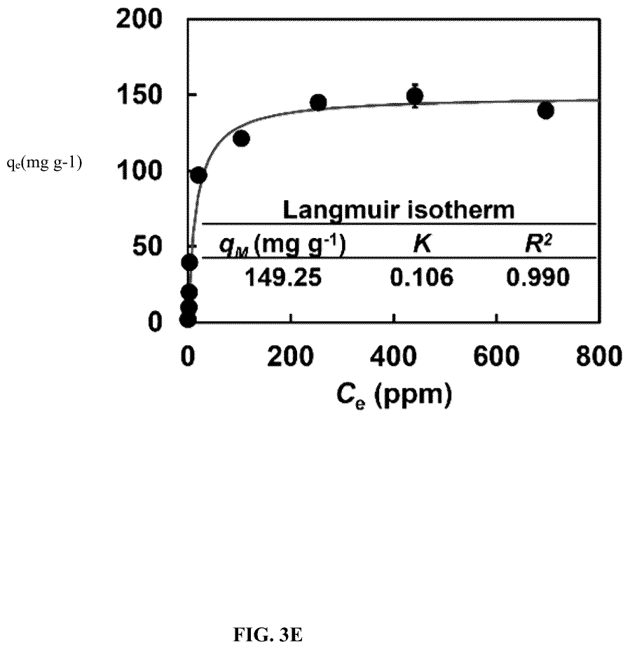

FIG. 3A shows a schematic of Nd³⁺ removal procedure using MINC-treated SG. FIG. 3B shows effect of contact time on MINC-mediated Nd³⁺ removal at C₀=700 ppm. FIG. 3C shows Nd³⁺ removal percentage and capacity of BHCNC, SG, PSG, or MINC-treated SG at C₀=10 ppm. FIG. 3D shows effect of initial Nd³⁺ concentrations on MINC-mediated Nd³⁺ removal percentage and capacity. FIG. 3E shows Nd³⁺ equilibrium removal capacity of MINC-treated SG versus equilibrium Nd³⁺ concentration, fitted to the Langmuir isotherm model. The inset table present the isotherm parameters. In panels B-E, the adsorbent mass is 35 mg.

Dried adsorbents were added to NdCl₃ solutions containing varying Nd³⁺ concentrations. FIG. 3A presents the schematic of MINC-mediated Nd³⁺ removal, which is enabled by the electrostatic interactions between Nd³⁺ and the dicarboxylate groups of BHCNC. FIG. 3B shows the Nd³⁺ removal percentage and capacity of MINC-treated SG versus contact time at C₀=700 ppm. The Nd³⁺ removal percentage and capacity reached a plateau of 85% and 119 mg g⁻¹ in 5 min, respectively, suggesting that Nd³⁺ adsorption to the MINC was almost immediate. The stoichiometric Nd³⁺ removal capacity based on the ratio of COO on the MINC-treated SG and Nd³⁺ concentration in the solution is ~134 mg g⁻¹, which agrees with the experimental value.

The MINC-mediated Nd³⁺ removal at a low Nd³⁺ concentration was investigated as a more industrially relevant system. FIG. 3C presents the removal percentage of 10 ppm Nd³⁺ using BHCNC, SG, PDA-coated SG (PSG), and MINC-treated SG. The Nd³⁺ removal percentage of BHCNC (6.0%±2.4%), PSG (4.0%±2.1%), or SG (29.0±3.7%) was low, whereas MINC-treated SG removed ~100% of Nd³⁺. Despite the high affinity of BHCNC dicarboxylate groups to Nd³⁺,¹⁵ the nanoparticles do not undergo colloidal aggregation at low adsorbate: adsorbent ratios wherein BHCNC-Nd³⁺ complex remains negatively charged and stable in the solution. This shows that nanoscale sorbents decorated with charged groups require a substrate to effectively separate target ions from the solution. The low Nd³⁺ removal percentage of bare SG, as a negative controls for the MINC, was attributed to local negative charges. The PSG particles had an insignificant Nd³⁺ removal because of their PDA-coated surface, bearing cationic groups. A review of the MINC-mediated Nd³⁺ removal percentage versus initial Nd³⁺ concentrations ranging from 1 ppm to 10 ppm reveals Nd³⁺ removal percentage remained near 100% even at low Nd³⁺ concentrations, proving the Nd³⁺ capture effectiveness of MINC in dilute solutions, which is otherwise non-trivial using nanoparticle or polymer adsorbents.

FIG. 3D presents the Nd³⁺ removal percentage and capacity of MINC-treated SG versus initial Nd³⁺ concentrations ranging from 10 ppm to 1400 ppm. The Nd³⁺ removal percentage remained near 100% when the initial Nd³⁺ concentration was less than 500 ppm, followed by a decrease at higher Nd³⁺ concentrations. The removal capacity increased from ~2 mg g⁻¹ to ~140 mg g⁻¹ when the initial Nd³⁺ concentration increased from 10 ppm to 1000 ppm and reached a plateau of ~140 mg g⁻¹ at an initial Nd³⁺ concentration >1000 ppm. This is explained by the saturation of all active binding sites (i.e., dicarboxylate groups) on the MINC-treated SG, leaving the excess Nd³⁺ in the solution. The MINC-treated SG contains ~2.8 mmol g⁻¹ dicarboxylate groups, enabling the removal of 0.95 mmol or 134 mg of Nd³⁺ per gram of adsorbent. The MINC-treated SG adsorption isotherm was obtained based on the equilibrium removal capacity of MINC-treated SG versus Nd³⁺ equilibrium concentration, as presented in FIG. 3E. The removal capacity increased as the equilibrium Nd³⁺ concentration increased to 100 ppm and reached a plateau of ~140 mg g⁻¹. The Langmuir isotherm 43 was used to fit the data according to Ean. 5:

$$\frac{1}{{q}_{e}} = \frac{K}{{C}_{e}} + \frac{1}{{q}_{M}} \qquad ( 5 )$$

in which qₑ, q_{M}, and K denote the removal capacity (mg g⁻¹) at equilibrium, maximum removal capacity (mg g⁻¹), adsorption equilibrium constant, respectively. The linear fitting of data yielded q_{M}=149 mg g⁻¹ and K=0.1053, calculated based on the intercept and slope in Eqn. 5, respectively. The q_{M} obtained is close to the stoichiometric removal capacity (~134 mg g⁻¹), calculated based on the electrostatic interaction governing the adsorption process. The K value indicates that adsorption rate is about 10 times higher than the desorption rate. The Langmuir isotherm fitted the experimental data (R²=0.990), implying the high probability of a monolayer Nd³⁺ coverage on the MINC-treated SG.

### Recovery and Reusability of MINC-Treated SG

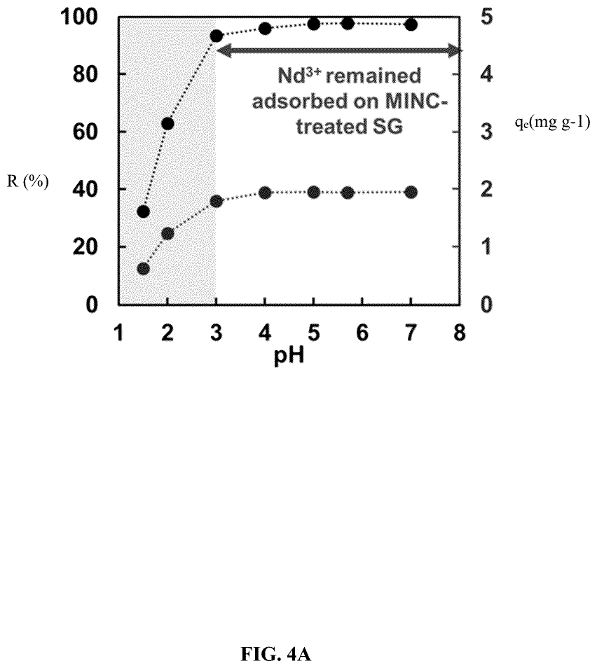

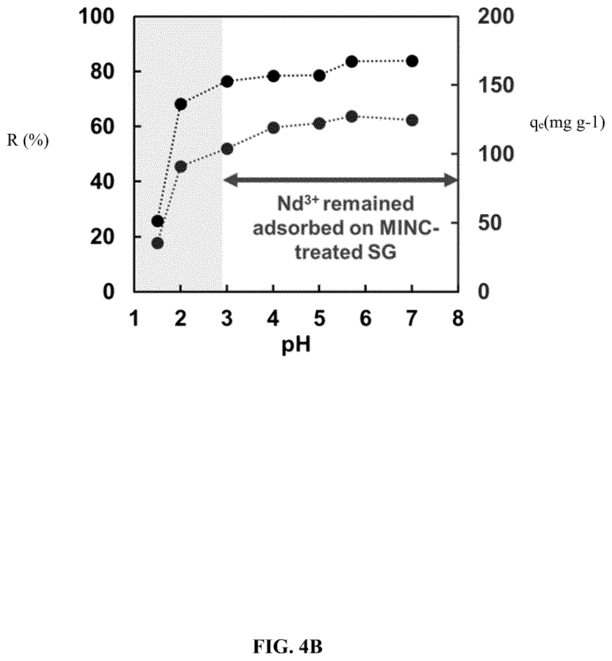

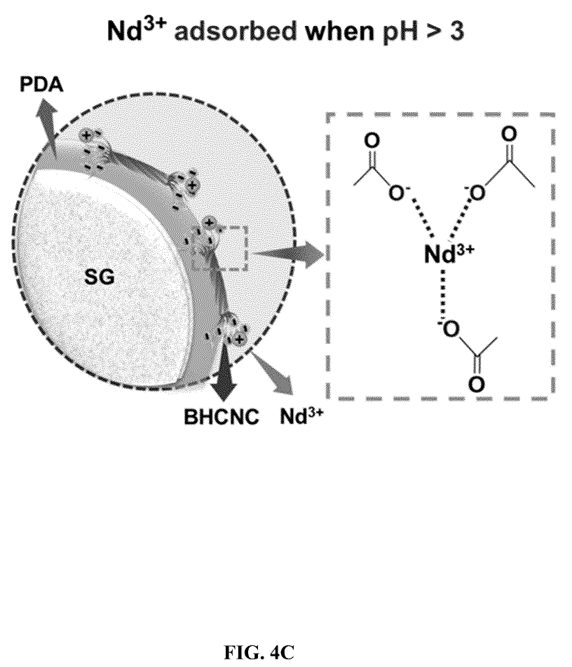

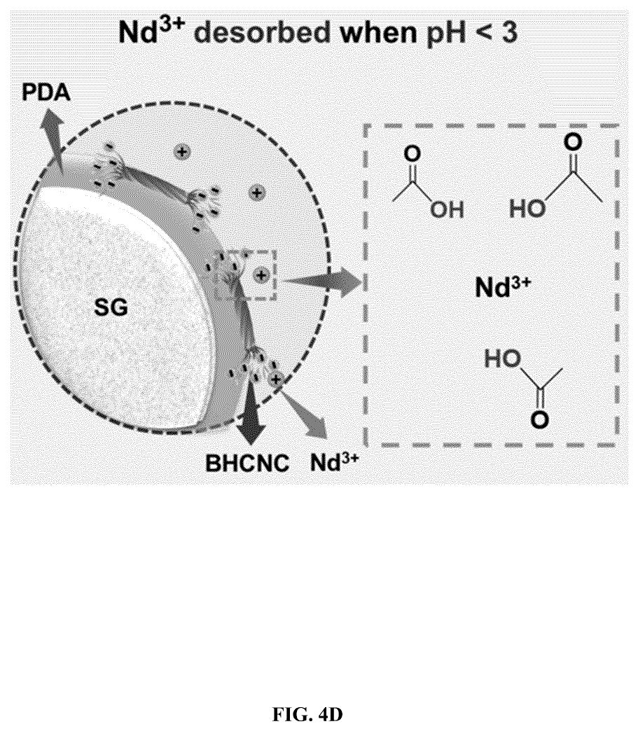

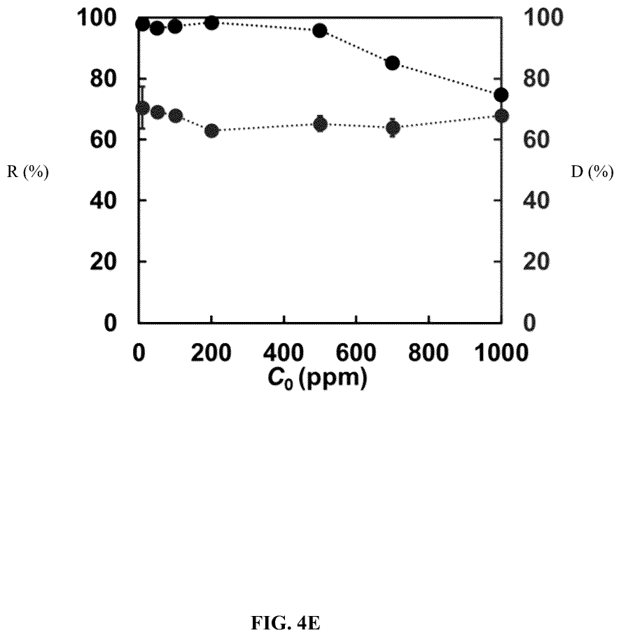

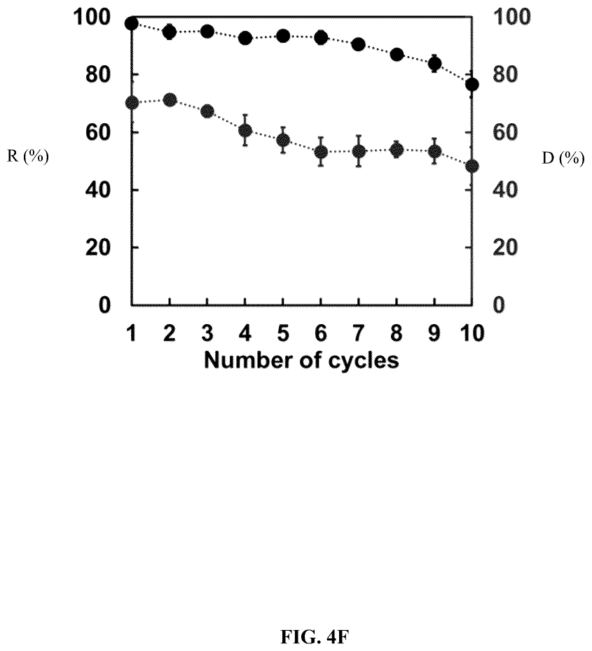

FIGS. 4A and 4B show the effect of pH on MINC-mediated Nd³⁺ removal at (FIG. 4A) low (C₀=10 ppm) or (FIG. 4B) high (C₀=700 ppm) Nd³⁺ initial concentrations. The mass of MINC-treated SG adsorbent is 35 mg. FIG. 4C shows a schematic of Nd³⁺ removal mechanism using the MINC-treated SG at pH >3. FIG. 4D shows a schematic of Nd³⁺ desorption (recovery) mechanism from the MINC-treated SG at pH<3. FIG. 4E shows the effect of initial Nd³⁺ concentrations on MINC-mediated Nd³⁺ removal and desorption. FIG. 4F shows Nd³⁺ removal and desorption percentage of MINC-treated SG versus varying acid wash cycle numbers at C₀=10 ppm.

To recover the adsorbed Nd³⁺ from dicarboxylate-bearing MINC-treated SG, solution pH was decreased. Since the pKₐ values of BHCNC dicarboxylates are 4.9 and 7.9,¹⁵ reducing pH to ~1.5 theoretically protonates ~99% of the weak acid. FIG. 4A presents the Nd³⁺ removal percentage and capacity versus pH at an initial Nd³⁺ concentration of 10 ppm. At pH >3, the removal capacity ~2 mg g⁻¹, and removal percentage remained ~100%, which decreased to ~ 32% at pH=1.5. Such removal percentage was significantly higher than the theoretical value (<1%), which may be explained by the Le Chatelier's principle. The equilibrium reactions (rxn.) regulating the adsorption process are:

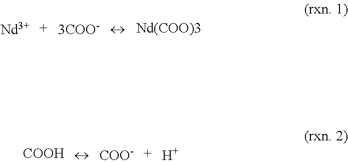

According to Le Chatelier's principle, rxn. 2 may shift to the left at low pH as a result of a high proton concentration. Simultaneously, rxn. 1 may be shifted to right due to the high Nd³⁺ concentration (0.07 mM), which will reduce COO″ concentration. This will shifts rxn. 2 to the right, thus the deprotonated carboxylate group concentration may exceed the theoretical calculation. The reduction of Nd³⁺ removal by decreasing the pH attests to the electrostatically driven adsorption of Nd³⁺ to the MINC, providing the feasibility of controlling ion adsorption and desorption via tuning solution pH. FIG. 4A presents the Nd³⁺ removal percentage and capacity versus pH for an initial Nd³⁺ concentration of 700 ppm. In a similar trend to the low Nd³⁺ initial concentration (10 ppm, FIG. 4A), the removal capacity ~120 mg g⁻¹, and removal percentage remained ~80% at pH >3, which decreased to ~26% when pH decreased to 1.5. The decrease in Nd³⁺ removal percentage and capacity was more significant when the initial Nd³⁺ concentration is low (10 ppm). This is possibly because the higher Nd³⁺ concentration (4.9 mM) favors rxn. 1 in the forward direction, which decreases COO″ concentration. Such decreases may then shift rxn. 2 more to the right, increasing the deprotonated carboxylate group concentration.

FIG. 4C presents the schematic of Nd³⁺ adsorbed to MINC-treated SG at pH >3, resulting from the electrostatic attraction between Nd³⁺ and unprotonated dicarboxylate groups of BHCNC. FIG. 4D presents the schematic of Nd³⁺ desorption from the MINC-treated SG at pH<3, wherein the dicarboxylate groups undergo protonation, liberating the otherwise captured Nd³⁺. The pH-regulated Nd³⁺ adsorption and desorption enable the reuse of MINC-treated SG for multiple times via cyclic pH adjustments.

Upon analyzing the MINC-mediated Nd³⁺ removal and desorption percentage after acid wash cycles at varying pH, we see the Nd³⁺ removal percentage decreased by ~20% after two acid wash cycles; however, the Nd³⁺ desorption percentage increased by ~40% by decreasing the pH from 2 to 1. The tradeoff between Nd³⁺ desorption percentage and removal percentage may be attributed to the partial strong acid-mediated hydrolysis of dicarboxylate-bearing hairs of BHCNC and/or imine bond hydrolysis, breaking the bonds between BHCNC and PDA under extremely acidic condition and resulting in the detachment of BHCNC from the MINC-treated SG. Accordingly, to maximize Nd³⁺ recovery and minimize performance loss, pH=1.5 was selected as the optimal pH for cyclic recovery.

Upon analyzing the dicarboxylate content of MINC-treated SG versus incubation time at PH ~1.5 and acid wash cycles, we see the dicarboxylate content of MINC-treated SG decreased from 2.84 mmol g⁻¹ to 2.04 mmol g⁻¹ after 24 h incubation in the acid or to 2.05 mmol g⁻¹ after 10 cycles of acid wash, possibly as a result of partially hydrolyzed (i) BHCNC hairs and (ii) imine bonds, detaching BHCNC from MINC-treated SG. Upon analyzing the mass ratio of desorbed BHCNC from MINC-treated SG to the total BHCNC (Desorbed BHCNC/Total BHCNC) versus incubation time at pH ~1.5 and acid wash cycles, we see the Desorbed BHCNC/Total BHCNC reached ~20% after acid treatment for 24 h or 10 cycles of acid wash. The detached BHCNC is associated with 28% reduction of dicarboxylate content after acid treatment.

FIG. 4E presents the removal and desorption percentage of Nd³⁺ at varying initial Nd³⁺ concentrations. The Nd³⁺ removal percentage remained ~100% when the initial Nd³⁺ concentration was lower than 500 ppm but dropped by increasing the initial Nd³⁺ concentration as a result of adsorbent saturation. The Nd³⁺ desorption percentage remained ~67±7% when the initial Nd³⁺ concentration increased from 10 ppm to 1000 ppm. The non-desorbed Nd³⁺ may possibly be attributed to the strongly trapped Nd³⁺ on the MINC-treated SG that requires much lower pH to shift rxn. 2 to the left for Nd³⁺ liberation. FIG. 4F presents the Nd³⁺ removal percentage and desorption percentage of MINC-treated SG at varying acid wash cycles. The Nd³⁺ removal percentage remained constant (>95±2%) in at least 5 subsequent cycles and dropped to 78±4% after 10 cycles. The Nd³⁺ desorption percentage also dropped from 67±6% to 48±7% after 10 cycles. Accordingly, the MINC-treated SG is suitable to be successively reused for recovering 10 ppm Nd³⁺ for at least 6 cycles. As the MINC is developed based on cost effective materials, such as cellulose and SG, 6 recovery cycles may be sufficient for industrial use.

MINC selectivity for Nd³⁺

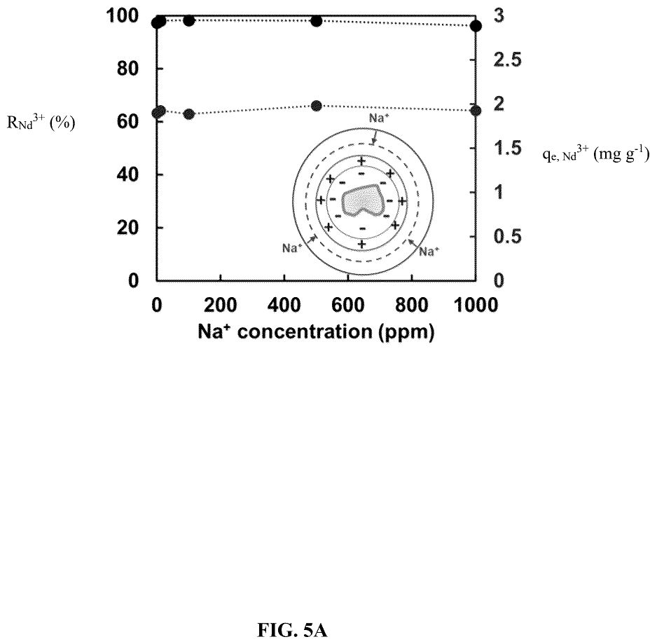

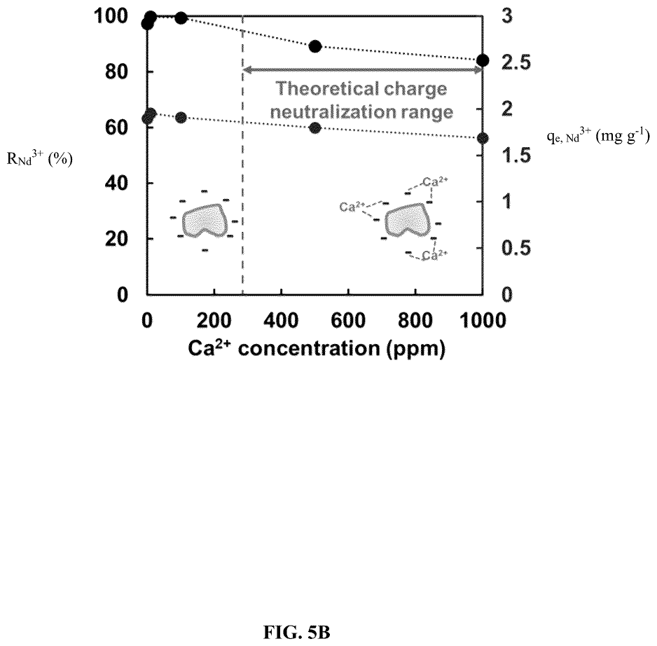

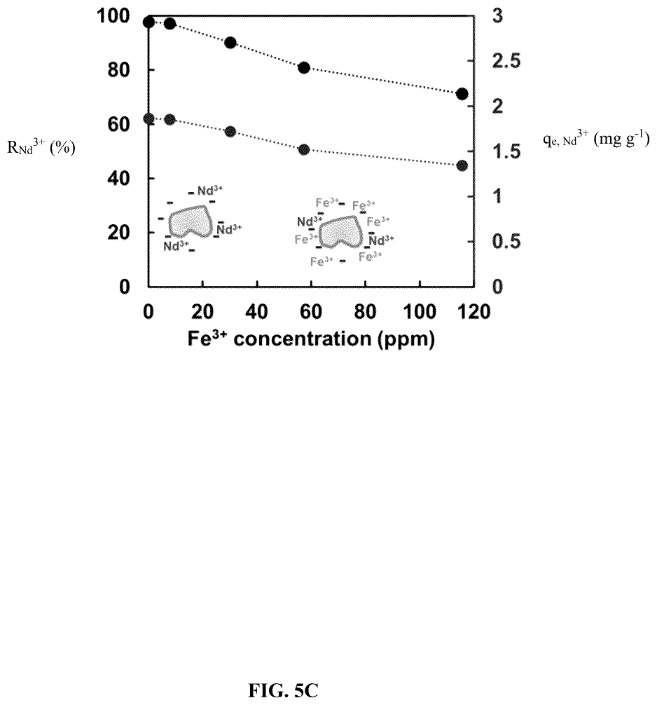

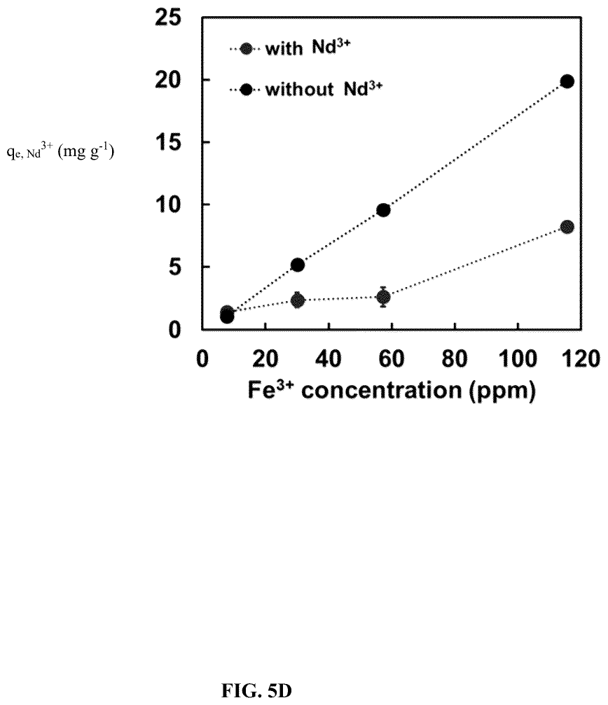

FIGS. 5A, 5B, and 5C show the effects of (FIG. 5A) monovalent ions (Na⁺), FIG. 5B divalent ions (Ca²⁺), or FIG. 5C trivalent ions (Fe³⁺) on the Nd³⁺ removal percentage and capacity of MINC-treated SG at a low Nd³⁺ concentration (C₀=10 ppm). FIG. 5D shows Fe³⁺ removal capacity of MINC-treated SG with or without Nd³⁺.

Monovalent, divalent, or trivalent ions, sourced from NaCl, CaCl₂, or FeCl₃, respectively, were used to assess the effect of ionic strength on the Nd³⁺ removal percentage and capacity of MINC-treated SG. FIG. 5A shows the Nd³⁺ removal percentage and capacity of MINC-treated SG at C₀=10 ppm and varying Na⁺ concentrations. The Nd³⁺ removal percentage and capacity did not significantly change (p=0.12) by increasing the monovalent ion concentrations up to 1000 ppm. The introduction of Na⁺ in the solution decreases the electrical double layer thickness of MINC, which may partially collapse the BHCNC hairs without affecting the deprotonated dicarboxylate groups. FIG. 5B shows the Nd³⁺ removal percentage and capacity of MINC-treated SG at C₀=10 ppm and varying Ca²⁺ concentrations. The Nd³⁺ removal percentage and capacity were reduced ~11% when the divalent cation (Ca²⁺) concentration increased from 0 ppm to 1000 ppm. The introduction of Ca²⁺ to the solution may neutralize the dicarboxylate groups and bridge the hairs, reducing the electrostatic-mediated binding of Nd³⁺. The Ca²⁺ concentrations ranging from 10-1000 ppm correspond to the Ca²⁺: COO molar ratios ranging from 0.0185:1 to 1.85:1 in the MINC-treated SG-mediated Nd³⁺ removal experiments. Stoichiometrically, the carboxylate groups on MINC-treated SG may be neutralized by 270 ppm (7 mM) of Ca²⁺ (one mole of Ca²⁺ neutralized two moles of COO″); however, the Nd³⁺ removal capacity was reduced by only ~11% even at the Ca²⁺ concentration of 1000 ppm, showing the remarkable selectivity of MINC-treated SG for Nd³⁺ against Ca²⁺. The Nd³⁺ selectivity of MINC-treated SG may be attributed to the higher binding energy of COO—Nd (200 times) compared with that of COO—Ca. Upon analyzing the Nd³⁺ removal percentage and capacity of MINC-treated SG at C₀=700 ppm and varying Na⁺ or Ca²⁺ concentrations, we see the same trend as that at low initial Nd³⁺ concentration (C₀=10 ppm).

One of the most competitive ions in Nd³⁺ recovery processes is iron (Fe) as ferrous (Fe²⁺) or Fe³⁺ states, which are generated during the recycling of solid electronic wastes and strong magnets. As a result of the higher valency of Fe³⁺ compared with Fe²⁺, it is expected that aqueous Fe³⁺ solutions create a more competitive environment for the MINC-mediated Nd³⁺ removal. FIG. 5C shows the Nd³⁺ removal percentage and capacity of MINC-treated SG at C₀=10 ppm and varying Fe³⁺ concentrations. Nd³⁺ removal percentage and capacity reduced by ~ 27% when the trivalent ion (Fe³⁺) concentrations increased from 0 ppm to 115 ppm. The Fe³⁺ concentration ranging from 7.69 to 115 ppm corresponds to a Fe³⁺: COO molar ratio ranging from 0.01:1 to 0.15:1. Theoretically, the carboxylate groups of MINC are neutralized by 251 ppm of Fe³⁺ via charge neutralization (one mole of Fe³⁺ neutralizes three moles of COO). Therefore, the introduction of 115 ppm Fe³⁺ should neutralize ~46% of MINC carboxylate groups; however, the Nd³⁺ removal capacity reduced only by ~27%, showing the higher selectivity of MINC-treated SG for Nd³⁺ against Fe³⁺. This may also be explained by the 50-fold higher binding energy of COO—Nd compared with that of COO—Fe.

FIG. 5D presents the Fe³⁺ removal capacity of MINC-treated SG at varying Fe³⁺ concentrations with or without Nd³⁺. By increasing Fe³⁺ concentration from 7 to 115 ppm, the Fe³⁺ removal capacity of MINC-treated SG increased from ~1 mg g⁻¹ to ~20 mg g⁻¹ in the absence of Nd³⁺, whereas it increased to ~8 mg g⁻¹ at 10 ppm of Nd³⁺. This is likely because of the preferential binding of dicarboxylate groups to Nd³⁺ versus Fe³⁺. A review of the Nd³⁺ (C₀=100 ppm) removal percentage and capacity of MINC-treated SG at varying Fe³⁺ concentrations, reveals a similar trend to the low initial Nd³⁺ concentration (C₀=10 ppm). At any Fe³⁺ concentration (e.g., 115 ppm), the higher the Nd³⁺ concentration (e.g., 100 ppm versus 10 ppm), the higher the Nd³⁺ removal capacity (15 mg g⁻¹ versus 1.4 mg g⁻¹) and percentage (76% versus 71%) of MINC-treated SG.

In Table 2, the MINC-mediated Nd³⁺ removal is compared with other sorbents reported in the literature.

TABLE 2
MINC-mediated Nd³⁺ removal and recovery compared with other sorbents
at the lowest and highest reported Nd³⁺ concentrations.

| | | | | | | | Number | |
|---|---|---|---|---|---|---|---|---|
| | | | Contact | | Cₒ | | of | |
| Adsorbent | qₑ (mg g⁻¹) | pH | time | | (ppm) | Selectivity | cycles | Ref. |
| MINC-treated SG | 2-146 | 5.7 | 5 | min | 1-1400 | Na⁺, Ca²⁺, | 6 | This |
| | | | | | | Fe³⁺ | | work |
| Anionic hairy cellulose | 8-264 | 5.7 | 10 | sec | 140-1000 | Na⁺, Ca²⁺, | N/A | ¹⁵ |
| nanocrystal | | | | | | Fe²⁺ | | |
| Macro reticular resin | 80 | 1.25 | 2 | h | 3000 | N/A | N/A | ⁵⁶ |
| Dowex 50X8 | | | | | | | | |
| Graphene oxide | 20.6 | 6 | 120 | min | 70 | N/A | 10 | ⁵⁷ |
| 1-(2-pyridylazo)-2- | 30-105 | 4 | 24 | h | 1-250 | Ca²⁺, Mg²⁺ | N/A | ⁵⁸ |
| naphthol grafted multi- | | | | | | | | |
| walled carbon | | | | | | | | |
| nanotubes-nanosilica | | | | | | | | |
| Hydroxamate | 0-8 | 5 | 30 | min | 0.1-25 | Na⁺, K+, Ca²⁺, | 10 | ⁵⁹ |
| immobilized silica | | | | | | Mg²⁺, Y³⁺ | | |
| Magnetic mesoporous | 65 | N/A | 100 | min | 25 | K⁺, Na⁺, Ca²⁺, | 5 | ⁶⁰ |
| Fe₃O₄@mSiO₂—N,N- | | | | | | Mg²⁺, Co²⁺, | | |
| dioctyldiglycolic | | | | | | Ni²⁺, Cu²⁺, | | |
| nanoparticles | | | | | | Fe³⁺, Al³⁺ | | |
| Carboxyl-functionalized | 175 | 6 | 4 | h | 50-500 | Na+, Ca²⁺, | 5 | ¹⁰ |
| porous carbon | | | | | | Mg²⁺, Al³⁺, | | |
| | | | | | | Fe³⁺ | | |
| Diglycolic acid | 146.2 | 6 | 120 | min | 100 | Ce³⁺, Co²⁺, | 4 | ⁶¹ |
| functionalized | | | | | | Ni²⁺, Sr²⁺ | | |
| electrospun polystyrene | | | | | | | | |
| nanofiber | | | | | | | | |
| Chromium based metal | 67.5 | 5.5 | 120 | min | 100 | Al³⁺, Fe³⁺, | 5 | ⁶² |
| organic framework | | | | | | Ni³⁺ | | |
| Expanded vermiculite | 67.7 | 3 | 24 | h | 14-1700 | N/A | 5 | ¹² |
| Magnetic iron oxide | 25 | 7 | 30 | min | 500 | Na+ | 3 | ⁶³ |
| Imprinted chitosan | 43.63 | 6 | 200 | min | 1-160 | Dy³⁺, Pr³⁺, | 5 | ⁶⁴ |
| composite | | | | | | La³⁺ | | |
| N-methacryloylamido | 1-14 | 5.5 | 30 | min | 10-1000 | Ce³⁺, Eu³⁺, | 12 | ⁶⁵ |
| folic acid-Nd(III) | | | | | | La³⁺ | | |
| imprinted polymers | | | | | | | | |
| Cellulose | 30 | 3 | 24 | h | 50 | Pr³⁺, Dy³⁺, | 5 | ⁶⁶ |

| | |
|---|---|
| nanocrystals/organosilic | Tb³⁺, Fe³⁺ |
| a composite ionic | |
| imprinted mesoporous | |
| films | |

MINC-treated SG have a superior removal capacity than most of other adsorbents. The contact time required for MINC to remove Nd³⁺ (5 min) is notably shorter than other sorbents (hours), which may be a result of the high charge density and hairy structure of BHCNC in the MINC, facilitating ionic interactions. Additionally, MINC-treated SG is reused for Nd³⁺ removal for at least 6 cycles with only a slight reduction (<5%) in the removal capacity. Together, the MINC-mediated Nd³⁺ removal process is an advantageous technology for selectively and rapidly recovering Nd³⁺ in dilute aqueous solutions containing ions such as Na⁺, Ca²⁺, and Fe³⁺.

Despite bearing active functional groups that bind to ions, nanoscale sorbents may maintain their colloidal stability in dilute ion solutions, failing to precipitate and recover the ions. We developed the first mussel-inspired coating using highly functional nanocelluloses called MINC, not only to overcome this limitation, but also to enable the cyclic recovery of Nd³⁺ from dilute aqueous solutions (e.g., C₀=1-100 ppm) within minutes. Hairy cellulose nanocrystals were decorated with aldehyde and carboxylate groups (BHCNC) to orthogonally bind to the amine groups of DA during polymerization, coating a model substrate while maintaining the ion-binding functional groups (carboxylates) available. The Nd³⁺ removal capacity of MINC-treated SG was ~140 mg g⁻¹ at pH ~5.7. The Nd³⁺ removal percentage of MINC-treated SG was at least 90% at C₀=10 ppm after five subsequent recovery cycles. Additionally, the MINC-treated SG selectivity removed Nd³⁺ in aqueous solutions containing ions such as Nat, Ca²⁺, or Fe³⁺. Future works may focus on engineering the MINC to selectively remove Nd³⁺ against other REEs. We envision that the MINC may help address the REE supply shortage by enabling Nd³⁺ recovery from secondary resources.

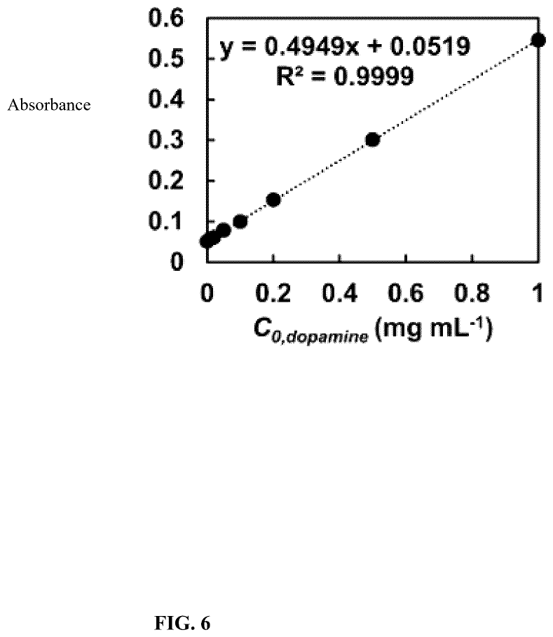

FIG. 6 shows a calibration curve of dopamine (DA) UV-vis absorbance (λₘₐₓ=280 nm) in Milli-Q water.

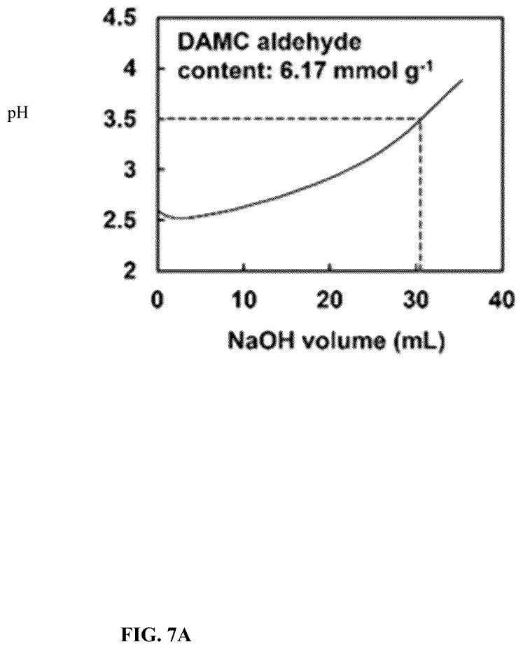

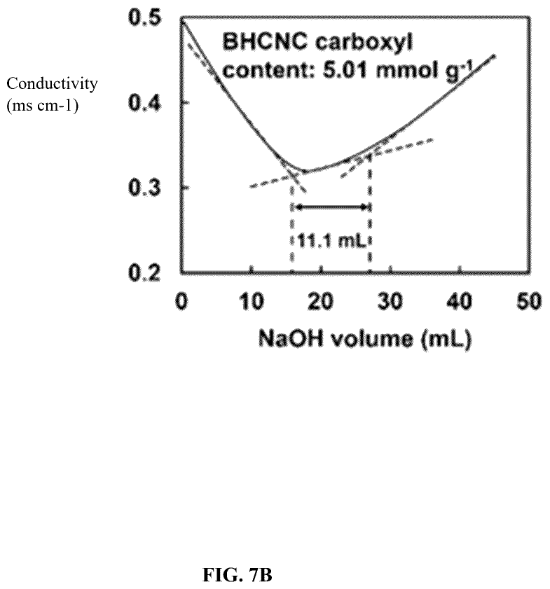

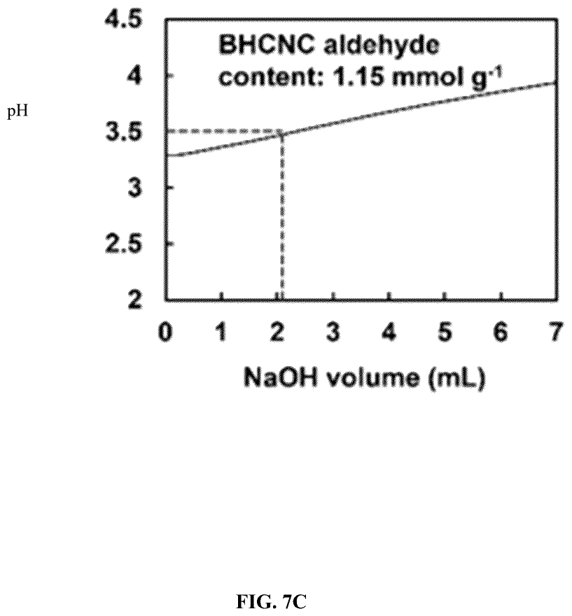

FIGS. 7A, 7B, and 7C show aldehyde and carboxylate content measurements. FIG. 7A shows aldehyde content of DAMC measured by the hydroxylamine hydrochloride titration method. FIG. 7B shows carboxylate content of BHCNC, measured by the conductometric titration. FIG. 7C shows aldehyde content of BHCNC, measured by the hydroxylamine hydrochloride titration method.

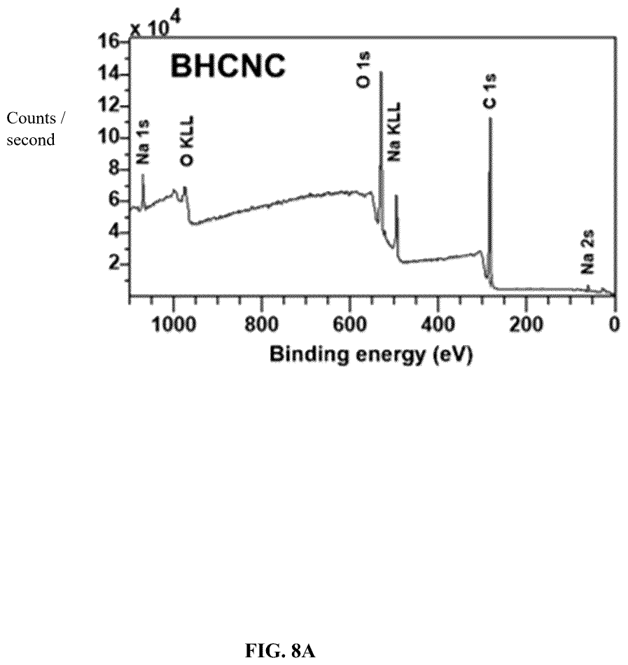

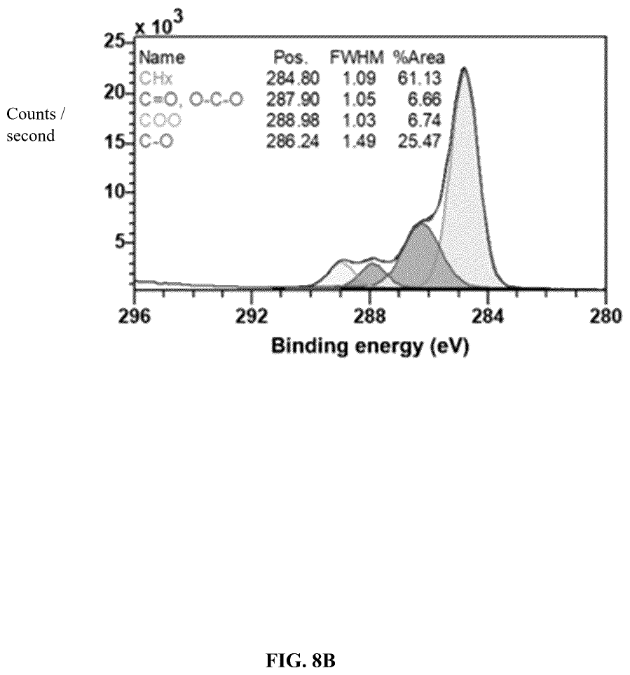

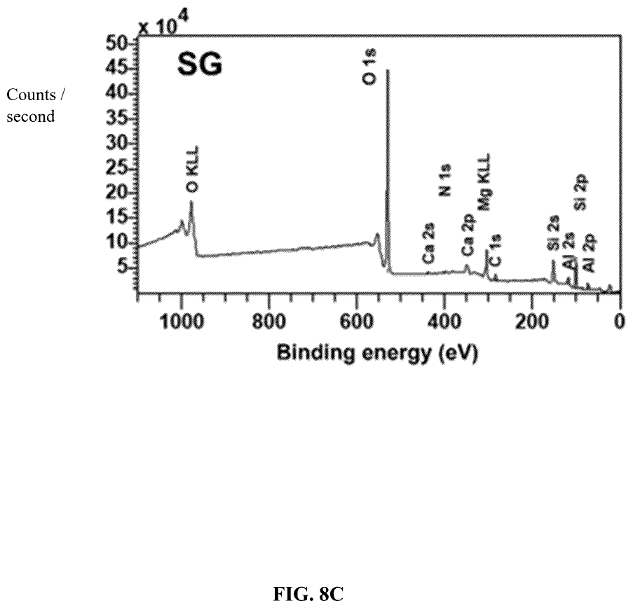

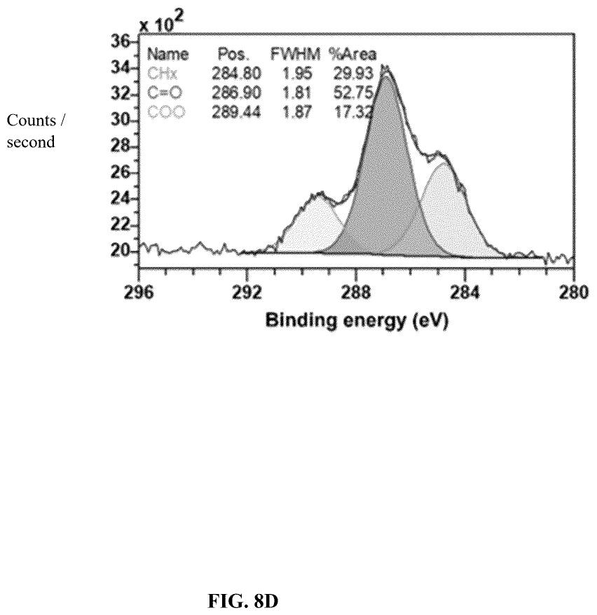

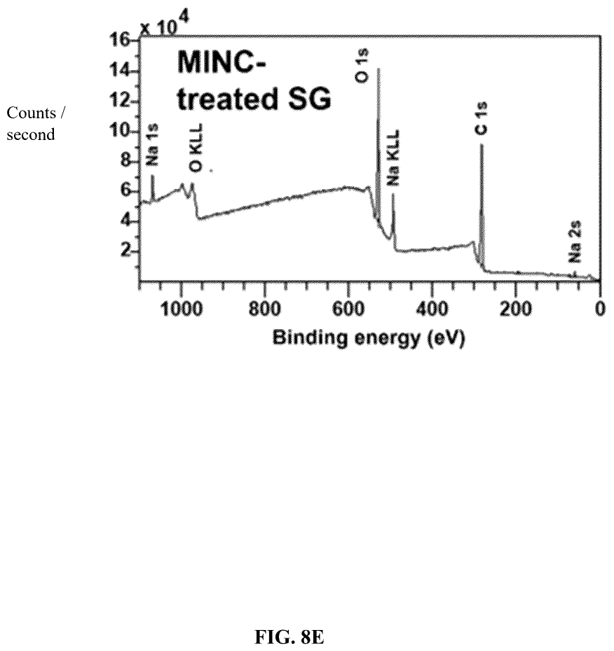

FIG. 8A shows full survey XPS spectra of BHCNC, FIG. 8B shows full survey XPS spectra of SG, and FIG. 8C shows full survey XPS spectra of MINC-treated SG. Cis survey deconvoluted into different carbon bonds for (FIG. 8D) BHCNC, (FIG. 8E) SG, and (FIG. 8F) MINC-treated SG. (Pos. denotes position, FWHM stands for the full width half maximum, % Area means the area percentage).

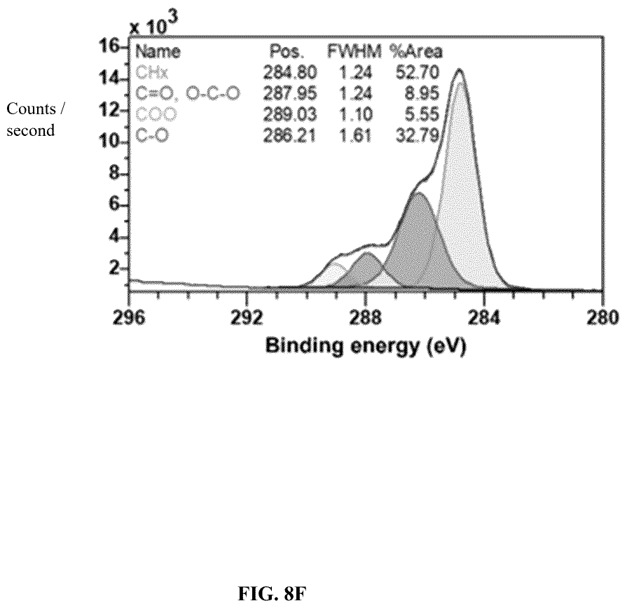

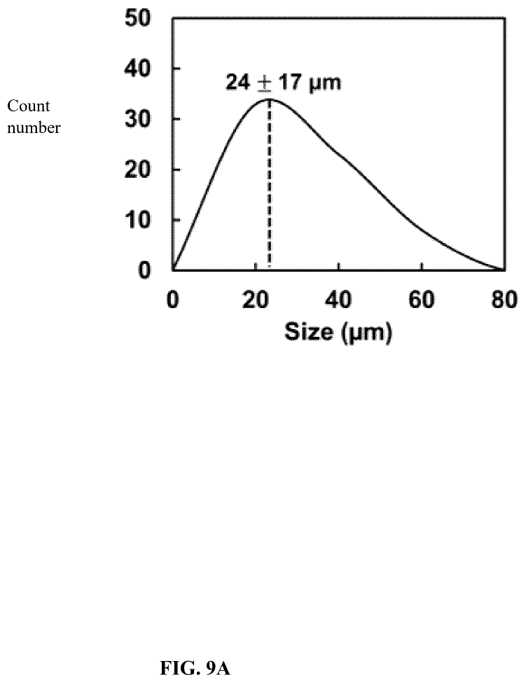

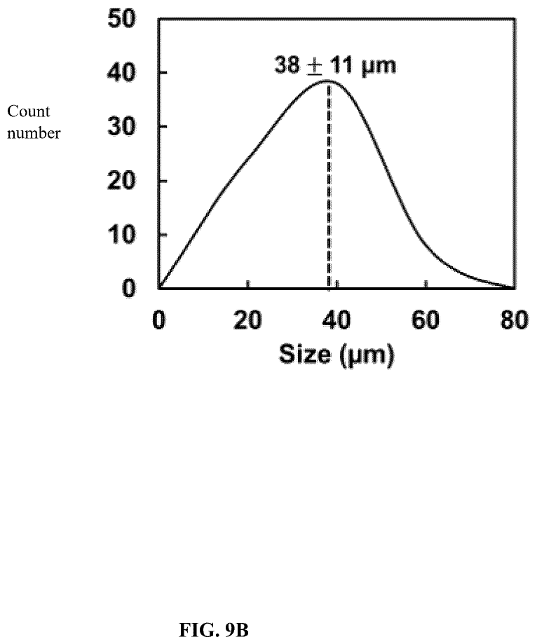

FIGS. 9A and 9B show the equivalent size distribution of SG and MINC-treated SG, analyzed by Image J based on SEM images and considering equivalent circular shapes.

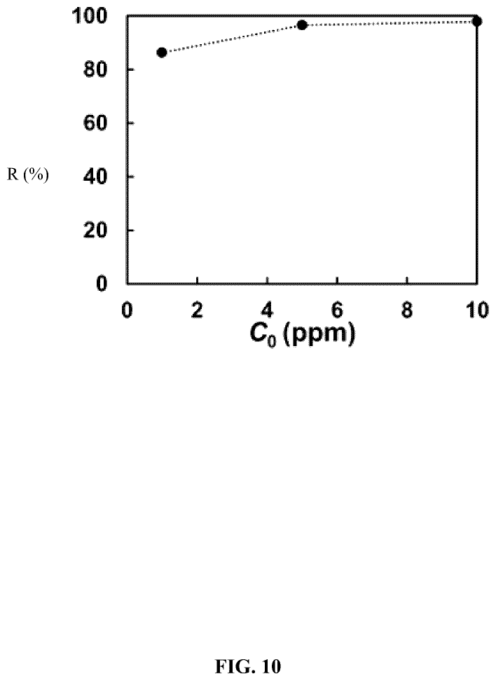

FIG. 10 shows MINC-mediated Nd³⁺ removal percentage at varying initial Nd³⁺ concentrations, ranging from 1 ppm to 10 ppm.

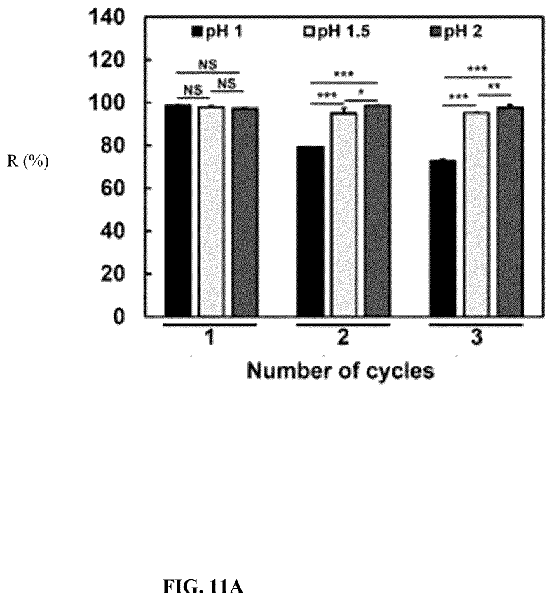

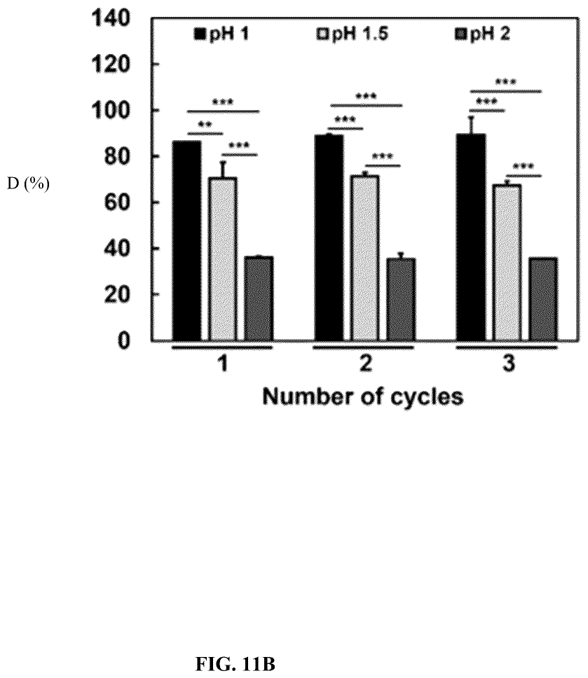

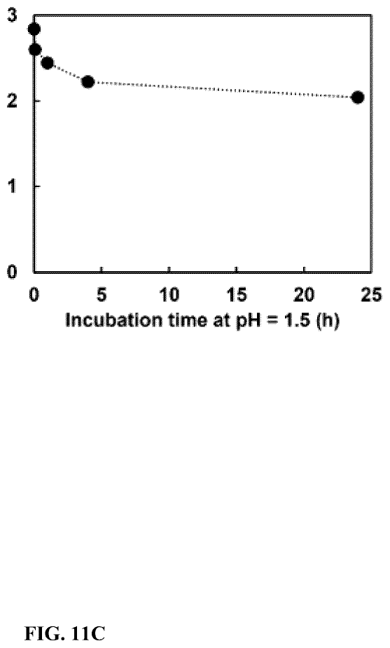

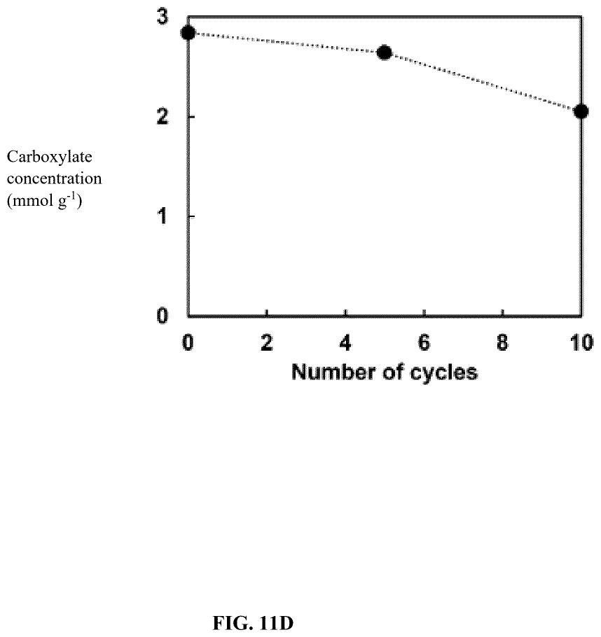

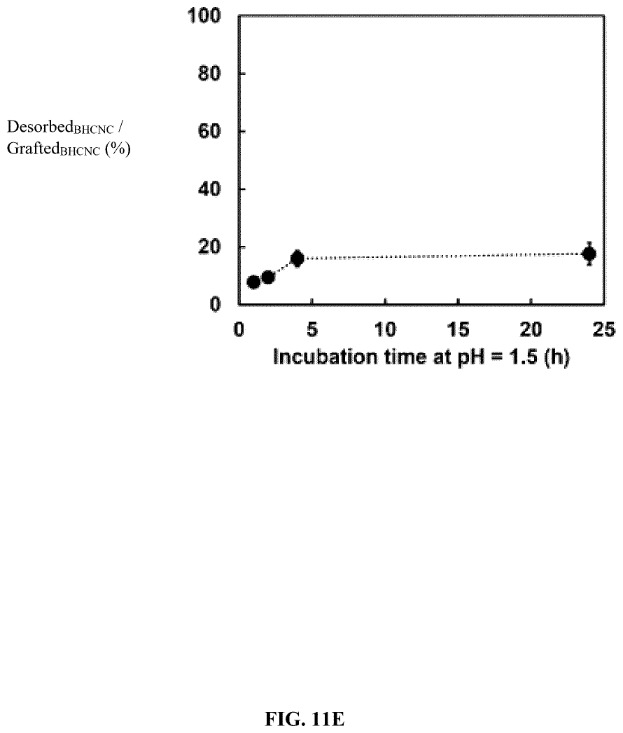

FIGS. 11A and 11B show MINC-treated SG reusability and stability results, wherein the Nd³⁺ (C₀=10 ppm) (FIG. 11A) removal percentage or (FIG. 11B) desorption of MINC-treated SG after varying acid wash cycles at pH=1, 1.5, or 2. FIG. 11C shows carboxylate content of MINC-treated SG after incubating in a HCl solution (pH=1.5) for varying period. FIG. 11D shows carboxylate content of MINC-treated SG versus varying acid wash cycles. The mass ratio of desorbed BHCNC to the total BHCNC on MINC-treated SG is shown in FIG. 11E after incubation in a HCl solution (pH=1.5) for varying period or (FIG. 11F) after varying acid wash cycles. (NS p>0.05, *p<0.05, **p<0.01, and ***p<0.001).

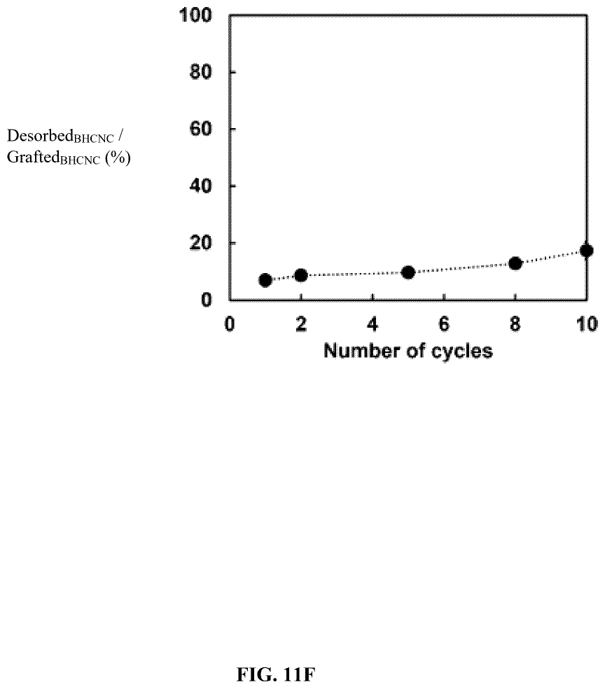

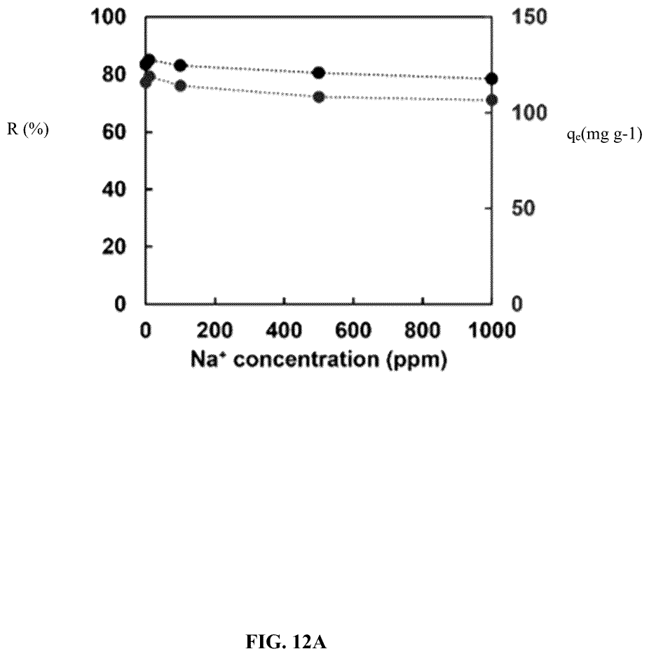

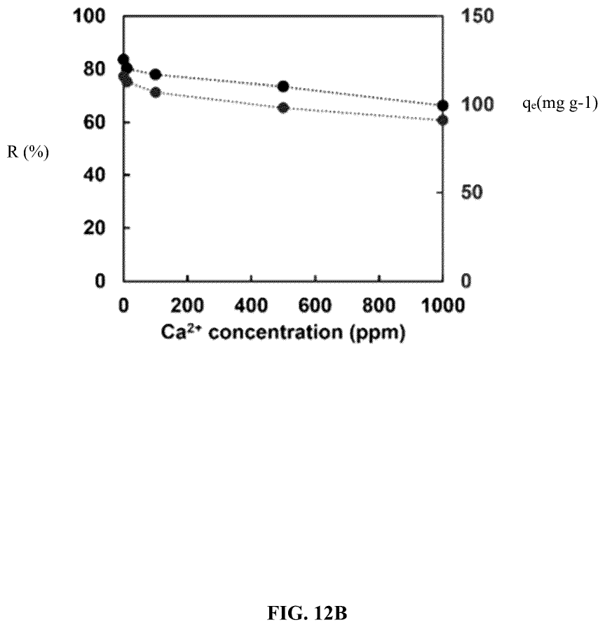

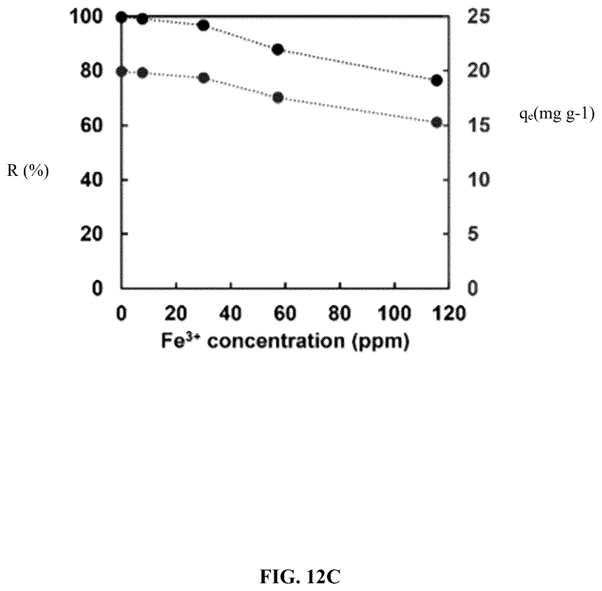

FIGS. 12A, 12B, and 12C show effects of competitive ions on the MINC-mediated Nd³⁺ removal, illustrating effects of (FIG. 12A) monovalent ions (Na⁺), (FIG. 12B) divalent ions (Ca²⁺), or (FIG. 12C) trivalent ions (Fe³⁺) on the Nd³⁺ (C₀=700 ppm) removal percentage and capacity of MINC-treated SG.

Selective separation of heavy and light rare earth elements using hairy cellulose nanocrystals.

Dysprosium (III) (Dy^{III}) is one of the widely used heavy rare earth elements (HREE) for developing advanced magnetic devices and clean energy technologies because of temperature stability and coercivity. Dy^{III} separation from light rare earth elements (LREE), such as neodymium (III) (Nd^{III}), is however extremely difficult as a result of subtle differences in ionic radius and coordination number. Here, we report the unprecedented HREE selectivity of dicarboxylate-modified cellulose chains (hairs) in anionic hairy cellulose nanocrystals (AHCNC), and show other carboxylate-modified celluloses may not achieve such selectivity. The Dy selectivity of AHCNC is ~10 times the Nd^{III} and ~100 times the calcium (II) (Ca^{II}), supported by ~6.5 and ~56 times higher AHCNC binding affinity to Dy^{III} and Ca^{II}, respectively, measured using isothermal titration calorimetry (ITC). This study shows for the first time how a facile chemical modification of cellulose renders it a highly selective biopolymer for HREE separation. We envision that the experimental and theoretical findings of this work may lay the foundation for developing highly selective bio-based adsorbents, enabling sustainable, selective HREE separation from ion mixtures, particularly LREE.

Dysprosium (III) (Dy^{III}), one of the heavy rare earth elements (HREE) with high temperature stability and coercivity, is an enabling element for strong magnets used in engines and generators. Neodymium-iron-boron (NdFeB) magnets, the integral component in various high-tech applications and clean energy technologies such as industrial robotics, wind turbines, and electric vehicles, benefit from Dy^{III}-imparted improved thermal stability. Additionally, Dy is widely used in control rods in nuclear reactor, production of magneto-strictive material in sonar sensors, high-power semiconductors, digital data storage, and commercial lightings. Dy is primary reserved, produced, and exported by the People's Republic of China (PRC). The US is challenged by an 80-fold disparity between domestic mineral supplies and market demands, driven by swift technological advancements, leading to a notable dependence on the imports from the PRC Forecasts suggest a remarkable 2,600% surge in demand for Dy over the next 25 years, and a 700% increase in demand for the light REE (LREE) like neodymium (III) (Nd^{III}). Therefore, Dy^{III} is deemed a critical raw material by the USA Department of Energy (DOE), not only because of the challenges associated with the recovery and reuse, but also the changes in trade policies and suspended operations.

Currently, solvent extraction remains the predominant method for Dy^{III} recovery from primary ores; however, its low efficiency contributes to significant environmental repercussions. Given the lagging domestic production and limited resources, it is imperative to explore alternative resources for Dy^{III}. Ionic liquids Cyanex 923, activated carbon, and polyurethane sponge-supported graphene oxide-titanium phosphate¹⁸ have been used to separate Dy^{III} from electronic wastes or waste solutions to minimize environmental footprints. Nevertheless, the concerns associated with the low sustainability and limited selectivity have hindered practical industrial applications of these adsorbents. We have engineered novel anionic hairy cellulose nanocrystals (AHCNC) for sustainable Nd^{III} removal with a removal capacity up to 264±14 mg g⁻¹. AHCNC consist of a crystalline body sandwiched between two layers of highly charged amorphous, dicarboxylate cellulose chains (DCC, known as hairs). AHCNC were also successfully immobilized on micron-scale silica gel substrates for the cyclic removal of low Nd^{III} concentrations (e.g., 10 ppm). We hypothesize that AHCNC dicarboxylate hairs interact differently with Dy^{III} compared with Nd^{III} and Ca^{II} as result of its larger metal charge density and smaller ionic radius, resulting in Dy^{III} selective removal.

In this work, we test our hypotheses by conducting experimental and theoretical investigations of AHCNC dicarboxylate-modified cellulose chains (hairs) role in selective removal of Dy^{III} over Nd^{III} and calcium (II) (Ca^{II}). We will compare the Dy^{III} selectivity and removal of AHCNC with carboxymethyl cellulose (CMC) and 2,2,6,6-tetramethylpiperidine-1-oxyl-oxidized cellulose nanocrystals (TEMPO-CNC). The binding affinities of Dy^{III}, Nd^{III}, and Ca^{II} to the cellulose-based adsorbents will be studied, and the hydrodynamic size, ζ-potential, and glass transition temperature (T_{g}) of these colloids will be characterized to uncover the colloidal interactions and thermal transitions of ion-bound cellulose-based adsorbents.

### Materials and Methods

### Materials

Sheets of northern bleached softwood pulp from Resolute Inc. (QC, Canada) were used as the starting material to synthesize AHCNC, DCC, and TEMPO-oxidized CNC. Hydrochloric acid (HCl, ACS reagent grade, 37%), calcium chloride dihydrate (CaCl₂·2H₂O, for molecular biology, ≥99.0%), sodium chloride (NaCl, >99.5%), sodium hydroxide (NaOH, ACS reagent grade, >97%), dysprosium (III) chloride hexahydrate (DyCl₃·6H₂O, 99.9% trace metal basis), Neodymium (III) chloride hexahydrate (NdCl₃·6H₂O, 99.9% trace metal basis), sodium (meta) periodate (NaIO₄, >99.0%), hydroxylamine hydrochloride (NH₂OH·HCl, ReagentPlus®, 99%), sodium chlorite (NaClO₂, 80%), ethylene glycol (C₂H₆O₂, ReagentPlus®, >99%), hydrogen peroxide (H₂O₂, 30 wt. %), sodium borate (NaBr, >99%), sodium hypochlorite solution (NaClO, available chlorine of 10-15%), sodium carboxymethyl cellulose (CMC, Mw ~ 90,000, 98%), 2,2,6,6-tetramethylpiperidine-1-oxyl (TEMPO, C₉H₁₈NO, 98%) were purchased from MilliporeSigma, USA. Anhydrous ethanol (200 proof) was obtained from KOPTEC Inc., USA. Dialysis membranes (molecular weight cutoff=8-10 kDa) were purchased from Spectrum Laboratories Inc., TX, USA. Mica sheets (V1 grade) and atomic force microscopy (AFM) stainless steel disks were supplied from Ted Pella Inc. (USA) and SPI supplies (USA), respectively. Aluminum hermetic pans (outer diameter=5.4 mm) with lids were supplied from MSE supplies, USA. Unless otherwise specified, Milli-Q water with a resistivity of 18.2 MΩ cm at 25° C. was used for experiments. Nitrogen gas (N2) cylinder (99.995%) was provided by Linde company (USA). Milli-Q water was obtained by passing deionized (DI) water through an ultrafilter (Biopak Polisher, Millipore, USA).

### Cellulose-Based Adsorbents Synthesis and Characterizations

wTEMPO-CNC synthesis

HCl-mediated hydrolysis of cellulose fibrils to synthesize CNC and the TEMPO-mediated oxidation of CNC were conducted according to the literature. One gram of softwood kraft pulp was chopped into thin, small (~2 cm×2 cm) pieces. Pulp was then hydrolyzed with 40 mL of 2 N HCl in a round bottom flask at 80° C. for 3 h via continuous magnetic stirring at 90 rpm. Following the hydrolysis, the suspension was diluted with 400 mL of DI water to stop the reaction. Afterward, the suspension was centrifuged at 3000×g. The precipitate was repeatedly rinsed with DI water (50 mL each time) and centrifuged at 3000×g for five times, followed by dialysis against DI water for 3 days using dialysis membranes (molecular weight cutoff=8-10 kDa). Following dialysis, the CNC suspension was diluted to 1 wt. % and sonicated using a probe sonicator (Qsonica Ultrasonic Homogenizer Q500, Qsonica, USA) at a frequency of 60 Hz for 30 min, applying on (30 s)/off (30 s) pulses to prevent overheating. The TEMPO oxidation reaction was initiated via adding 15 mg of TEMPO and 165 mg of NaBr to 50 mL of 1 wt. % CNC dispersion. Gradually, a 12.5 wt. % NaClO solution (containing 3 g of solute, 24 mL) was added, and the pH was adjusted to 10 using an NaOH solution (0.5 M). The reaction mixture was magnetically stirred for 3 h at room temperature. Finally, the dispersion of oxidized CNC was purified using dialysis membranes (molecular weight cutoff=8-10 kDa) for 3 days.

### AHCNC and Dicarboxylate Cellulose (DCC) Synthesis

To synthesize AHCNC and DCC from the cellulose pulp, our previously established protocols were followed. Briefly, one gram of softwood kraft pulp, chopped into thin, small pieces (~2 cm×2 cm), was soaked in DI water for ~24 h. The wet pulp was mechanically disintegrated using a fruit blender (Cleanblend 3HP, USA) for 10 min, followed by vacuum filtration. Dialdehyde modified cellulose (DAMC) was synthesized by adding the wet pulp to an aqueous solution, containing 1.32 g of NaIO₄ and 3.8 g of NaCl. Total solvent volume was 65 mL of DI water, including the wet pulp water. The suspension was stirred in a beaker covered with an aluminum foil for 42 h at room temperature. To stop the reaction, the unreacted NaIO₄ was deactivated via adding 1 mL of ethylene glycol to the reaction mixture and stirring for 10 min. DAMC fibrils were then rinsed with DI water at least five times. Each time, the fibrils were dispersed in 50 mL of DI water, stirred for 5 min, and collected by vacuum filtration.

To convert dialdehyde groups to dicarboxylate groups, DAMC was then oxidized with NaClO₂. Never-dried DAMC was mixed with DI water (total volume=50 mL), 0.8452 g of NaClO₂, and 0.8478 mL of H₂O₂ (added dropwise), and stirred for 12 h at room temperature. The mixture pH was maintained at 5.0±0.2 via the intermittent addition of a NaOH solution (0.5 M) within the first 5 h of the reaction. Afterward, the resulting suspension was centrifugated at 27,000×g for 15 min to remove the non-fibrillated precipitates. AHCNC was then precipitated by adding ethanol (0.16 g per 1 g of suspension) to the supernatant, followed by centrifugation at 3000×g for 15 min. Further ethanol was added to precipitate the DCC in the remaining supernatant. To eliminate any unreacted chemicals, the AHCNC and DCC were separately redispersed in DI water (50 mL) and dialyzed using the dialysis membrane against DI water for 3 days.

### Functional Group Density Quantification

The aldehyde group density of DAMC was measured following Kim et al. method. Briefly, 50 mg of never-dried DAMC (based on dry mass) was added to 50 mL of Milli-Q water. The suspension pH was then adjusted to 3.5 using a 0.1 M HCl solution. Subsequently, 10 mL of 5 wt. % NH₂OH. HCl solution, with a pre-adjusted pH of 3.5 (using 0.1 M HCl solution), was added to the suspension. The reaction of NH₂OH. HCl with DAMC dialdehyde groups resulted in the release of HCl, causing a decrease in pH below 3.5. The aldehyde group content was determined by titrating the mixture with a 10 mM NaOH solution at a rate of 0.1 mL min⁻¹ using an automated titrator (Metrohm 907 Titrando, USA) until the pH stabilized at 3.5.

Conductometric titration was conducted to measure the carboxylate group content of AHCNC, DCC, TEMPO-CNC, and CMC. The never-dried materials (0.02 g, based on dry mass) were separately dispersed in 140 mL of Milli-Q water. Subsequently, a NaCl solution (20 mM, 2 mL) was added, and the dispersion pH was adjusted to 3 using a HCl solution (0.1 M). The titration proceeded with a NaOH solution (10 mM) at a rate of 0.1 mL min⁻¹ using an automated titrator (Metrohm 907 Titrando, USA) until pH ~11. The carboxylate group content was determined by measuring the volume of NaOH consumed to neutralize the carboxylate groups (i.e., weak acid groups).

### AFM Imaging

To investigate AHCNC and TEMPO-CNC morphology, an atomic force microscope (Bruker Dimension Icon I, USA), equipped with a silicon nitride probe (Bruker ScanAsyst-Air, USA) was used in the PeakForce tapping mode. A 10 μL droplet of TEMPO-CNC or AHCNC dispersion (concentration=0.1 mg mL⁻¹) was deposited on a freshly cleaved mica sheet, secured to a magnetic stainless-steel disc. After air-drying overnight at room temperature, the discs were rinsed with Milli-Q water five times (200 μL each time) and thoroughly dried at room temperature before imaging. The AFM images were analyzed using the NanoScope Analysis (version 1.80, accessed through Penn State MCL).

### Dy^{III} Adsorption Experiments

Preparation of Dy^{III}, Nd^{III}, or Ca^{II} Stock Solutions

Stock solutions of DyCl₃·6H₂O, NdCl₃·6H₂O, or CaCl₂·2H₂O, containing 1940 ppm of Dy^{III}, 1910 ppm of Nd^{III}, or 1903 ppm of Ca^{II}, respectively, were prepared by dissolving 450 mg of DyCl₃·6H₂O, 475 mg of NdCl₃·6H₂O or 698 mg of CaCl₂·2H₂O in 100 mL of Milli-Q water, respectively.

### Effect of Contact Time on Dy^{III} Removal

The cellulose-based adsorbent (7 mg of AHCNC, DCC, TEMPO-CNC, or CMC) was added to Dy^{III} solutions (2 mM, 7 mL), followed by vortexing (5 min) and incubation for varying contact times (5 min, 10 min, 30 min, 1 h, 2 h, or 4 h) at room temperature. The Dy^{III} concentration was chosen 2 mM or 323 ppm to neutralize all the dicarboxylate groups of AHCNC (~6 mmol g⁻¹), based on the stoichiometric 1:3 molar ratio of Dy^{III} I to AHCNC carboxylate groups. The total solution volume was 7 mL, including the volume of HCl (0.5 M) for pH adjustment to 5.7. At this pH, DyCl₃ is predominantly in the form of Dy^{III}. The mixtures were then centrifugated at 3000×g (5 min), and 5 mL of supernatants was separated. The unadsorbed Dy^{III} concentration in the supernatants was determined using the inductively coupled plasma-atomic emission spectrometry (ICP-AES, Thermo iCAP 7400, USA). The removal percentage (R) and removal capacity at equilibrium (qₑ) were calculated using equations (Eqn.) 6 and 7, respectively,

$$R = \frac{{C}_{0} - {C}_{e}}{{C}_{0}} \times 100 \qquad ( 6 )$$

$${q}_{e} = \frac{( {C}_{0} - {C}_{e} ) V}{m} \qquad ( 7 )$$

where C₀ (mg mL⁻¹) and Cₑ (mg mL⁻¹) are the initial and the equilibrium ion concentration. V (mL) is the total solution volume, and m (g) is the mass of cellulose-based adsorbent.
Effect of Initial Dy^{III} Concentration on Dy^{III} Removal

Dy^{III} solutions with varying initial concentrations ranging from 0.1 mM to 10 mM (16.17 ppm to 1617 ppm), were prepared via diluting the stock solution using Milli-Q water. The cellulose-based adsorbent (7 mg of AHCNC, DCC, TEMPO-CNC, or CMC) was added to the Dy^{III} solutions (7 mL), followed by vortexing (5 min) and incubation for 2 h at room temperature. The total solution volume was 7 mL, including the HCl volume (0.5 M) for pH adjustment to 5.7. The mixtures were then centrifugated at 3000×g (5 min), and 5 mL of supernatant was separated for Cₑ measurement using the ICP-AES. R and qₑ were calculated using Eqns. 6 and 7, respectively.

Effect of Ca^{II} or Nd^{III} on Dy^{III} Removal

The effect of Ca^{II} or Nd^{III} on Dy^{III} removal using cellulose-based adsorbents was investigated at a constant Dy^{III} concentration (2 mM) and varying CaCl₂) or NdCl₃ concentrations, respectively. Each salt was added to the 2 mM Dy^{III} solutions (final Ca^{II} or Nd^{III} concentration=0.1, 0.2, 0.5, 2, 5, 7.5, or 10 mM), and the final pH was adjusted to 5.7 with a HCl solution (0.5 M) and Milli-Q water (final volume=7 mL). The cellulose-based adsorbent (AHCNC, DCC, TEMPO-CNC, or CMC, 7 mg each) was added to the solutions, followed by vortexing (5 min) and incubation for 2 h at room temperature. The mixtures were then centrifuged at 3000×g (5 min), and 5 mL of supernatants were collected for measuring the Cₑ of Dy^{III} and Nd^{III} using the ICP-AES. R and qₑ, (for Dy^{III} or Nd^{III}) were calculated using Eqns. 6 and 7, respectively.

### Characterization of Ion-Induced Aggregates

### Ion Concentration Effect on the Aggregate Hydrodynamic Size and ζ-Potential

The hydrodynamic size of AHCNC, DCC, CMC and their corresponding ion-induced aggregates were assessed via dynamic light scattering (DLS) spectroscopy using a Zetasizer Nano series instrument (Malvern Instrument Ltd. Inc., UK). Prior to the measurements, cellulose-based adsorbents (1000 ppm) were separately mixed with varying concentrations of ions (final concentrations=0, 0.1, 0.5, 2, 5, or 10 mM, pH adjusted to 5.7 using a 2 M HCl solution), and the total mixture volume was fixed at 1 mL. Then, 70 μL of each sample was transferred to low-volume quartz cuvettes (ZEN2112, Malvern, UK) for the DLS spectroscopy. The measurements were conducted at a scattering angle of 90° at 25° C. The Z-average, representing the cumulants mean of the intensity measurements, was reported as the hydrodynamic equivalent size of particles.

To determine the ζ-potential, electrophoretic light scattering (ELS) was conducted to acquire the electrophoretic mobility of particles using the Zetasizer Nano series instrument (Malvern Instruments Ltd. Inc., UK). Prior to the measurements, cellulose-based adsorbents (final concentration=1000 ppm) were separately added to solutions with varying initial concentrations of ions (final ion concentration: 0, 0.1, 0.5, 2, 5, or 10 mM, pH adjusted to 5.7 using a 2 M HCl solution) with a total volume of 1 mL. Afterward, 900 μL of samples was transferred to a universal dip cell kit for the measurements. The ζ-potential values were corrected for their cylindrical shape (i.e., non-spherical) using Ohshima's mobility expression for charged cylindrical colloidal particles. Measured by AFM, the width of AHCNC and TEMPO-CNC was ~3 nm and ~6 nm, respectively, and the final ion concentration ranged from 0.1 to 5 mM, thus the Debye-Hückel length κ⁻¹ was in the order of 10 nm, and κa<1 (κ denotes the Debye-Hückel parameter, and a denotes the rod-like AHCNC or TEMPO-CNC radius). Therefore, Henry's function, i.e., f(κa)→0.5 was used to estimate the ζ-potential using Eqn. 8

$${μ}_{av} = \frac{{ε}_{r} {ε}_{0}}{3 η} ζ [ 1 + 2 f ( κ a ) ] \qquad ( 8 )$$

where μₐᵥ is the electrophoretic mobility of a cylindrical particle that is randomly positioned in an applied electric field, εᵣ and ε₀ are the relative permittivity of water and electric permittivity of vacuum, respectively, and n is the viscosity.

### Isothermal Titration Calorimetry (ITC)

The binding of AHCNC, DCC, TEMPO-CNC, or CMC to the ions was investigated using ITC binding experiment based on an established protocol. Measurements were carried out on an Automated Affinity isothermal titration calorimeter (TA instrument, USA). The syringe was filled with stock solution of ion (Ca^{II}, N^{dIII} or Dy^{III}) and the sample cell was loaded with 1 mg mL⁻¹ cellulose-based adsorbent. Titrations were conducted at 25° C., involving 35×1.5 μL injections, with stirring at 125 rpm and 360 s equilibration time between injections. The data were fitted using NanoAnalyze software (version 3_12_0, Copyright 2020 Flexera) assuming one binding site with the independent model and two binding sites with the multiple sites model. This analysis provided the dissociation constant (K_{D}), enthalpy of dissociation (ΔH), and entropy of dissociation (ΔS).

### Differential Scanning Calorimetry (DSC)

DSC was conducted using a Q2000 temperature-modulated DSC (TA instrument, USA). The samples were first frozen at −80° C., and lyophilized at pressure=0.01 mbar overnight using a FreeZone benchtop freeze dryer (Labconco, USA). Then, approximately 5 mg of each sample was transferred to aluminum pans and tightly sealed using a TZero Press (TA instrument, USA). An empty pan was used as a reference. The heat flow rate curves were acquired via heating the samples from room temperature to 200° C. at a constant heating rate of 10° C. min⁻¹ under N₂ flow.

### Statistical Analyses

The data are presented as the average of three independent samples (n=3) with standard deviation (SD) values. Statistical significance was assessed using a t-test for comparisons between two groups. The p-values <0.05 were considered statistically significant, representing by the symbols *, **, and *** for p<0.05, p<0.01, and p<0.001, respectively. The p-values >0.05 were reported as nonsignificant (NS) All statistical analyses were conducted using the GraphPad Prism (Version 9.4.1, USA).

### Results and Discussion

### Development and Characterization of Cellulose-Based Adsorbents

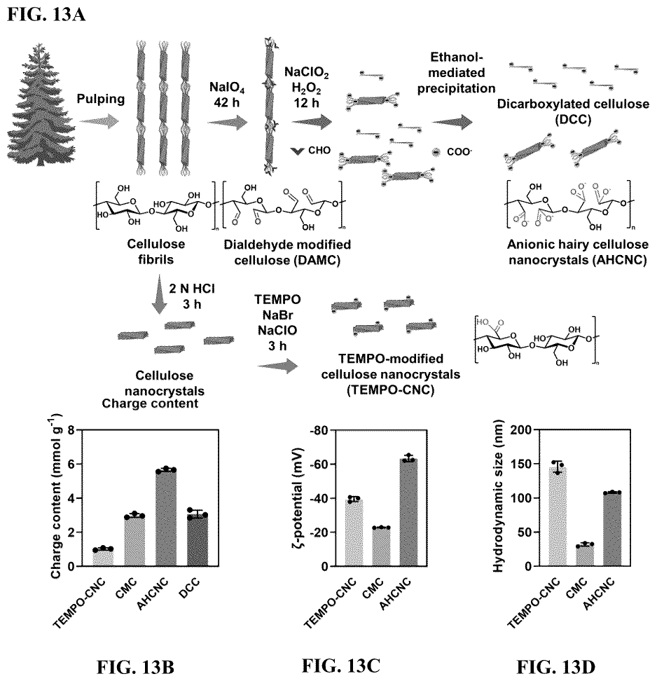

The main adsorbent in this study is AHCNC (cellulose nanocrystals bearing polyanionic disordered cellulose chains), which was compared with several anionic cellulose-based adsorbent controls, including TEMPO-CNC, DCC (isolated polyanionic disordered cellulose chains), and CMC. AHCNC, TEMPO-CNC, and DCC were synthesized, and CMC was purchased. To produce the cellulosic adsorbents, cellulose fibrils underwent distinct transformations, as shown in FIG. 13A. AHCNC were synthesized through sequential periodate and chlorite oxidation reactions. Following a 42 h periodate reaction, intact DAMC fibrils, bearing partially aldehyde group-modified C2 and C3 was produced. A subsequent 12 h chlorite reaction converted most of the aldehyde groups to carboxylate groups, resulting in a mixture of AHCNC and DCC. Non-solvent (ethanol)-mediated fractional precipitation was conducted to separate AHCNC from DCC. TEMPO-CNC was synthesized through HCl hydrolysis and subsequent TEMPO-mediated oxidation to introduce carboxylate groups to CNC. Stable nitroxyl TEMPO radicals, combined with NaBr, were dissolved in the CNC dispersion at pH ~10. The addition of a NaClO solution, serving as the primary oxidant, initiated the oxidation of primary hydroxyl groups to carboxylate groups on CNC.

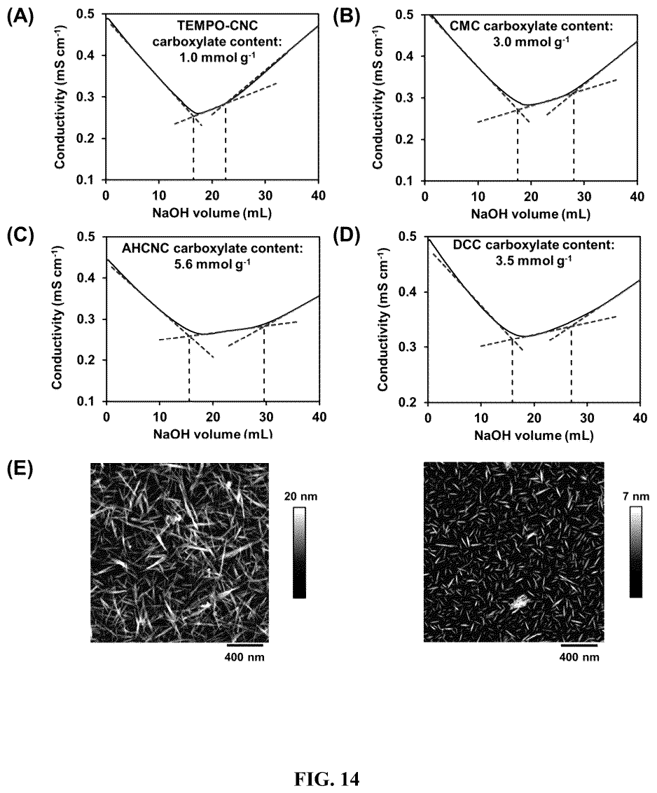

The charge content, ζ-potential, and hydrodynamic sizes of TEMPO-CNC, CMC, AHCNC, and DCC are presented in FIGS. 13B, 13C, 13D, respectively. The carboxylate content of TEMPO-CNC, CMC, AHCNC, and DCC was 1.1±0.1 mmol g⁻¹, 3.0±0.1 mmol g⁻¹, 5.7±0.1 mmol g⁻¹, and 3.1±0.2 mmol g⁻¹, respectively, which were based on the volume of NaOH used to neutralize the weak acid, as indicated on the conductometric titration curves shown in FIGS. 14A, 14B, 14C, and 14D. In the TEMPO-mediated reaction, the selective oxidation was limited to hydroxymethyl groups on C6 in cellulose, resulting in the formation of charged carboxylate moieties without affecting the secondary hydroxyls. In contrast, during AHCNC and DCC synthesis, the kinetically accessible disordered regions of cellulose are harnessed, resulting in a significantly higher carboxylate content (on C2 and C3) than that yielded in TEMPO-CNC. The ζ-potential of TEMPO-CNC, CMC, and AHCNC was −39.6±1.5 mV, −22.9±0.3 mV, and −63.4±1.9 mV (pH=5.7), respectively, confirming the negatively charged groups (carboxylates). AHCNC had the highest ζ-potential among other cellulose-based adsorbents, which correlated with the highest carboxylate content (5.7±0.1 mmol g⁻¹). The hydrodynamic equivalent sizes of TEMPO-CNC, CMC, and AHCNC were 146±8 nm, 31±3 nm, and 108±1 nm, respectively. It is worth noting that DCC was not detected by the DLS. FIGS. 14E and 14F present the AFM images of TEMPO-CNC and AHCNC, respectively. The nanoparticles are needle-like, and their length and width are 194±81 nm and 6±3 nm for TEMPO-CNC and 95±30 nm and 3±1 nm for AHCNC, respectively. These dimensions are similar to conventional CNC and comparable to the reported values in the literature.

FIGS. 13A, 13B, 13C, and 13D show synthesis and characterization of cellulose-based adsorbents. FIG. 13A is a schematic of AHCNC synthesis via the successive periodate- and chlorite-mediated oxidation of delignified softwood kraft pulp, as well as TEMPO-CNC synthesis via the HCl hydrolysis, followed by the TEMPO-mediated oxidation of delignified softwood kraft pulp. FIG. 13B is charge content, FIG. 13C is-potential, and FIG. 13D is hydrodynamic equivalent size of TEMPO-CNC, CMC, AHCNC and DCC. Note that DCC is unable to be detected by DLS, thus no data is included for the ζ-potential and hydrodynamic size.

### AHCNC-Mediated Dy^{III} Selective Removal

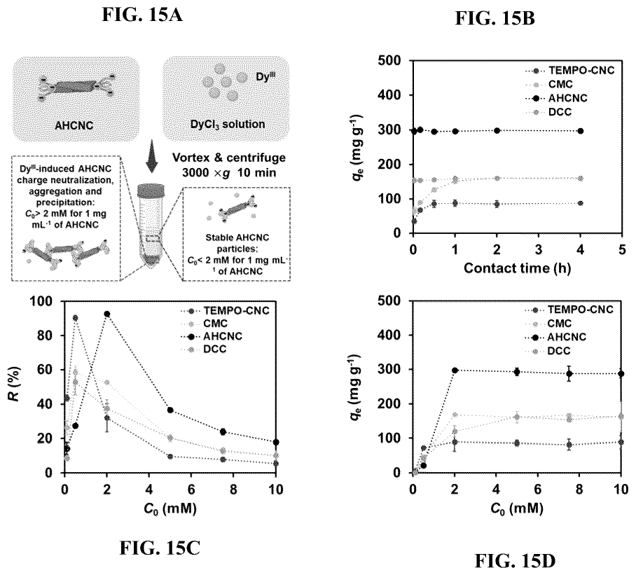

AHCNC was used to remove Dy^{III} in a batch process, which was also compared with other cellulosic adsorbents, including TEMPO-CNC, CMC, and DCC, bearing carboxylate groups. FIG. 15A shows the schematic of Dy^{III} removal using AHCNC via electrostatic interactions. Given that 2 mM of Dy^{III} neutralizes 1 mg mL⁻¹ of AHCNC, at Dy^{III} C₀<2 mM, AHCNC were only partially saturated with Dy^{III}, remaining colloidally stable in the supernatant without phase separation. At Dy^{III} C₀>2 mM, the AHCNC was fully saturated with Dy^{III}, inducing charge neutralization, aggregation, and precipitation. In FIG. 15B, the qₑ of cellulose-based adsorbents is plotted versus contact time at C₀=2 mM (323 ppm). The qₑ of AHCNC and DCC instantly reached a plateau of ~300 mg g⁻¹ and ~160 mg g⁻¹, respectively, implying the immediate Dy³⁺ adsorption to the dicarboxylate chains and separation. The stoichiometric Dy^{III} removal capacity based on the 3:1 molar ratio of COO⁻ on the AHCNC or DCC and Dy^{III} is ~ 303 mg g⁻¹ and ~159 mg g⁻¹, respectively (carboxylate content=5.7 mmol per gram of AHCNC or 3.1 mmol per gram of DCC, electrostatically binding ~1.9 mmol or ~1.0 mmol of Dy^{III} per gram of adsorbent, respectively), which agreed with the experimental values. TEMPO-CNC and CMC required ~1 h to reach the plateau of qₑ at ~85 mg g⁻¹ and ~160 mg g⁻¹, respectively. The results suggest that the dicarboxylate chains of disordered cellulose may be more kinetically accessible than the crystalline counterpart, inducing rapid ions adsorption, colloidal aggregation, and phase separation. Note that TEMPO-CNC and CMC qₑ values also align with the stoichiometric calculations (carboxylate content=1.0 mmol g⁻¹ or 3.0 mmol g⁻¹, binding ~0.3 mmol or ~1.0 mmol of Dy^{III} per gram of the adsorbent, equivalent to 53 mg g⁻¹ or 159 mg g⁻¹, respectively).

In FIGS. 15C and 15D, R and qₑ of cellulose-based adsorbents are plotted against C₀ ranging from 0.1 mM to 10 mM, respectively. At the lowest C₀⁺ (0.1 mM), all the adsorbents had low R (<50%). This may be attributed to a low adsorbate-to-adsorbent ratio, resulting in partial adsorbent charge neutralization, which impairs colloidal aggregations and separation. As C₀ increased from 0.1 to 2 mM, R increases to ~90% for the nanoparticles (TEMPO-CNC and AHCNC) and ~50-60% for the fully solubilized biopolymers (CMC and DCC) as a result of ion-induced colloidal aggregation and precipitation. Note that the Dy^{III} removal percentage of biopolymers is significantly lower than the nanoparticles because they may not be fully precipitated. At higher C₀, (>2 mM), R decreased for all the adsorbents, as a result of saturation of active binding sites (carboxylate groups). The qₑ of all cellulose-based adsorbents increased by increasing C₀ and reached a plateau as the active binding sites (i.e., carboxylate groups of TEMPO-CNC and CMC or dicarboxylate groups of AHCNC and DCC) saturated.

FIGS. 15A, 15B, 15C, and 15D show Dy^{III} removal using the cellulose-based nanoparticles (AHCNC and TEMPO-CNC) and fully solubilized biopolymers (CMC and DCC). FIG. 15A show a schematic of Dy^{III} removal using AHCNC, which is similar to the other adsorbents. The unsaturated, electrically charged adsorbents remain stable and do not precipitate. Ion separation takes place when the adsorbents are saturated, forming aggregates and precipitate. FIG. 15B shows the effect of contact time on Dy^{III} removal using the cellulose-based adsorbents at C0=2 mM (323 ppm), excluding the vortex and centrifugation time (~10 min). FIG. 15C show the effect of C0 on the Dy^{III} removal percentage (R) of cellulose-based adsorbents. FIG. 15D shows the effect of C0 on the Dy^{III} removal capacity (qe) of cellulose-based adsorbents.

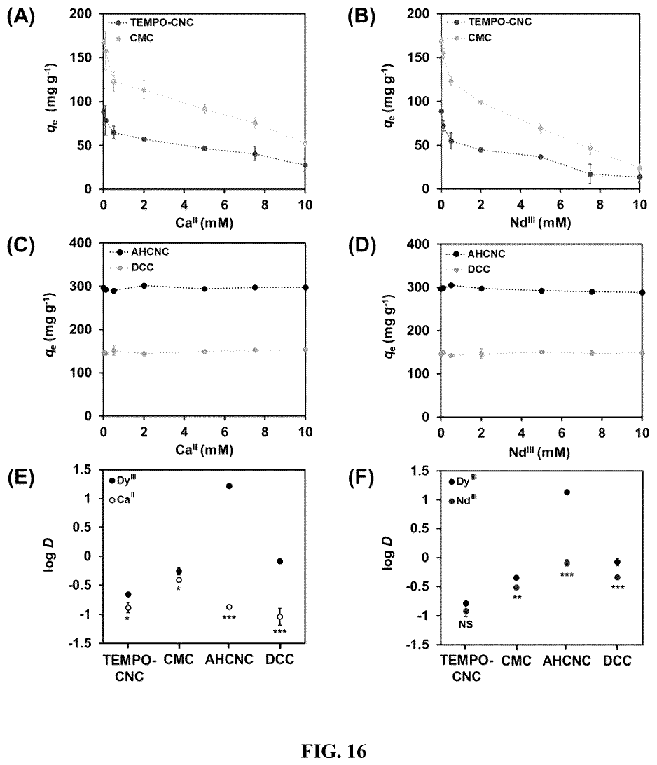

The Dy^{III} removal selectivity of cellulose-based adsorbents versus Ca^{II} and Nd^{III} was then investigated. FIGS. 16A and 16B present qₑ of TEMPO-CNC and CMC (1 mg mL⁻¹) at C₀=2 mM and varying Ca^{II} and Nd^{III} concentrations, respectively. The qₑ monotonically decreased from 89±26 mg g⁻¹ and 169±3 mg g⁻¹ to 27±7 mg g⁻¹ and 53±6 mg g⁻¹ for TEMPO-CNC and CMC respectively, as the concentration of divalent cation (Ca^{II}) increased from 0 mM to 10 mM. Similarly, for the LREE ion (Nd^{III}), the qₑ of TEMPO-CNC and CMC decreased from 89±26 mg g⁻¹ and 169±3 mg g⁻¹ to 14±7 mg g⁻¹ and 24±4 mg g⁻¹ (~84% reduction for TEMPO-CNC and 86% for CMC), respectively, by increasing Nd^{III} concentration from 0 mM to 10 mM. The reduction in qₑ may be associated with the higher binding energy of COO—Nd (200 times) compared with COO—Ca. The introduction of Nd^{III} in the Dy^{III} solution resulted in a much more significant competitive adsorption compared with the Ca^{II}. FIGS. 16C and 16D show qₑ of AHCNC and DCC (1 mg mL⁻¹) at C₀=2 mM and varying Ca^{II} and Nd^{III} concentrations, respectively. The qₑ of AHCNC and DCC remained relatively constant at 297±1 mg g⁻¹ and 147±6 mg g⁻¹, respectively, by increasing the competitive ion concentration (Ca^{II} or Nd^{III}) from 0 mM to 10 mM. While the DCC chains on AHCNC may induce coordination, the dominant REE removal mechanism still appears to be electrostatic interactions, as discussed in our previous publication for AHCNC-mediated Nd^{III} removal. The remarkable selectivity of Dy^{III} III over Ca^{II} or Nd^{III} may arise from a unique configuration of dicarboxylate-Dy^{III} interactions, distinct from the configurations observed with dicarboxylate-Ca^{II} or dicarboxylate-Nd^{III}.

To understand the specific ion selectivity of cellulose-based adsorbents, the ion distribution factor, D=(C₀−Cₑ)/Cₑ, was calculated. FIG. 16E shows the D in log scale for the adsorbents in a Ca^{II}-Dy^{III} mixture. The D of AHCNC and DCC for the Dy^{III} was significantly higher than that for Ca^{II}, whereas the D of TEMPO-CNC and CMC had a much smaller difference for the two ions. This confirms the significantly higher Dy^{III} selectivity of AHCNC and DCC versus divalent Ca^{II}, which is possibly related to the dicarboxylate hairs. FIG>16F shows the D of cellulose-based adsorbents in a Nd^{III}-Dy^{III} ion mixture, which confirms the significantly higher (~12 times for AHCNC and ~2 times for DCC) HREE removal selectivity versus LREE for both AHCNC and DCC.

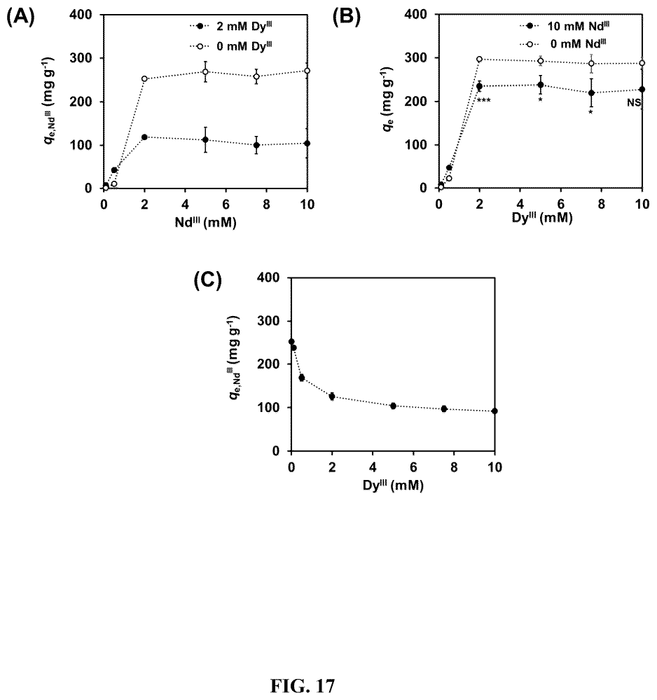

To validate the AHCNC-mediated selective removal of Dy^{III} over Nd^{III}, FIG. 17A presents Nd^{III} removal capacity (q_{e,Nd}^{III}) of AHCNC at varying initial Nd^{III} concentrations (C_{0,Nd}^{III}) with or without Dy³⁺. As the C_{0,Nd}^{III} increased from 0.1 to 10 mM, the q_{e,Nd}^{III} AHCNC increased from 1±1 mg g⁻¹ to 271±17 mg g⁻¹ in the absence of Dy^{III}, whereas it only increased to 126±8 mg g⁻¹ at 2 mM of Dy^{III}, confirming the selective binding of Dy^{III} over Nd^{III}. FIG. 17B shows qₑ of AHCNC at varying C₀ with or without Nd^{III}. As the C₀ increased from 0.1 to 10 mM, qₑ of AHCNC increased from 2±1 mg g⁻¹ to 288±13 mg g⁻¹ in the absence of Nd^{III}, whereas it still increased to 228±45 mg g⁻¹ at 10 mM of Nd^{III}. FIG. 17C presents q_{e,Nd}^{III} of AHCNC at varying C₀ The q_{e,Nd}^{III} decreased from 253±4 mg g⁻¹ to 92±3 mg g⁻¹ when the C₀ increased from 0 to 10 mM, as a result of higher Dy^{III} selectivity, occupying the binding sites on AHCNC. Together, these results indicate an unprecedented HREE selectivity of AHCNC, mediated by the dicarboxylate groups.

FIGS. 16A, 16B, 16C, 16D, 16E, and 16F show the effects of a divalent cation and a LREE on the Dy³⁺ removal of cellulose-based adsorbents. Effects of (FIG. 16A) Ca^{II} and (FIG. 16B) Nd^{III} on TEMPO-CNC- and CMC-mediated Dy^{III} removal. Effects of (FIG. 16C) Ca^{II} and (FIG. 16D) Nd^{III} on AHCNC- and DCC-mediated Dy^{III} removal. (FIG. 16E) Dy™ and Ca^{II} distribution factors (log D) for TEMPO-CNC, CMC, AHCNC, and DCC in a Dy^{III} (2 mM)-Ca^{II} (2 mM) mixture. (FIG. 16F) Dy^{III} and Nd^{III} log D for the adsorbents in a Dy^{III} (2 mM)-Nd^{III} (2 mM) mixture. (NS p≥0.05, *p<0.05, **p<0.01, and ***p<0.001).

### Colloidal Aspects Ion-Adsorbent Interactions

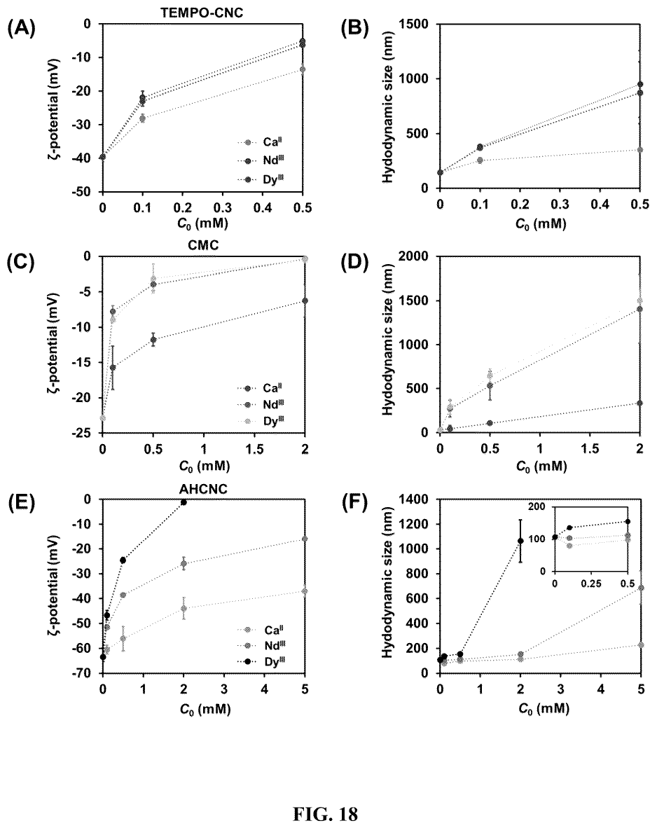

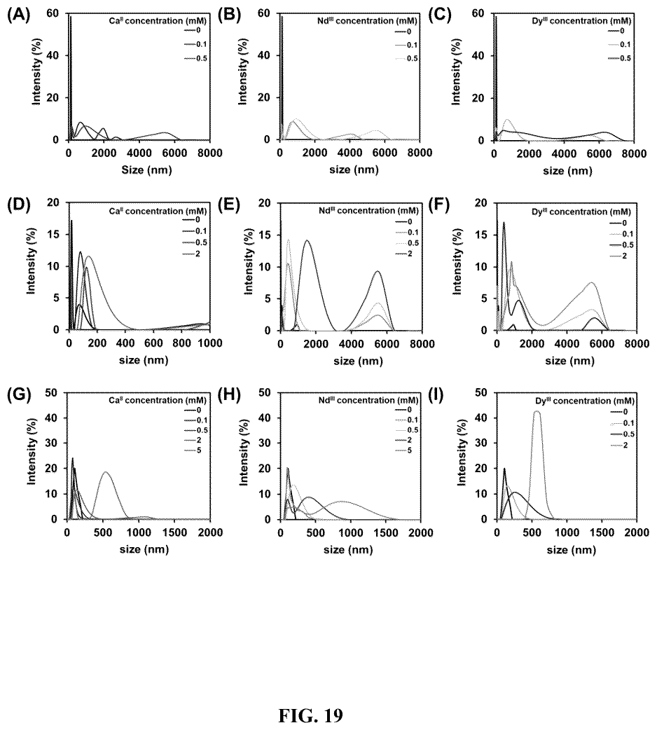

The interactions of ions and cellulose-based adsorbents were investigated using ELS and DLS spectroscopy. FIGS. 18A-18F show the ζ-potential and hydrodynamic equivalent size of adsorbents at varying ion types and concentrations. FIGS. 18A and 18B present the ζ-potential and hydrodynamic equivalent size of TEMPO-CNC, respectively, at varying concentrations of Ca^{II}, Nd^{III}, or Dy^{III}. The ζ-potential decreased and hydrodynamic size increased with increasing ions concentrations. By increasing the concentration of Ca^{II}, Nd^{III}, or Dy^{III} from 0 to 0.5 mM, TEMPO-CNC ζ-potential decreased from −39.6±1.5 mV to −13.6±1.6 mV, −5.1±0.4 mV, and −6.3±0.4 mV, respectively, and the hydrodynamic size increased from 146±8 nm to 354±12 nm, 953±304 nm, and 874±281 nm, respectively. Representative hydrodynamic equivalent size distributions of TEMPO-CNC at varying Ca^{II}, Nd^{III}, or Dy^{III} concentrations are shown in FIGS. 19A, 19B, and 19C, respectively. The size distribution of TEMPO-CNC became broader by increasing the concentrations of ions, implying ion-induced colloidal aggregations. Trivalent REE ions (Nd^{III} and Dy^{III}) yielded larger aggregates and lower ζ-potential compared with Ca^{II}. FIGS. 18C and 18D present the ζ-potential and hydrodynamic equivalent size of CMC, respectively, at varying concentrations of Ca^{II}, Nd^{III}, or Dy^{III}. The ζ-potential of CMC decreased from −22.9±0.2 mV to −6.3 ±2.3 mV, −0.4±0.3 mV, and −0.5±0.5 mV, and the hydrodynamic size increased from 32±3 nm to 336±2 nm, 1408±390 nm, and 1500±127 nm by the addition of 2 mM of Ca^{II}, Nd^{III}, or Dy^{III}, respectively. Representative hydrodynamic size distributions of CMC at varying Ca^{II}, Nd^{III}, or Dy^{III} concentrations are shown in FIGS. 19D, 19E, and 19F, respectively. It has previously observed that Ca^{II} enabled the multichain association of CMC chains, resulting in an increase in the hydrodynamic size. Similarly, Nd^{III} and Dy^{III} with higher binding affinities resulted in larger ion-induced aggregates and lower ζ-potential.

FIGS. 18E and 18F present the ζ-potential and hydrodynamic equivalent size of AHCNC at varying concentrations of Ca^{II}, Nd^{III}, or Dy^{III}. By adding 2 mM of Ca^{II}, Nd^{III}, or Dy^{III}, the ζ-potential of AHCNC decreased from −63.4±1.9 mV to −43.9±4.3 mV, −26.0±2.6 mV, and −1.2±0.1 mV, respectively, and the hydrodynamic size increased from 108±1 nm to 114±4 nm, 154±1 nm, and 1070±172 nm. Representative hydrodynamic size distributions of AHCNC at varying Ca^{II}, Nd^{III}, or Dy^{III} concentrations are shown in FIGS. 19G, 19H, and 19I, respectively. Similar to TEMPO-CNC and CMC, the size distribution of AHCNC broadened as the ion concentration increased, indicating ion-induced colloidal aggregation. However, the HREE (Dy^{III}) yielded significantly larger aggregates compared with the LREE (Nd^{III}) or Ca^{II}, likely as a result of higher binding affinity to dicarboxylate groups (will be discussed in next section). Interestingly, it was observed that the hydrodynamic size of AHCNC decreased from 108±1 nm to 80±5 nm at 0.1 mM of Ca^{II}, whereas it remained almost constant at 104±2 nm at 0.1 mM of Nd^{III} and increased to 137±2 nm at 0.1 mM of Dy^{III}, as shown in the inset of FIG. 18F. This is likely a result of Ca^{II}-induced partial “intrahair crosslinking” and Dy^{III}-induced partial “interhair crosslinking”, which will be further discussed in next section.

FIGS. 18A, 18B, 18C, 18D, 18E, and 18F show ion type and concentration effects on the colloidal properties of cellulose-based adsorbents. (FIG. 18A) ζ-potential and (FIG. 18B) hydrodynamic equivalent size of TEMPO-CNC at varying initial Ca^{II}, Nd^{III} or Dy^{III} concentrations. (FIG. 18C) ζ-potential and (FIG. 18D) Hydrodynamic equivalent size of CMC at varying initial Ca^{II}, Nd^{III} or Dy^{III} concentrations. (FIG. 18E) ζ-potential and (FIG. 18F) Hydrodynamic equivalent size of AHCNC at varying initial Ca^{II}, Nd^{III} or Dy^{III} concentrations.

### Fundamental Aspects of Ion Binding to Cellulose-Based Adsorbents

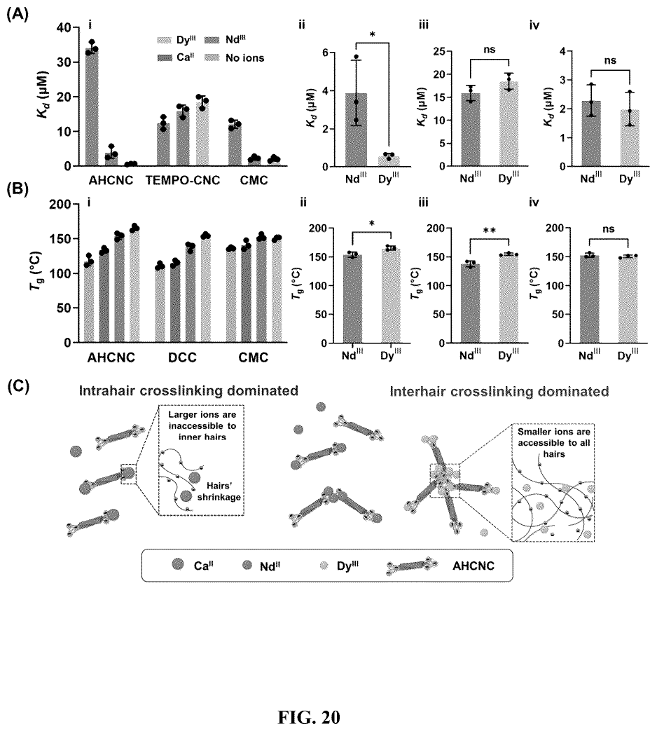

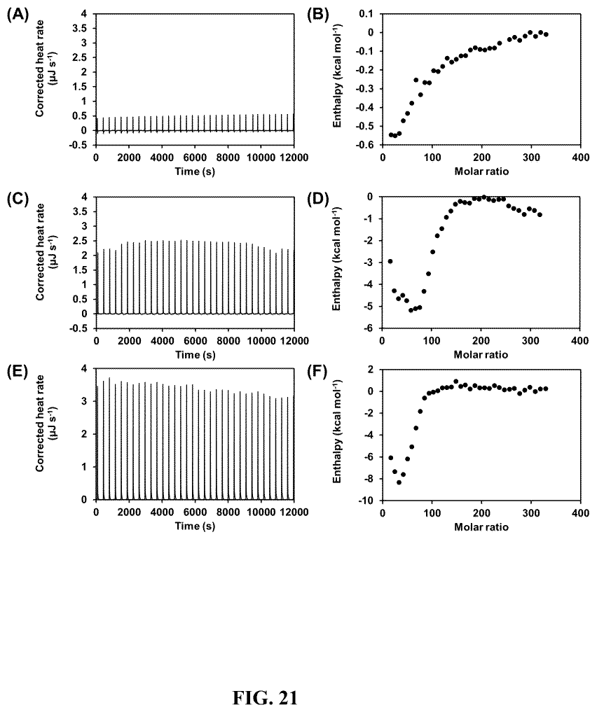

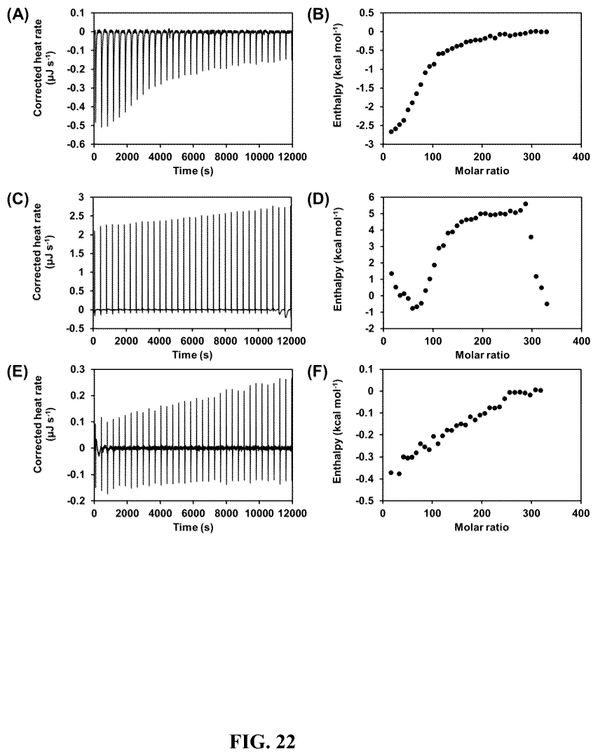

To investigate the binding of ions (Dy^{III}, Nd^{III}, or Ca^{II}) to cellulose-based adsorbents, ITC and DSC were conducted. FIG. 20A shows (i) the K_{D} values of AHCNC, TEMPO-CNC, and CMC obtained using the ITC along with separate graphs for each adsorbent (ii-iv) to assess the differences and statistical significance between Nd^{III} and Dy^{III} II. As seen in FIG. 10A, the Ca^{II}-, Nd^{III}- or Dy^{III}-bound AHCNC had K_{D} values of 34.1±1.6 μM, 3.9±1.7 μM, or 0.6±0.1 μM, respectively (representative ITC trace curves and thermograms are shown in FIGS. 21A-21F). AHCNC had a 6.5 fold decrease in K_{D} preference for binding to the HREE Dy^{III} over LREE Nd^{III} (650% higher binding affinity) and an impressive 56.8 fold (5680%) preference for Dy^{III} binding over Ca^{II}. However, the Ca^{II}-, Nd^{III}- or Dy^{III}-bound TEMPO-CNC had K_{D} of 12.4±1.8 M, 15.9±1.7 μM, or 18.5±1.7 μM, respectively, and no significant differences were found for TEMPO-CNC binding affinity to different ions. Representative ITC trace curve and thermogram of TEMPO-CNC are shown in FIGS. 22A-22F.

The Ca^{II}-, Nd^{III}- or Dy^{III}-bound CMC had K_{D} of 12.1±1.2 μM, 2.3 +0.5 μM, or 2.0±0.6 μM, respectively (representative ITC trace curves and thermograms are shown in FIGS. 22A-22F). Unlike the K_{d} of TEMPO-CNC, CMC had a 5.5 fold preference for binding to trivalent REE ions (both Nd^{III} and Dy^{III}) compared with the divalent Ca^{II}. To compare the affinity of cellulose-based adsorbents for binding trivalent REE ions, FIGS. 20-20C present the K_{d} of AHCNC, TEMPO-CNC, and CMC for Nd^{III} and Dy^{III}, respectively. Only the K_{d} values of AHCNC showed a statistically difference for Nd^{III} compared with Dy^{III}, while the K_{d} values of TEMPO-CNC and CMC were not statistically different in binding Nd^{III} and Dy^{III}. These results confirm the superior Dy^{III} removal selectivity of AHCNC over other carboxylate-bearing cellulose-based adsorbents. Note that ion binding of DCC could not be detected by the ITC.

We hypothesize that the favorable AHCNC binding to Dy^{III} may originate from the disordered cellulose conformational changes upon ion binding. To investigate ion-induced “intrahair crosslinking” and “interhair crosslinking”, the glass transition temperature (T_{g}) of AHCNC, DCC, and CMC was measured at 0.1 mM ions concentrations. Typically, an increase in crosslinking density leads to a higher T_{g} in polymer chains; in particular, interchain crosslinking has a more significant impact on elevating T_{g} by restricting molecular mobility. FIG. 20B presents the T_{g} values (i) of ions binding of AHCNC, DCC and CMC obtained from the DSC along with separate graphs for each adsorbent (ii-iv) to highlight the differences and statistical significance between Nd^{III} and Dy^{III}. The T_{g} values of ion-free, Ca^{II}-bound, Nd^{III}-bound and Dy^{III}-bound AHCNC were 122±6° C., 134±5° C., 152±4° C. and 167±3° C., respectively. The T_{g} values of ion-free, Ca^{II}-bound, Nd^{III}-bound and Dy^{III} II-bound DCC were 109 ±1° C., 114±4° C., 136±6° C. and 155±3° C., respectively. For AHCNC and DCC, the largest increase in T_{g} (~40% for AHCNC and ~40% for DCC) was yielded by the trivalent HREE Dy^{III}, whereas the divalent Ca^{II} only caused a slight increase (~13% for AHCNC and ~4% for DCC) in T_{g}. This difference may result from the phenomenon of “interhair crosslinking” induced by HREE, in contrast to the “intrahair crosslinking” induced by Ca^{II}.

As can be seen in FIGS. 20A-20C, the T_{g} value of ion-free, Ca^{II}-, Nd^{III}-, or Dy^{III}-bound CMC was 137±2° C., 142±9° C., 154±4° C., or 150±3° C., respectively. The T_{g} of ion-free CMC was similar to the reported values in the literature (~138° C.).⁴⁰ The binding of ions to CMC elevated the T_{g} because of the ion-mediated crosslinking.⁴¹ Notably, trivalent REE led to a substantially greater increase in T_{g} compared with Ca²⁺. Note that TEMPO-CNC mainly comprise crystalline cellulose, for which T_{g} cannot be measured by the DSC.⁴² To compare the T_{g} of cellulose-based adsorbents bound to trivalent REE ions, FIGS. 20A-20C present the T_{g} of AHCNC, DCC, and CMC with bound Nd^{III} or Dy^{III}, respectively. The T_{g} values of ions-AHCNC and ions-DCC showed a statistically significant difference when binding to Nd^{III} compared to Dy^{III}. However, the T_{g} of CMC bound to Nd^{III} was not statistically different from that bound to Dy^{III}. This indicates Dy^{III} may induce more ions-mediated crosslinking compared to Nd^{III} on AHCNC.

FIG. 20C shows a scheme of Ca^{II}, Nd^{III} or Dy^{III} interactions with AHCNC. The disordered dicarboxylate hairs (DCC chains) on AHCNC, located closer to the crystalline area (inner hairs), may be less disordered compared with the outer hairs. Therefore, the accessibility of Ca^{II} (ionic radius=0.348 nm compared with Dy^{III} ionic radius=0.092 nm to the hairs may be more difficult. Instead, Ca^{II} induces partial shrinkage of the outer hairs of AHCNC, leading to “intrahair crosslinking”. Dy^{III} with the smallest radius among the ions studied in this work, may readily access the AHCNC hairs, leading to the “interhair crosslinking” among DCC, enabling the most favorable interactions, outweighing the interactions with the larger LREE Nd^{III} and divalent Ca^{II}. The LREE Nd^{III} may induce partially “intrahair crosslinking” and partially “interhair crosslinking” on AHCNC, resulting in higher selectivity to Ca^{II} but lower selectivity to FIGS. 20A, 20B, and 20C show fundamental aspects of ion binding to cellulose-based adsorbents. (FIG. 20A) The dissociation constant (K_{D}) of Ca^{II}-, Nd^{III}- or Dy^{III}-bound TEMPO-CNC, CMC, and AHCNC, determined using the ITC. (FIG. 20B) The glass transition temperature (T_{g}) of Ca^{II}-, Nd^{III}-, or Dy^{III}-bound CMC, AHCNC, and DCC, measured using the DSC. (FIG. 20C) Conceptual representation of Ca^{II}-, Nd^{III}- and Dy^{III}-bound AHCNC, where Ca^{II} induces dominant intrahair crosslinking and Dy^{III} induces dominated interhair crosslinking. (NS p≥0.05, *p<0.05, and **p<0.01.

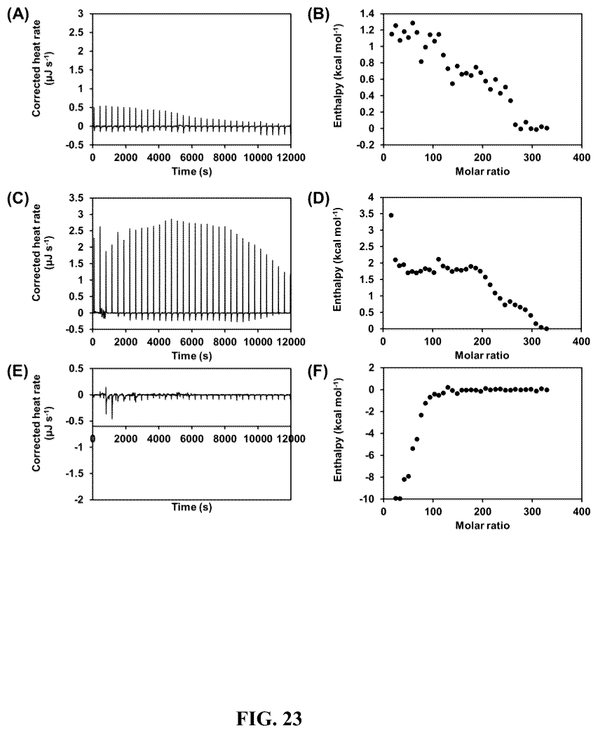

FIGS. 23A, 23B, 23C, 23D, 23E, and 23F show ITC titration plots for ions-CMC. (FIG. 23A) Representative ITC trace for titration of 1 mg mL⁻¹ CMC with a Ca^{II} solution (1 mM, pH=5.7). (FIG. 23B) Thermogram derived from the titration data in FIG. 23A. (FIG. 23C)

Representative ITC trace for titration of 1 mg mL⁻¹ CMC with a Nd^{III} solution (1 mM, pH=5.7). (FIG. 23D) Thermogram derived from the titration data in FIG. 23C. (FIG. 23E) Representative ITC trace for titration of 1 mg mL⁻¹ CMC with a Dy^{III} solution (1 mM, pH=5.7). (FIG. 23F)

Thermogram derived from the titration data in FIG. 23E.

TABLE 3
Thermodynamics of binding Dy^{III} to cellulose-based
adsorbents, i.e., AHCNC, TEMPO-CNC, and CMC.

| Binding parameter | AHCNC | TEMPO-CNC | CMC |
|---|---|---|---|
| K_{d} (μM) | 0.64 ± 0.06 | 18.93 ± 1.04 | 1.292 ± 0.541 |
| n | 60.77 ± 2.94 | 145.3 ± 13.9 | 58.83 ± 1.74 |
| ΔH (kcal mol⁻¹) | −7.20 ± 0.57 | −0.395 ± 0.059 | −10.64 ± 0.52 |
| ΔS (cal mol⁻¹ K) | 4.176 | 20.28 | −9.545 |
| ΔG (kcal mol⁻¹) | 19.65 | −60.85 | 17.81 |

TABLE 4
Thermodynamics of binding Nd^{III} to cellulose-based
adsorbents, i.e., AHCNC, TEMPO-CNC, and CMC.

| | | | |
|---|---|---|---|
| Binding parameter | AHCNC | TEMPO-CNC | CMC |

| | |
|---|---|
| K_{d1} (μM) | 34.4 |
| K_{d2} (μM) | 13.0 |
| n1 | 10.0 ± 1.7 |
| n2 | 10.0 ± 1.2 |
| ΔH1 (kcal mol⁻¹) | 50.00 ± 13.87 |
| ΔH2 (kcal mol⁻¹) | −44.53 ± 20.17 |
| ΔS1 (cal mol⁻¹ K) | 188 |
| ΔS2 (cal mol⁻¹ K) | −127 |
| ΔG1 (kcal mol⁻¹) | |
| ΔG2 (kcal mol⁻¹) | |

TABLE 5
Thermodynamics of binding Ca^{II} to cellulose-based
adsorbents, i.e., AHCNC, TEMPO-CNC, and CMC.

| Binding parameter | AHCNC | TEMPO-CNC | CMC |
|---|---|---|---|
| K_{d} (μM) | 33.80 ± 1.30 | 12.43 ± 1.76 | 12.19 ± 1.22 |
| n | 79.00 ± 12.22 | 75.84 ± 2.59 | 196.5 ± 13.6 |
| ΔH (kcal mol⁻¹) | −0.869 ± 0.192 | −3.33 ± 0.15 | 1.239 ± 0.175 |
| ΔS (cal mol⁻¹ K) | 17.54 | 11.26 | 26.64 |
| ΔG (kcal mol⁻¹) | −53.16 | −36.90 | −78.18 |

### CONCLUSIONS

Selective removal of HREE from ions mixture is challenging as they have similar ionic radius and coordination number to LREE. In this study, we discovered that AHCNC selectively bind HREE Dy^{III} against LREE Nd^{III} and Ca^{II}. AHCNC showed ~10 times selectively to Dy^{III} over Nd^{III} and ~100 times to Dy^{III} I over Ca^{II}. Accordingly, AHCNC binding affinity to Dy^{III} and Ca^{II} was 5 and 53 times higher, respectively, compared with carboxylate bearing cellulose-based adsorbents. When compared with the ion removal by other cellulose nanoparticles (TEMPO-CNC) and fully solubilized biopolymers (CMC and DCC), AHCNC-mediated removal was correlated to the unique configuration of dicarboxylate chain (“hairs”) protruding from the crystalline ends in the presence of ions.

### REFERENCES

The following references are incorporated herein by reference in their entireties.
(1) Binnemans, K.; Jones, P. T.; Blanpain, B.; van Gerven, T.; Yang, Y.; Walton, A.; Buchert, M. Recycling of Rare Earths: A Critical Review. Journal of Cleaner Production. 2013, 51, 1-22. https://doi.org/10.1016/j.jclepro.2012.12.037.
(2) Yang, Y.; Walton, A.; Sheridan, R.; Güth, K.; Gauß, R.; Gutfleisch, O.; Buchert, M.; Steenari, B. M.; van Gerven, T.; Jones, P. T.; Binnemans, K. REE Recovery from End-of-Life NdFeB Permanent Magnet Scrap: A Critical Review. Journal of Sustainable Metallurgy. 2017, 3, 122-149. https://doi.org/10.1007/s40831-016-0090-4.
(3) Noor, Y. M.; Tam, S. C.; Lim, L. E. N.; Jana, S. A Review of the Nd: YAG Laser Marking of Plastic and Ceramic IC Packages. Journal of Material Process Technology. 1994, 42, 95-133. https://doi.org/https://doi.org/10.1016/0924-0136 (94) 90078-7.
(4) Alonso, E.; Sherman, A. M.; Wallington, T. J.; Everson, M. P.; Field, F. R.; Roth, R.; Kirchain, R. E. Evaluating Rare Earth Element Availability: A Case with Revolutionary Demand from Clean Technologies. Environmental Science and Technology. 2012, 46 (6), 3406-3414. https://doi.org/10.1021/es203518d.
(5) U.S. Department of Energy critical materials strategy. Accessed on 2022 Oct. 12. https://doi.org/https://doi.org/10.2172/1000846.
(6) de Vargas Brião, G.; da Silva, M. G.; Adeodato Vieira, M. G. Adsorption Potential for the Concentration and Recovery of Rare Earth Metals from NdFEB Magnet Scrap in the Hydrometallurgical Route: A Review in a Circular Economy Approach. Journal of Cleaner Production. 2022, 135112. https://doi.org/10.1016/j.jclepro.2022.135112.
(7) Konishi, Y.; Asai, S.; Shimaoka, J.; Miyata, M.; Kawamura, T. Recovery of Neodymium and Ytterbium by Biopolymer Gel Particles of Alginic Acid. Industrial & Engineering Chemistry Research. 1992, 31, 2303-2311. https://doi.org/10.1021/ie00010a008.
(8) Park, H. J.; Tavlarides, L. L. Adsorption of Neodymium (III) from Aqueous Solutions Using a Phosphorus Functionalized Adsorbent. Industrial & Engineering Chemistry Research. 2010, 49 (24), 12567-12575. https://doi.org/10.1021/ie100403b.
(9) Cheng, L. L.; Wei, X. D.; Hao, X. L.; Ruan, D.; Yu, S. M. The Removal of Strontium (II) and Neodymium (III) from Their Aqueous Solutions on Chrysotile Nanotubes. Advanced Materials Research. 2014, 881, 519-524. https://doi.org/10.4028/www.scientific.net/AMR.881-883.519.
(10) Ahmed, I.; Bhattacharjee, S.; Lee, C. S.; Kang, K. K.; Ahn, J. W.; Ahn, W. S. Aqueous Nd3+ Capture Using a Carboxyl-Functionalized Porous Carbon Derived from ZIF-8. Journal of Colloid and Interface Science. 2021, 594, 702-712. https://doi.org/10.1016/j.jcis.2021.03.036.
(11) de Vargas Briaõ, G.; da Silva, M. G. C.; Vieira, M. G. A. Efficient and Selective Adsorption of Neodymium on Expanded Vermiculite. Industrial & Engineering Chemistry Research. 2021, 60 (13), 4962-4974. https://doi.org/10.1021/acs.iecr.0c05979.
(12) Brião, G. de V.; Silva, M. G. C. da; Vieira, M. G. A. Neodymium Recovery from Aqueous Solution through Adsorption/Desorption onto Expanded Vermiculite. Applied Clay Science. 2020, 198. https://doi.org/10.1016/j.clay.2020.105825.
(13) Borst, A. M.; Smith, M. P.; Finch, A. A.; Estrade, G.; Villanova-de-Benavent, C.; Nason, P.; Marquis, E.; Horsburgh, N. J.; Goodenough, K. M.; Xu, C.; Kynický, J.; Geraki, K. Adsorption of Rare Earth Elements in Regolith-Hosted Clay Deposits. Nature Communication. 2020, 11 (1). https://doi.org/10.1038/s41467-020-17801-5.
(14) Gupta, N. K.; Gupta, A.; Ramteke, P.; Sahoo, H.; Sengupta, A. Biosorption-a Green Method for the Preconcentration of Rare Earth Elements (REEs) from Waste Solutions: A Review. Journal of Molecular Liquids. 2019, 274, 148-164. https://doi.org/10.1016/j.molliq.2018.10.134.
(15) Wamea, P.; Pitcher, M. L.; Muthami, J.; Sheikhi, A. Nanoengineering Cellulose for the Selective Removal of Neodymium: Towards Sustainable Rare Earth Element Recovery. Chemical Engineering Journal. 2022, 428. https://doi.org/10.1016/j.cej.2021.131086.
(16) Pitcher, M. L.; Huntington, B.; Dominick, J.; Sheikhi, A. Highly Functional Bio-Based Micro- and Nano-Structured Materials for Neodymium Recovery. Chemical Engineering Journal. 2022, 137418. https://doi.org/10.1016/j.cej.2022.137418.
(17) Young, S. A. E.; Muthami, J.; Pitcher, M.; Antovski, P.; Wamea, P.; Murphy, R. D.; Haghniaz, R.; Schmidt, A.; Clark, S.; Khademhosseini, A.; Sheikhi, A. Engineering Hairy Cellulose Nanocrystals for Chemotherapy Drug Capture. Materials Today Chemistry 2022, 23. https://doi.org/10.1016/j.mtchem.2021.100711.
(18) Johnson, L.; Gray, D. M.; Niezabitowska, E.; McDonald, T. O. Multi-Stimuli-Responsive Aggregation of Nanoparticles Driven by the Manipulation of Colloidal Stability. Nanoscale. 2021, 13, 7879-7896. https://doi.org/10.1039/d1nr01190a.
(19) Lee, H.; Dellatore, S. M.; Miller, W. M.; Messersmith, P. B. Mussel-Inspired Surface Chemistry for Multifunctional Coatings. Science. 2007, 318 (5849), 426-430. https://doi.org/10.1126/science.1147241.
(20) Ding, Y. H.; Floren, M.; Tan, W. Mussel-Inspired Polydopamine for Bio-Surface Functionalization. Biosurface and Biotribology. 2016, 2 (4), 121-136. https://doi.org/10.1016/j.bsbt.2016.11.001.
(21) Yeh, S. L.; Deval, P.; Wu, J. G.; Luo, S. C.; Tsai, W. B. One-Step Electrochemical Deposition of Antifouling Polymers with Pyrogallol for Biosensing Applications. Journal of Materials Chemistry B. 2021, 10 (14), 2504-2511. https://doi.org/10.1039/d1tb02536h.
(22) Yeh, S. L.; Wang, T. C.; Yusa, S. I.; Thissen, H.; Tsai, W. B. Conjugation of Polysulfobetaine via Poly (Pyrogallol) Coatings for Improving the Antifouling Efficacy of Biomaterials. ACS Omega 2021, 6 (5), 3517-3524. https://doi.org/10.1021/acsomega.0c04643.
(23) Ryu, J. H.; Messersmith, P. B.; Lee, H. Polydopamine Surface Chemistry: A Decade of Discovery. ACS Applied Materials and Interfaces. 2018, 10, 7523-7540. https://doi.org/10.1021/acsami.7b19865.
(24) Hong, S.; Na, Y. S.; Choi, S.; Song, I. T.; Kim, W. Y.; Lee, H. Non-Covalent Self-Assembly and Covalent Polymerization C₀-Contribute to Polydopamine Formation.

Advanced Functional Materials. 2012, 22 (22), 4711-4717. https://doi.org/10.1002/adfm.201201156.
(25) Burzio, L. A.; Waite, J. H. Cross-Linking in Adhesive Quinoproteins: Studies with Model Decapeptides. Biochemistry. 2000, 39 (36), 11147-11153. https://doi.org/10.1021/bi0002434.
(26) Kim, U. J.; Kuga, S.; Wada, M.; Okano, T.; Kondo, T. Periodate Oxidation of Crystalline Cellulose. Biomacromolecules. 2000, 1 (3), 488-492. https://doi.org/10.1021/bm0000337.
(27) Araki, J.; Wada, M.; Kuga, S. Steric Stabilization of a Cellulose Microcrystal Suspension by Poly (Ethylene Glycol) Grafting. Langmuir. 2001, 17 (1), 21-27. https://doi.org/10.1021/la001070m.
(28) Lin, J. H.; Yu, C. J.; Yang, Y. C.; Tseng, W. L. Formation of Fluorescent Polydopamine Dots from Hydroxyl Radical-Induced Degradation of Polydopamine Nanoparticles.

Physical Chemistry Chemical Physics. 2015, 17 (23), 15124-15130. https://doi.org/10.1039/c5cp00932d.
(29) Mayerhöfer, T. G.; Pahlow, S.; Popp, J. The Bouguer-Beer-Lambert Law: Shining Light on the Obscure. Chemphyschem 2020, 21, 2029-2046. https://doi.org/10.1002/cphc.202000464.
(30) Seah, M. P. Summary of ISO/TC 201 Standard: VII ISO 15472:2001-Surface Chemical Analysis-x-Ray Photoelectron Spectrometers-Calibration of Energy Scales. Surface and Interface Analysis 2001, 31 (8), 721-723. https://doi.org/10.1002/sia.1076.
(31) Anwar Jahid, M.; Wang, J.; Zhang, E.; Duan, Q.; Feng, Y. Energy Savings Potential of Reversible Photothermal Windows with near Infrared-Selective Plasmonic Nanofilms. Energy Conversion and Management 2022, 263. https://doi.org/10.1016/j.enconman.2022.115705.
(32) Collins, T. J. ImageJ for Microscopy. Biotechniques. 2007, 43 (1S), S25-S30. https://doi.org/10.2144/000112517.
(33) Venkatesan, P.; Sun, Z. H. I.; Sietsma, J.; Yang, Y. An Environmentally Friendly Electro-Oxidative Approach to Recover Valuable Elements from NdFeB Magnet Waste. Separation and Purification Technology. 2018, 191, 384-391. https://doi.org/10.1016/j.seppur.2017.09.053.
(34) Machulek, A.; Quina, F. H.; Gozzi, F.; Silva, V. O.; Friedrich, L. C.; Moraes, J. E. F. Fundamental Mechanistic Studies of the Photo-Fenton Reaction for the Degradation of Organic Pollutants. 2012. https://doi.org/10.5772/30995.
(35) van de Ven, T. G.; Sheikhi, A. Hairy Cellulose Nanocrystalloids: A Novel Class of Nanocellulose. Nanoscale. 2016, 8 (33), 15101-15114. https://doi.org/10.1039/c6nr01570k.
(36) Alfieri, M. L.; Panzella, L.; Oscurato, S. L.; Salvatore, M.; Avolio, R.; Errico, M. E.; Maddalena, P.; Napolitano, A.; d′Ischia, M. The Chemistry of Polydopamine Film Formation: The Amine-Quinone Interplay. Biomimetics. 2018, 3 (3). https://doi.org/10.3390/biomimetics3030026.
(37) Cox, H. J.; Li, J.; Saini, P.; Paterson, J. R.; Sharples, G. J.; Badyal, J. P. S. Bioinspired and Eco-Friendly High Efficacy Cinnamaldehyde Antibacterial Surfaces. Journal of Materials Chemistry B. 2021, 9 (12), 2918-2930. https://doi.org/10.1039/d0tb02379e.
(38) Bilgiç, A.; çimen, A. Removal of Chromium (vi) from Polluted Wastewater by Chemical Modification of Silica Gel with 4-Acetyl-3-Hydroxyaniline. RSC Advance. 2019, 9 (64), 37403-37414. https://doi.org/10.1039/c9ra05810a.
(39) Luo, H.; Gu, C.; Zheng, W.; Dai, F.; Wang, X.; Zheng, Z. Facile Synthesis of Novel Size-Controlled Antibacterial Hybrid Spheres Using Silver Nanoparticles Loaded with Poly-Dopamine Spheres. RSC Advance. 2015, 5 (18), 13470-13477. https://doi.org/10.1039/c4ra16469e.
(40) Saini, A. K.; Carlin, H. C. M.; Patterson, D. H. Confirmation of the Presence of Imine Bonds in Thermally Cured Polyimides. Journal of Polymer Science A. 1993, 10. http://doi.org/10.1002/pola.1993.080311111.
(41) Bennettand, H.; Wiley, G. J. O.; Benninghoven, A.; Janssen, K. T. F.; Tumpner, J.; Wer, H. W. High Resolution XPS of Organic Polymers: The Scienta ESCA300 Database (SIMS VIII). Journal of Chemical Education. 1992, 7. https://doi.org/10.1021/ed070pA25.5
(42) Fu, J.; Chen, Z.; Wang, M.; Liu, S.; Zhang, J.; Zhang, J.; Han, R.; Xu, Q. Adsorption of Methylene Blue by a High-Efficiency Adsorbent (Polydopamine Microspheres): Kinetics, Isotherm, Thermodynamics and Mechanism Analysis. Chemical Engineering Journal. 2015, 259, 53-61. https://doi.org/10.1016/j.cej.2014.07.101.
(43) Langmuir, I. The Adsorption of Gases on Plane Surfaces of Glass, Mica and Platinum. Journal of American Chemical Society. 1918, 40, 1361-1403. https://doi.org/10.1021/ja02242a004.
(44) Yeh, S.-L.; Narasimhalu, N.; vom Steeg, L. G.; Muthami, J.; LeConey, S.; He, Z.; Pitcher, M.; Cassady, H.; Morley, V. J.; Cho, S. H.; Bator, C.; Koshani, R.; Woods, R. J.; Hickner, M.; Read, A. F.; Sheikhi, A. Ion Exchange Biomaterials to Capture Daptomycin and Prevent Resistance Evolution in Off-Target Bacterial Populations. ACS Applied Materials and Interfaces. 2022, 14 (38), 42864-42875. https://doi.org/10.1021/acsami.2c14894.
(45) Hillert, M. Le Chatelier's Principle-Restated and Illustrated with Phase Diagrams. Journal of Phase Equilibria and Diffusion. 1995, 16 (5), 403-410. https://doi.org/10.1007/bf02645347.
(46) Sheikhi, A.; Kakkar, A.; van de Ven, T. G. M. Nanoengineering Colloidal and Polymeric Celluloses for Threshold Scale Inhibition: Towards Universal Biomass-Based Crystal Modification. Materials Horizon. 2018, 5 (2), 248-255. https://doi.org/10.1039/c7mh00823f.
(47) Rao, M. R.; Fang, Y.; de Feyter, S.; Perepichka, D. F. Conjugated Covalent Organic Frameworks via Michael Addition-Elimination. Journal of American Chemical Society. 2017, 139 (6), 2421-2427. https://doi.org/10.1021/jacs.6b12005.
(48) Safari, S.; Sheikhi, A.; van de Ven, T. G. M. Electroacoustic Characterization of Conventional and Electrosterically Stabilized Nanocrystalline Celluloses. Journal of Colloid and Interface Science. 2014, 432, 151-157. https://doi.org/10.1016/j.jcis.2014.06.061.
(49) Chen, D. Z.; van de Ven, T. G. M. Flocculation Kinetics of Precipitated Calcium Carbonate Induced by Electrosterically Stabilized Nanocrystalline Cellulose. Colloids and Surfaces a-Physicochemical and Engineering Aspects. 2016, 504, 11-17. https://doi.org/10.1016/j.colsurfa.2016.05.023.
(50) Bala, T.; Prasad, B. L. V.; Sastry, M.; Kahaly, M. U.; Waghmare, U. v. Interaction of Different Metal Ions with Carboxylic Acid Group: A Quantitative Study. Journal of Physical Chemistry A. 2007, 111 (28), 6183-6190. https://doi.org/10.1021/jp067906x.
(51) Hisada, M.; Kawase, Y. Recovery of Rare-Earth Metal Neodymium from Aqueous Solutions by Poly-γ-Glutamic Acid and Its Sodium Salt as Biosorbents: Effects of Solution PH on Neodymium Recovery Mechanisms. Journal of Rare Earths. 2018, 36 (5), 528-536. https://doi.org/10.1016/j.jre.2018.01.001.
(52) Jin, H.; Afiuny, P.; Dove, S.; Furlan, G.; Zakotnik, M.; Yih, Y.; Sutherland, J. W. Life Cycle Assessment of Neodymium-Iron-Boron Magnet-to-Magnet Recycling for Electric Vehicle Motors. Environmental Science and Technology. 2018, 52 (6), 3796-3802. https://doi.org/10.1021/acs.est.7b05442.
(53) Riaño, S.; Binnemans, K. Extraction and Separation of Neodymium and Dysprosium from Used NdFeB Magnets: An Application of Ionic Liquids in Solvent Extraction towards the Recycling of Magnets. Green Chemistry. 2015, 17 (5), 2931-2942. https://doi.org/10.1039/c5gc00230c.
(54) Mehdilo, A.; Irannajad, M.; Rezai, B. Effect of Crystal Chemistry and Surface Properties on Ilmenite Flotation Behavior. International Journal of Miner Processing. 2015, 137, 71-81. https://doi.org/10.1016/j.minpro.2015.02.004.
(55) López-Cruz, A.; López, G. E. Formation of an Iron Oxide Bond in Iron Carboxylate Complexes: A Density Functional Theory Study. Molecular Physics. 2009, 107 (17), 1799-1804. https://doi.org/10.1080/00268970903078567.
(56) Khawassek, Y. M.; Eliwa, A. A.; Haggag, E. S. A.; Omar, S. A.; Abdel-Wahab, S. M. Adsorption of Rare Earth Elements by Strong Acid Cation Exchange Resin Thermodynamics, Characteristics and Kinetics. SN Applied Sciences. 2019, 1. https://doi.org/10.1007/s42452-018-0051-6.
(57) Zhao, X.; Jiang, X.; Peng, D.; Teng, J.; Yu, J. Behavior and Mechanism of Graphene Oxide-Tris (4-Aminophenyl) Amine Composites in Adsorption of Rare Earth Elements. Journal of Rare Earths. 2021, 39 (1), 90-97. https://doi.org/10.1016/j.jre.2020.02.006.
(58) Ramasamy, D. L.; Puhakka, V.; Doshi, B.; Iftekhar, S.; Sillanpää, M. Fabrication of Carbon Nanotubes Reinforced Silica Composites with Improved Rare Earth Elements Adsorption Performance. Chemical Engineering Journal. 2019, 365, 291-304. https://doi.org/10.1016/j.cej.2019.02.057.
(59) Artiushenko, O.; Ávila, E. P.; Nazarkovsky, M.; Zaitsev, V. Reusable Hydroxamate Immobilized Silica Adsorbent for Dispersive Solid Phase Extraction and Separation of Rare Earth Metal Ions. Separation and Purification Technology. 2020, 231. https://doi.org/10.1016/j.seppur.2019.115934.
(60) Li, J.; Gong, A.; Li, F.; Qiu, L.; Zhang, W.; Gao, G.; Liu, Y.; Li, J. Synthesis and Characterization of Magnetic Mesoporous Fe3O4@mSiO2-DODGA Nanoparticles for Adsorption of 16 Rare Earth Elements. RSC Advance. 2018, 8 (68), 39149-39161. https://doi.org/10.1039/c8ra07762b.
(61) Pereao, O.; Laatikainen, K.; Bode-Aluko, C.; Kochnev, I.; Fatoba, O.; Nechaev, A. N.; Petrik, L. Adsorption of Ce3+ and Nd3+ by Diglycolic Acid Functionalised Electrospun Polystyrene Nanofiber from Aqueous Solution. Separation and Purification Technology. 2020, 233. https://doi.org/10.1016/j.seppur.2019.116059.
(62) Lee, Y. R.; Yu, K.; Ravi, S.; Ahn, W. S. Selective Adsorption of Rare Earth Elements over Functionalized Cr-MIL-101. ACS Applied Materials and Interfaces. 2018, 10 (28), 23918-23927. https://doi.org/10.1021/acsami.8b07130.
(63) Tu, Y. J.; Lo, S. C.; You, C. F. Selective and Fast Recovery of Neodymium from Seawater by Magnetic Iron Oxide Fe3O4. Chemical Engineering Journal. 2015, 262, 966-972. https://doi.org/10.1016/j.cej.2014.10.025.
(64) Zhang, Y.; Hua, J.; Wu, H.; Shao, Y.; Gu, P.; Li, Z. Adsorption of Nd(III) on a Multistage Porous Imprinted Chitosan Composite Membrane. New Journal of Chemistry. 2022. 32. https://doi.org/10.1039/D2NJ02776C.
(65) Dolak, I.; Keçili, R.; Hür, D.; Ersöz, A.; Say, R. Ion-Imprinted Polymers for Selective Recognition of Neodymium (III) in Environmental Samples. Industrial & Engineering Chemistry Research. 2015, 54 (19), 5328-5335. https://doi.org/10.1021/acs.iecr.5b00212.
(66) Zheng, X.; Zhang, F.; Liu, E.; Xu, X.; Yan, Y. Efficient Recovery of Neodymium in Acidic System by Free-Standing Dual-Template Docking Oriented Ionic Imprinted Mesoporous Films. ACS Applied Materials and Interfaces. 2017, 9 (1), 730-739. https://doi.org/10.1021/acsami.6b 13049
(67) Hirosawa, S. Permanent Magnets Beyond Nd-Dy-Fe-B. JOM 2015, 67 (6), 1304-1305. https://doi.org/10.1007/s11837-015-1439-z.
(68) Li, J.; Peng, K.; Wang, P.; Zhang, N.; Feng, K.; Guan, D.; Meng, J.; Wei, W.; Yang, Q. Critical Rare-Earth Elements Mismatch Global Wind-Power Ambitions. One Earth 2020, 3 (1), 116-125. https://doi.org/10.1016/j.oneear.2020.06.009.
(69) Rademaker, J. H.; Kleijn, R.; Yang, Y. Recycling as a Strategy against Rare Earth Element Criticality: A Systemic Evaluation of the Potential Yield of NdFeB Magnet Recycling. Environ Sci Technol 2013, 47 (18), 10129-10136. https://doi.org/10.1021/es305007w.
(70) Risovany, V. D.; Varlashova, E. E.; Suslov, D. N. Dysprosium Titanate as an Absorber Material for Control Rods. Journal of Nuclear Materials 2000, 281, 84-89.
(71) Teng, D.; Li, Y. Finite Element Solutions for Magnetic Field Problems in Terfenol-d Transducers. Sensors (Switzerland) 2020, 20 (10). https://doi.org/10.3390/s20102808.
(72) Lee, T.; Choi, K.; Ando, T.; Park, D.-G.; Gribelyuk, M. A.; Kwon, U.; Banerjee, S. K. Mechanism of VFB/VTH Shift in Dysprosium Incorporated HfO2 Gate Dielectric n-Type Metal-Oxide-Semiconductor Devices. Journal of Vacuum Science & Technology B, Nanotechnology and Microelectronics: Materials, Processing, Measurement, and Phenomena 2011, 29 (2). https://doi.org/10.1116/1.3562974.
(73) Majewski, M. R.; Woodward, R. I.; Jackson, S. D. Dysprosium Mid-Infrared Lasers: Current Status and Future Prospects. Laser Photon Rev 2020, 14 (3). https://doi.org/10.1002/1por.201900195.
(74) dos Santos, J. R.; Bueno, P.; Jakutis, J.; Victor, A. R.; Barreta, L. F. N.; Sbampato, M. E.; Neri, J. W.; Silveira, C. A. B.; Rodrigues, N. A. S.; Destro, M. G. Dysprosium Optogalvanic Spectroscopy in a Hollow Cathode Lamp. Journal of the Optical Society of America B 2023, 40 (5), 1141. https://doi.org/10.1364/josab.482663.
(75) Wang, Q. C.; Chen, W. Q.; Wang, P.; Dai, T. Illustrating the Supply Chain of Dysprosium in China through Material Flow Analysis. Resour Conserv Recycl 2022, 184. https://doi.org/10.1016/j.resconrec.2022.106417.
(76) Chen, C.; Li, N.; Qi, J.; Wei, J.; Chen, W.-Q. Material Flow Analysis of Dysprosium in the United States. Environ Sci Technol 2023, 57 (45), 17256-17265. https://doi.org/10.1021/acs.est.3c07496.
(77) Alonso, E.; Sherman, A. M.; Wallington, T. J.; Everson, M. P.; Field, F. R.; Roth, R.; Kirchain, R. E. Evaluating Rare Earth Element Availability: A Case with Revolutionary Demand from Clean Technologies. Environ Sci Technol 2012, 46 (6), 3406-3414. https://doi.org/10.1021/es203518d.
(78) Bauer, D. D. D. L. J. S. D. T. P. W. B. Critical Materials Strategy. https://doi.org/https://doi.org/10.2172/1000846.
(79) Graedel, T. E.; Reck, B. K.; Miatto, A. Alloy Information Helps Prioritize Material Criticality Lists. Nat Commun 2022, 13 (1). https://doi.org/10.1038/s41467-021-27829-w.
(80) Yoon, H. S.; Kim, C. J.; Chung, K. W.; Kim, S. D.; Lee, J. Y.; Kumar, J. R. Solvent Extraction, Separation and Recovery of Dysprosium (Dy) and Neodymium (Nd) from Aqueous Solutions: Waste Recycling Strategies for Permanent Magnet Processing. Hydrometallurgy 2016, 165, 27-43. https://doi.org/10.1016/j.hydromet.2016.01.028.
(81) Asadollahzadeh, M.; Torkaman, R. Extraction of Dysprosium from Waste Neodymium Magnet Solution with Ionic Liquids and Ultrasound Irradiation Procedure. Korean Journal of Chemical Engineering 2022, 39 (1), 134-145. https://doi.org/10.1007/s11814-021-0970-6.
(82) Dewulf, B.; Batchu, N. K.; Binnemans, K. Enhanced Separation of Neodymium and Dysprosium by Nonaqueous Solvent Extraction from a Polyethylene Glycol 200 Phase Using the Neutral Extractant Cyanex 923. ACS Sustain Chem Eng 2020, 8 (51), 19032-19039. https://doi.org/10.1021/acssuschemeng.0c07207.
(83) Alcaraz, L.; Escudero, M. E.; Alguacil, F. J.; Llorente, I.; Urbieta, A.; Fernández, P.; López, F. A. Dysprosium Removal Fromwater Using Active Carbons Obtained from Spent Coffee Ground. Nanomaterials 2019, 9 (10). https://doi.org/10.3390/nano9101372.
(84) Peng, X.; Mo, S.; Li, R.; Li, J.; Tian, C.; Liu, W.; Wang, Y. Effective Removal of the Rare Earth Element Dysprosium from Wastewater with Polyurethane Sponge-Supported Graphene Oxide-Titanium Phosphate. Environ Chem Lett 2021, 19 (1), 719-728. https://doi.org/10.1007/s10311-020-01073-y.
(85) Wamea, P.; Pitcher, M. L.; Muthami, J.; Sheikhi, A. Nanoengineering Cellulose for the Selective Removal of Neodymium: Towards Sustainable Rare Earth Element Recovery. Chemical Engineering Journal 2022, 428, 131086. https://doi.org/10.1016/j.cej.2021.131086.
(86) van de Ven, T. G.; Sheikhi, A. Hairy Cellulose Nanocrystalloids: A Novel Class of Nanocellulose. Nanoscale 2016, 8 (33), 15101-15114. https://doi.org/10.1039/c6nr01570k.
(87) Yeh, S.-L.; Alexander, D.; Narasimhalu, N.; Koshani, R.; Sheikhi, A. Mussel-Inspired Nanocellulose Coating for Selective Neodymium Recovery. ACS Appl Mater Interfaces 2023. https://doi.org/10.1021/acsami.3c04512.
(88) Higgins, R. F.; Ruoff, K. P.; Kumar, A.; Schelter, E. J. Coordination Chemistry-Driven Approaches to Rare Earth Element Separations. Acc Chem Res 2022, 55 (18), 2616-2627. https://doi.org/10.1021/acs.accounts.2c00312.
(89) Araki, J.; Wada, M.; Kuga, S. Steric Stabilization of a Cellulose Microcrystal Suspension by Poly (Ethylene Glycol) Grafting. Langmuir 2001, 17 (1), 21-27. https://doi.org/10.1021/la001070m.
(90) Cheng, M.; Qin, Z.; Chen, Y.; Hu, S.; Ren, Z.; Zhu, M. Efficient Extraction of Cellulose Nanocrystals through Hydrochloric Acid Hydrolysis Catalyzed by Inorganic Chlorides under Hydrothermal Conditions. ACS Sustain Chem Eng 2017, 5 (6), 4656-4664. https://doi.org/10.1021/acssuschemeng.6b03194.
(91) Yang, H.; Alam, M. N.; van de Ven, T. G. M. Highly Charged Nanocrystalline Cellulose and Dicarboxylated Cellulose from Periodate and Chlorite Oxidized Cellulose Fibers. Cellulose 2013, 20 (4), 1865-1875. https://doi.org/10.1007/s10570-013-9966-7.
(92) van de Ven, T. G.; Sheikhi, A. Hairy Cellulose Nanocrystalloids: A Novel Class of Nanocellulose. Nanoscale 2016, 8 (33), 15101-15114. https://doi.org/10.1039/c6nr01570k.
(93) Kim, U. J.; Kuga, S.; Wada, M.; Okano, T.; Kondo, T. Periodate Oxidation of Crystalline Cellulose. Biomacromolecules 2000, 1 (3), 488-492. https://doi.org/10.1021/bm0000337.
(94) Lewis, A.; Gueguen, C. Using Chemometric Models to Predict the Biosorption of Low Levels of Dysprosium by Euglena Gracilis. Environmental Science and Pollution Research 2022, 29 (39), 58936-58949. https://doi.org/10.1007/s11356-022-19918-0.
(95) Ohshima. Henry's Function for Electrophoresis of a Cylindrical Colloidal Particle. J Colloid Interface Sci 1996, 180 (1), 299-301. https://doi.org/https://doi.org/10.1006/jcis.1996.0305.
(96) Mattocks, J. A.; Jung, J. J.; Lin, C. Y.; Dong, Z.; Yennawar, N. H.; Featherston, E. R.; Kang-Yun, C. S.; Hamilton, T. A.; Park, D. M.; Boal, A. K.; Cotruvo, J. A. Enhanced Rare-Earth Separation with a Metal-Sensitive Lanmodulin Dimer. Nature 2023, 618 (7963), 87-93. https://doi.org/10.1038/s41586-023-05945-5.
(97) Habibi, Y.; Lucia, L. A.; Rojas, O. J. Cellulose Nanocrystals: Chemistry, Self-Assembly, and Applications. Chem Rev 2010, 110 (6), 3479-3500. https://doi.org/10.1021/cr900339w.
(98) Meija, J.; Bushell, M.; Couillard, M.; Beck, S.; Bonevich, J.; Cui, K.; Foster, J.; Will, J.; Fox, D.; Cho, W.; Heidelmann, M.; Park, B. C.; Park, Y. C.; Ren, L.; Xu, L.; Stefaniak, A. B.; Knepp, A. K.; Theissmann, R.; Purwin, H.; Wang, Z.; De Val, N.; Johnston, L. J. Particle Size Distributions for Cellulose Nanocrystals Measured by Transmission Electron Microscopy: An Interlaboratory Comparison. Anal Chem 2020, 92 (19), 13434-13442. https://doi.org/10.1021/acs.analchem.0c02805.
(99) Yu, H. Y.; Zhang, D. Z.; Lu, F. F.; Yao, J. New Approach for Single-Step Extraction of Carboxylated Cellulose Nanocrystals for Their Use As Adsorbents and Flocculants. ACS Sustain Chem Eng 2016, 4 (5), 2632-2643. https://doi.org/10.1021/acssuschemeng.6b00126.
(100) Wamea, P.; Pitcher, M. L.; Muthami, J.; Sheikhi, A. Nanoengineering Cellulose for the Selective Removal of Neodymium: Towards Sustainable Rare Earth Element Recovery. Chemical Engineering Journal 2022, 428. https://doi.org/10.1016/j.cej.2021.131086.
(101) Bala, T.; Prasad, B. L. V.; Sastry, M.; Kahaly, M. U.; Waghmare, U. v. Interaction of Different Metal Ions with Carboxylic Acid Group: A Quantitative Study. Journal of Physical Chemistry A 2007, 111 (28), 6183-6190. https://doi.org/10.1021/jp067906x.
(102) Hisada, M.; Kawase, Y. Recovery of Rare-Earth Metal Neodymium from Aqueous Solutions by Poly-γ-Glutamic Acid and Its Sodium Salt as Biosorbents: Effects of Solution PH on Neodymium Recovery Mechanisms. Journal of Rare Earths 2018, 36 (5), 528-536. https://doi.org/10.1016/j.jre.2018.01.001.
(103) Arumughan, V.; Nypelo, T.; Hasani, M.; Larsson, A. Calcium Ion-Induced Structural Changes in Carboxymethylcellulose Solutions and Their Effects on Adsorption on Cellulose Surfaces. Biomacromolecules 2022, 23 (1), 47-56. https://doi.org/10.1021/acs.biomac.1c00895.
(104) Bandzierz, K.; Reuvekamp, L.; Dryzek, J.; Dierkes, W.; Blume, A.; Bielinski, D. Influence of Network Structure on Glass Transition Temperature of Elastomers. Materials 2016, 9 (8). https://doi.org/10.3390/MA9070607.
(105) Sharifi, S.; Asenjo-Sanz, I.; Pomposo, J. A.; Alegria, A. Intra-vs Intermolecular Cross-Links in Poly(Methyl Methacrylate) Networks Containing Enamine Bonds.

Macromolecules 2021. https://doi.org/10.1021/acs.macromol.1c02607.
(106) El-Sakhawy, M.; Tohamy, H.-A. S.; Salama, A.; Kamel, S. Thermal Properties of Carboxymethyl Cellulose. Cellulose Chem. Technol 2019, 53 (8), 667-675.
(107) Zhang, W.; Liu, Y.; Xuan, Y.; Zhang, S. Synthesis and Applications of Carboxymethyl Cellulose Hydrogels. Gels 2022, 8 (9). https://doi.org/10.3390/gels8090529.
(108) Meyer, J. Glass Transition Temperature as a Guide to Selection of Polymers Suitable for PTC Materials. Polym Eng Sci 1973, 13 (6), 462-468. https://doi.org/10.1002/pen.760130611.
(109) Sheikhi, A.; van de Ven, T. G. M. Colloidal Aspects of Janus-like Hairy Cellulose Nanocrystalloids. Curr Opin Colloid Interface Sci 2017, 29, 21-31. https://doi.org/10.1016/j.cocis.2017.02.001.
(110) Snyder, E. E.; Buoscio, B. W.; Falke, J. J. Calcium (II) Site Specificity: Effect of Size and Charge on Metal Ion Binding to an EF-Hand-like Site † NIH Public Access. Biochemistry 1990, 29 (16), 3937-3943.
(11) Almessiere, M. A.; Slimani, Y.; Güngüneş, H.; Korkmaz, A. D.; Zubar, T.; Trukhanov, S.; Trukhanov, A.; Manikandan, A.; Alahmari, F.; Baykal, A. Influence of Dy3+ Ions on the Microstructures and Magnetic, Electrical, and Microwave Properties of [Ni0.4Cu0.2Zn0.4](Fe2-XDyx) 04 (0.00≤x≤0.04) Spinel Ferrites. ACS Omega 2021, 6 (15), 10266-10280. https://doi.org/10.1021/acsomega.1c00611.

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the compositions, materials, apparatuses, and methods of using and making the same disclosed herein have been discussed and illustrated, it is to be distinctly understood that the invention is not limited thereto but may be otherwise variously embodied and practiced within the scope of the following claims.

What is claimed is:

1. An adsorbent, comprising:
a substrate; and
a coating formed on a surface of the substrate, the coating comprising:
multifunctional polymers and/or particles, bearing anionic, cationic, zwitterionic, and/or neutrally charged functional groups.

2. The adsorbent of claim 1, wherein:
the multifunctional polymers and/or particles include bifunctional hairy cellulose nanocrystals (BHCNC).

3. The adsorbent of claim 1, wherein:
the anionic, cationic, zwitterionic, and/or neutrally charged functional groups include dialdehyde groups and dicarboxylate groups.

4. The adsorbent of claim 1, wherein:
the coating is formed on a portion of the surface of the substrate or formed on an entire surface of the substrate.

5. The adsorbent of claim 1, wherein:
the coating, on each portion of the surface, is formed with uniform thickness and/or uniform concentration;
the coating, on each portion of the surface, is formed with non-uniform thickness and/or non-uniform concentration; or
the coating is formed with uniform thickness and/or uniform concentration on a first portion of the surface and is formed with non-uniform thickness and/or non-uniform concentration on a second portion of the surface.

6. The adsorbent of claim 1, wherein:
the substrate includes one or more substrates.

7. The adsorbent of claim 4, wherein:
the one or more substrates includes one or more of the same type of substrate or one or more of a different type of substrate.

8. The adsorbent of claim 1, wherein:
the multifunctional polymers and/or particles includes one or more types of multifunctional polymers and/or particles.

9. The adsorbent of claim 4, wherein:
the multifunctional polymers and/or particles includes one or more types of multifunctional polymers and/or particles; and
one substrate is coated with one type of multifunctional polymers and/or particles and another substrate is coated with another type of multifunctional polymers and/or particles.

10. The adsorbent of claim 5, wherein:
the multifunctional polymers and/or particles includes one or more types of multifunctional polymers and/or particles; and
one substrate is coated with one type of multifunctional polymers and/or particles and another substrate is coated with another type of multifunctional polymers and/or particles.

11. The adsorbent of claim 1, wherein:
the substrate is one or more particles, any one or combination of the one or more particles having a length that is on a nano scale, a micro scale, or a milli scale.

12. The adsorbent of claim 1, wherein:
the substrate comprises a polymer, an organic compound, and/or an inorganic compound.

13. The adsorbent of claim 12, wherein:
the inorganic compound comprises a synthetic compound, a natural compound, and/or a semi-natural compound.

14. The adsorbent of claim 1, wherein:
the substrate is silica gel, silicate nanoplatelets, microcrystalline cellulose, an organic compound, and/or an inorganic compound.

15. A method of generating an adsorbent, the method comprising:
forming a coating on a surface of a substrate, the coating comprising multifunctional polymers and/or particles, bearing anionic, cationic, zwitterionic, and/or neutrally charged functional groups.

16. The method of claim 15, wherein:
the multifunctional polymers and/or particles include bifunctional hairy cellulose nanocrystals (BHCNC).

17. The method of claim 16, further comprising:
converting a cellulose fibril to BHCNC via synthesis.

18. The method of claim 17, wherein:
the synthesis comprises:
oxidizing a biomass to convert a hydroxyl group of the biomass into an aldehyde group;
oxidizing aldehyde-modified biomass to convert the aldehyde group to an anionic group, a cationic group, a zwitterionic group, and/or an electrically neutral group; and
forming a micro- and/or nano-structured precipitate with the chemically modified biomass.

19. The method of claim 18, wherein:
the synthesis comprises oxidizing the biomass to convert a hydroxyl group of the biomass into a dialdehyde group.

20. The method of claim 19, wherein:
the synthesis comprises oxidizing the dialdehyde-modified biomass to at least partially convert the dialdehyde group to a dicarboxylate group.

21. The method of claim 15, further comprising:
adjusting a thickness and/or a concentration of the coating to optimize accessibility of functional groups, when the adsorbent will be used in an adsorption process.

22. The method of claim 21, wherein:
the functional groups include a dicarboxylate group.

23. A method of recovering an element from a solution, the method comprising:
exposing an adsorbent to a solution containing an element, the adsorbent comprising:
a substrate; and
a coating formed on a surface of the substrate, the coating comprising:
multifunctional polymers and/or particles, bearing anionic, cationic, zwitterionic, and/or neutrally charged functional groups; and
allowing the element to adsorb to the adsorbent.

24. The method of claim 23, further comprising:
removing the adsorbent from the solution; and
adjusting a pH of the environment within which the adsorbent is held to recover the element.

25. The method of claim 24, further comprising:
exposing the adsorbent to the solution to adsorb the element; and/or
exposing the adsorbent to a different solution containing an element and allowing the element to adsorb to the adsorbent.

26. The method of claim 23, wherein:
the element is any element.

27. The method of claim 26, wherein:
the element is a metal, a rare earth element, and/or a precious metal.

28. A method of generating an adsorbent, the method comprising:
forming a coating on a surface of a substrate, the coating configured to utilize a bioinspired adhesion mechanism found in nature.

29. The method of claim 28, wherein:
the bioinspired adhesion mechanism includes a mussel-inspired coating and/or a tea-inspired coating.
